(19) United States
(12) Patent Application Publication
(10) Pub. No.: US 2026/0212580 A1
(43) Pub. Date: Jul. 23, 2026

(54) INFORMATION PROCESSING APPARATUS, SCREEN GENERATION METHOD, NON-TRANSITORY RECORDING MEDIUM, AND INFORMATION PROCESSING SYSTEM

(71) Applicant: Naoki MOTOHASHI, Kanagawa (JP)

(72) Inventor: Naoki MOTOHASHI, Kanagawa (JP)

(21) Appl. No.: 19/444,202

(22) Filed: Jan. 9, 2026

(30) Foreign Application Priority Data
Jan. 22, 2025 (JP) 2025-009251
Jan. 22, 2025 (JP) 2025-009252
Jan. 22, 2025 (JP) 2025-009253
Jan. 28, 2025 (JP) 2025-012281
Jan. 28, 2025 (JP) 2025-012289
Jan. 28, 2025 (JP) 2025-012298

(51) Int. Cl. G06T 15/00; G06T 1/60

(52) U.S. Cl. CPC G06T 15/00; G06T 1/60

(57) ABSTRACT

An information processing apparatus includes: a memory that stores, for a plurality of image capturing positions, a plurality of predetermined-area images obtained at different times and each representing a predetermined area in a captured image of an object, a plurality of specific areas each specified in the predetermined-area image, and text information being generated based on audio data of audio collected at the different times, and circuitry to generate a screen including: a particular text information of the text information; a particular predetermined-area image corresponding to the particular text information and being superimposed with a specific image indicating a position of the specific area; a three-dimensional image to be aligned with the particular predetermined-area image; and an image corresponding to the image capturing position, the image being displayed in the three-dimensional image at a position corresponding to the image capturing position.

### CROSS-REFERENCE TO RELATED APPLICATIONS

This patent application is based on and claims priority pursuant to 35 U.S.C. § 119(a) to Japanese Patent Application Nos. 2025-012298, filed on Jan. 28, 2025, 2025-009251, filed on Jan. 22, 2025, 2025-009252, filed on Jan. 22, 2025, 2025-009253, filed on Jan. 22, 2025, 2025-012281, filed on Jan. 28, 2025, and 2025-012289, filed on Jan. 28, 2025, in the Japan Patent Office, the entire disclosure of which is hereby incorporated by reference herein.

### BACKGROUND

### Technical Field

The present disclosure relates to an information processing apparatus, a screen generation method, a non-transitory recording medium, and an information processing system.

### Related Art

A wide-field-of-view image having a wide viewing angle and captured in an imaging range including even an area that is difficult for a normal angle of view to cover has been known in recent years. The wide-field-of-view image is hereinafter referred to as a “wide-view image”. Examples of the wide-view image include a 360-degree image that is a captured image of an entire 360-degree view. The 360-degree image is also referred to as a spherical image, an omnidirectional image, or an “all-around” image.

If the entire wide-view image is displayed by a display terminal, the wide-view image is curved and difficult to view. Accordingly, such a display terminal displays a predetermined-area image indicating a predetermined area in the wide-view image, and a user views the predetermined-area image.

However, by viewing the predetermined-area image corresponding to a viewable range of the wide-view image, the user can hardly recognize the content of the predetermined-area image and the location where the predetermined-area image was captured.

Further, an image capturing device captures a 360-degree view of objects around an image capturing position in a single imaging process. In other words, the image capturing device does not capture each object from all 360-degree directions relative to the object. Even an object within the imaging range does not have its back captured, and the user is unable to know the condition of the back of the object.

### SUMMARY

The present disclosure described herein provides an information processing apparatus communicably connected with an image capturing device, the information processing apparatus including: a memory that stores, for a plurality of image capturing positions, a plurality of predetermined-area images having been obtained at different times and each representing a predetermined area in a captured image of an object having been captured by the image capturing device, a plurality of specific areas each specified in the corresponding predetermined-area image, and text information being generated based on audio data of audio collected by a sound collection unit at the different times, in association, and circuitry to generate a screen. The screen includes: a particular text information of the text information; a particular predetermined-area image corresponding to the particular text information, the particular predetermined-area image being superimposed with a specific image indicating a position of the specific area; a three-dimensional image to be aligned with the particular predetermined-area image; and an image corresponding to the image capturing position, the image being displayed in the three-dimensional image at a position corresponding to the image capturing position.

The present disclosure described herein provides a screen generation method performed by a computer communicably connected with an image capturing device, the screen generation method including: storing, in a memory, for a plurality of image capturing positions, a plurality of predetermined-area images having been obtained at different times and each representing a predetermined area in a captured image of an object having been captured by the image capturing device, a plurality of specific areas each specified in the corresponding predetermined-area image, and text information being generated based on audio data of audio collected by a sound collection unit at the different times, in association; and generating a screen. The screen includes: a particular text information of the text information; a particular predetermined-area image corresponding to the particular text information, the particular predetermined-area image being superimposed with a specific image indicating a position of the specific area; a three-dimensional image to be aligned with the particular predetermined-area image; and an image corresponding to the image capturing position, the image being displayed in the three-dimensional image at a position corresponding to the image capturing position.

The present disclosure described herein provides a non-transitory recording medium storing a plurality of instructions which, when executed by one or more processors, causes the one or more processors to perform a screen generation method including: storing, in a memory, for a plurality of image capturing positions, a plurality of predetermined-area images having been obtained at different times and each representing a predetermined area in a captured image of an object having been captured by an image capturing device, a plurality of specific areas each specified in the corresponding predetermined-area image, and text information being generated based on audio data of audio collected by a sound collection unit at the different times, in association; and generating a screen. The screen includes: a particular text information of the text information; a particular predetermined-area image corresponding to the particular text information, the particular predetermined-area image being superimposed with a specific image indicating a position of the specific area; a three-dimensional image to be aligned with the particular predetermined-area image; and an image corresponding to the image capturing position, the image being displayed in the three-dimensional image at a position corresponding to the image capturing position.

The present disclosure described herein provides an information processing system including: a memory that stores, for a plurality of image capturing positions, a plurality of predetermined-area images having been obtained at different times and each representing a predetermined area in a captured image of an object having been captured by the image capturing device, a plurality of specific areas each specified in the corresponding predetermined-area image, and text information being generated based on audio data of audio collected by a sound collection unit at the different times, in association, and circuitry to display a screen on a display. The screen includes: a particular text information of the text information; a particular predetermined-area image corresponding to the particular text information, the particular predetermined-area image being superimposed with a specific image indicating a position of the specific area; a three-dimensional image to be aligned with the particular predetermined-area image; and an image corresponding to the image capturing position, the image being displayed in the three-dimensional image at a position corresponding to the image capturing position.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A, 1B, and 1C are a left side view, a front view, and a plan view of an image capturing device according to an embodiment of the present disclosure, respectively;

FIG. 2 is a diagram illustrating an example of how the image capturing device illustrated in FIGS. 1A to 1C is used;

FIGS. 3A, 3B, and 3C are diagrams illustrating a front side of a hemispherical image, a back side of the hemispherical image, and an image in equirectangular projection, respectively, captured by the image capturing device illustrated in FIGS. 1A to 1C;

FIG. 4A is a conceptual diagram illustrating an example of how the image in equirectangular projection is mapped to a sphere;

FIG. 4B is a diagram illustrating an example of a spherical image;

FIG. 5 is a diagram illustrating an example of the position of a virtual camera and the position of a predetermined area in a case where the spherical image is of a three-dimensional sphere;

FIG. 6A is a perspective view of the virtual camera and the predetermined area illustrated in FIG. 5;

FIG. 6B is a diagram illustrating an example of a predetermined-area image obtained in the state illustrated in FIG. 6A and displayed on a display;

FIG. 6C is a diagram illustrating an example of a predetermined area obtained by changing the viewpoint of the virtual camera illustrated in FIG. 6A;

FIG. 6D is a diagram illustrating an example of a predetermined-area image obtained in the state illustrated in FIG. 6C and displayed on the display;

FIG. 7 is a diagram illustrating an example of a point in a three-dimensional Euclidean space defined in spherical coordinates;

FIG. 8 is a conceptual diagram illustrating an example of the relationship between the predetermined area and a point of interest;

FIG. 9 is a schematic diagram illustrating an example configuration of a communication system;

FIG. 10 is a block diagram illustrating an example hardware configuration of the image capturing device in the communication system illustrated in FIG. 9;

FIG. 11 is a block diagram illustrating an example hardware configuration of a relay device in the communication system illustrated in FIG. 9;

FIG. 12 is a block diagram illustrating an example hardware configuration of each of a communication control apparatus and a communication terminal in the communication system illustrated in FIG. 9;

FIG. 13 is a block diagram illustrating an example functional configuration of the communication system illustrated in FIG. 9;

FIG. 14 is a schematic diagram of an example of a user device management table;

FIG. 15 is a schematic diagram of an example of a virtual room management table;

FIG. 16 is a schematic diagram of an example of a three-dimensional image management table;

FIG. 17 is a schematic diagram of an example of another three-dimensional image management table;

FIG. 18A is a conceptual diagram illustrating an example of a movement history management table generated at a previous time;

FIG. 18B is a conceptual diagram illustrating an example of a movement history management table generated at a later time than the movement history management table illustrated in FIG. 18A;

FIG. 18C is a conceptual diagram illustrating an example of a movement history management table being generated;

FIG. 19 is a sequence diagram illustrating an example of a process of communicating content data in the communication system illustrated in FIG. 9;

FIG. 20 is a sequence diagram illustrating an example of a process of starting image and sound recording in the communication system illustrated in FIG. 9;

FIG. 21 is a sequence diagram illustrating an example of a process of stopping image and sound recording in the communication system illustrated in FIG. 9;

FIG. 22 is a sequence diagram illustrating an example of a process of playing back recorded images and sounds in the communication system illustrated in FIG. 9;

FIG. 23 is a diagram illustrating an example of a recorded data selection screen;

FIG. 24 is a flowchart of a part of an example of a screen display process performed by the communication control apparatus illustrated in FIG. 9;

FIG. 25 is a flowchart of another part of the example of the screen display process performed by the communication control apparatus illustrated in FIG. 9;

FIG. 26 is a diagram illustrating an example of an initial display screen displayed on the communication terminal illustrated in FIG. 9;

FIG. 27 is a diagram illustrating an example of a screen displayed on the communication terminal illustrated in FIG. 9 on which a specific area is specified;

FIG. 28 is a diagram illustrating an example of a screen on which a corresponding predetermined area, an icon of a virtual camera, and a line indicating the line of sight of the virtual camera are displayed in a display area;

FIG. 29 is a diagram illustrating an example of a screen displayed on the communication terminal illustrated in FIG. 9 on which a specific area is specified;

FIG. 30 is a diagram illustrating an example of a screen that includes a display area for displaying text information;

FIG. 31 is a diagram illustrating an example of a screen displayed on the communication terminal illustrated in FIG. 9 on which a specific area is specified;

FIG. 32 is a diagram illustrating an example of a screen displayed on the communication terminal illustrated in FIG. 9 on which a specific area is specified;

FIG. 33 is a diagram illustrating another example of a screen displayed on the communication terminal illustrated in FIG. 9 on which an icon of the virtual camera, a corresponding predetermined area, and a line indicating the line of sight of the virtual camera are superimposed;

FIG. 34 is a diagram illustrating an example of a screen displayed on the communication terminal illustrated in FIG. 9 on which a plurality of specific areas are specified;

FIG. 35 is a diagram illustrating an example of a screen displayed on the communication terminal illustrated in FIG. 9 on which a plurality of specific areas are specified;

FIG. 36 is a diagram illustrating an example of an initial display screen displayed on the communication terminal illustrated in FIG. 9;

FIG. 37 is a diagram illustrating an example of a screen on which a corresponding predetermined area, an icon of a virtual camera, and a line indicating the line of sight of the virtual camera are displayed in a display area;

FIG. 38 is a diagram illustrating an example of a screen displayed on the communication terminal illustrated in FIG. 9 on which a specific area is specified;

FIG. 39 is a flowchart of a part of an example of a screen display process performed by the communication control apparatus illustrated in FIG. 9 after the date and time of image capturing is registered;

FIG. 40 is a flowchart of another part of the example of the screen display process performed by the communication control apparatus illustrated in FIG. 9 after the date and time of image capturing is registered;

FIG. 41 is a diagram illustrating an example of a screen on the communication terminal illustrated in FIG. 9 for displaying a current predetermined-area image after the date and time of image capturing is registered;

FIG. 42 is a diagram illustrating an example of a screen on the communication terminal illustrated in FIG. 9 for displaying a current predetermined-area image after the date and time of image capturing is registered;

FIG. 43 is a flowchart of a part of an example of a screen display process performed by the communication control apparatus illustrated in FIG. 9 after the date and time of image capturing is registered;

FIG. 44 is a flowchart of another part of the example of the screen display process performed by the communication control apparatus illustrated in FIG. 9 after the date and time of image capturing is registered;

FIG. 45 is a diagram illustrating an example of a screen on the communication terminal illustrated in FIG. 9 for displaying a current predetermined-area image after the date and time of image capturing is registered;

FIG. 46 is a diagram illustrating an example of a screen on the communication terminal illustrated in FIG. 9 for displaying a current predetermined-area image after the date and time of image capturing is registered;

FIG. 47 is a diagram illustrating an example of a screen on the communication terminal illustrated in FIG. 9 for displaying a current predetermined-area image after the date and time of image capturing is registered;

FIG. 48 is a diagram illustrating an example of a screen on the communication terminal illustrated in FIG. 9 for additionally displaying a previous predetermined-area image after the date and time of image capturing is registered;

FIG. 49 is a diagram illustrating a variation of a screen on the communication terminal illustrated in FIG. 9 for additionally displaying a previous predetermined-area image after the date and time of image capturing is registered;

FIG. 50 is a diagram illustrating an example of a screen on the communication terminal illustrated in FIG. 9 for displaying minutes including transcribed text and images;

FIG. 51 is a diagram illustrating an example of a screen on the communication terminal illustrated in FIG. 9 for additionally displaying a previous predetermined-area image and a previous three-dimensional image together with the minutes;

FIG. 52 is a block diagram illustrating an example functional configuration of a communication system according to a modification of the embodiment illustrated in FIG. 13; and

FIG. 53 is a diagram illustrating an example of a screen on the communication terminal illustrated in FIG. 9 for additionally displaying, together with the minutes, images generated based on a predetermined-area image, a three-dimensional image, and audio comments.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Overview of Spherical Image

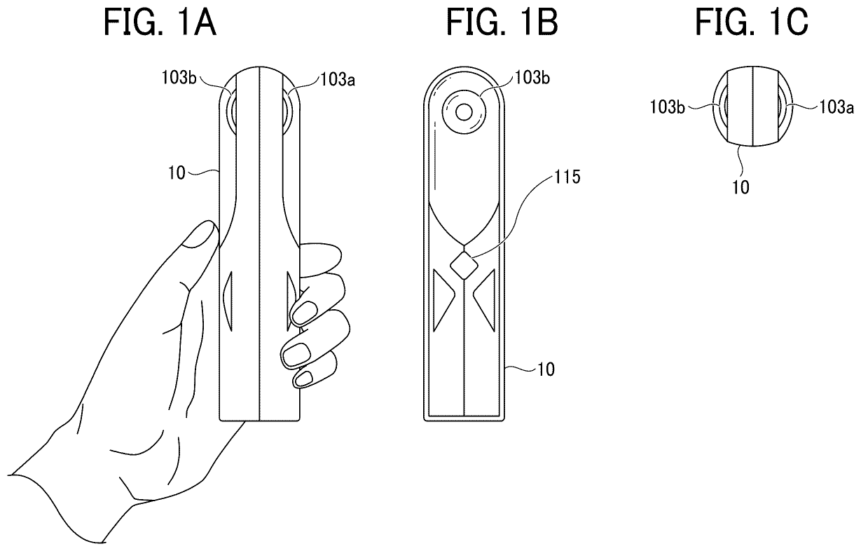

A method for generating a spherical image according to one or more embodiments will be described with reference to FIGS. 1A to 8. The spherical image is also referred to as a spherical panoramic image or a 360-degree panoramic image, and is an example of a wide-view moving image having a wide range of viewing angles. Examples of the wide-view image include a panoramic image with a viewing angle of about 180 degrees.

The external appearance of an image capturing device 10 will be described with reference to FIGS. 1A to 1C. The image capturing device 10 is a digital camera for capturing images from which a spherical image is generated. FIGS. 1A, 1B, and 1C are a left side view, a front view, and a plan view, respectively, of the image capturing device 10.

As illustrated in FIG. 1A, the image capturing device 10 has a size such that a person can hold the image capturing device 10 with one hand. As illustrated in FIGS. 1A, 1B, and 1C, the image capturing device 10 includes an imaging element 103a and an imaging element 103b in an upper portion thereof. Specifically, the imaging element 103a is disposed on the front side of the image capturing device 10, and the imaging element 103b is disposed on the back side of the image capturing device 10. As illustrated in FIG. 1B, the image capturing device 10 further includes an operation unit 115 such as a shutter button on the back side of the image capturing device 10.

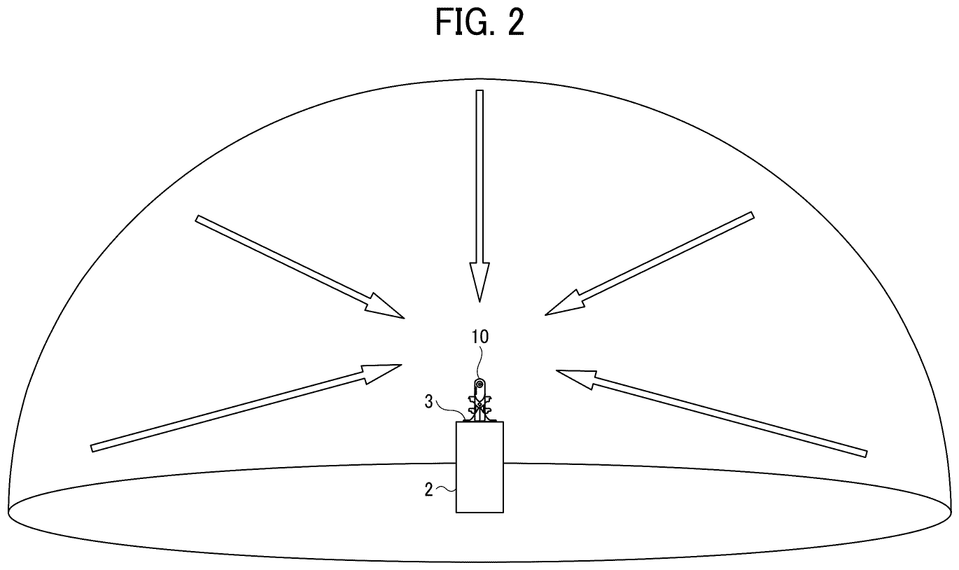

The usage scenario of the image capturing device 10 will be described with reference to FIG. 2. FIG. 2 illustrates how a user uses the image capturing device 10. As illustrated in FIG. 2, the image capturing device 10 is communicably connected to a relay device 3 placed on a table 2. The image capturing device 10 is used to capture images of surrounding objects and scenery. The imaging elements 103a and 103b illustrated in FIGS. 1A and 1C capture objects surrounding the user to obtain two hemispherical images. If the image capturing device 10 does not transmit the spherical image, which is generated from the captured hemispherical images, to another communication terminal or system, the relay device 3 is not used.

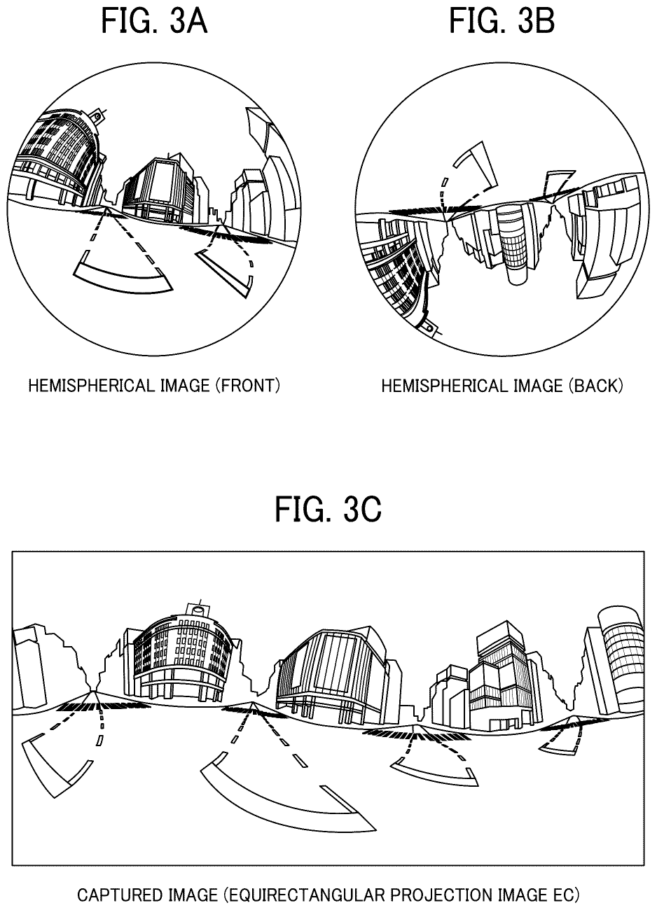

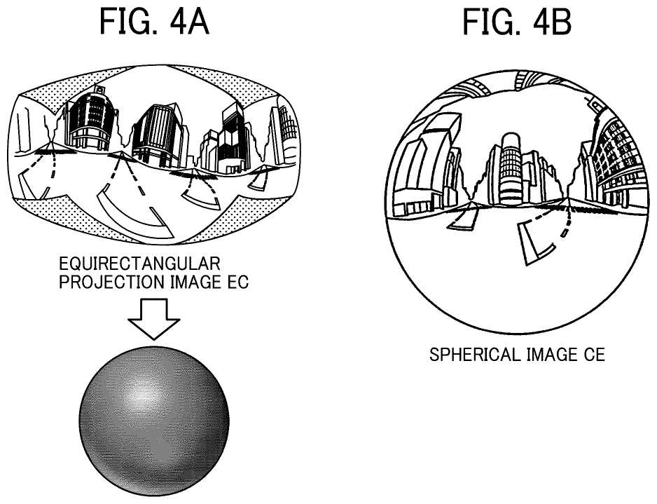

An overview of a process for generating the spherical image from the images captured by the image capturing device 10 will be described with reference to FIGS. 3A to 3C and FIGS. 4A and 4B. FIG. 3A illustrates a hemispherical image (front side) captured by the image capturing device 10. FIG. 3B illustrates a hemispherical image (back side) captured by the image capturing device 10. FIG. 3C illustrates an image in equirectangular projection, which is hereinafter referred to as an “equirectangular projection image” (or equidistant cylindrical projection image). The equirectangular projection image may be an image represented by Mercator projection. The image represented by Mercator projection is referred to as a “Mercator image”. FIG. 4A conceptually illustrates an example of how the equirectangular projection image is mapped to a sphere. FIG. 4B illustrates a spherical image. The term “equirectangular projection image” refers to a spherical image in equirectangular projection format, which is an example of the wide-view image described above.

As illustrated in FIG. 3A, an image obtained by the imaging element 103a is a curved hemispherical image (front side) captured through a wide-angle lens 102a such as a fisheye lens described below. As illustrated in FIG. 3B, an image obtained by the imaging element 103b is a curved hemispherical image (back side) captured through a wide-angle lens 102b such as a fisheye lens described below. The image capturing device 10 combines the hemispherical image (front side) and the hemispherical image (back side), which are flipped 180 degrees, to generate an equirectangular projection image EC as illustrated in FIG. 3C.

The image capturing device 10 uses software, such as Open Graphics Library for Embedded Systems (OpenGL ES), to map the equirectangular projection image EC to the sphere so as to cover the surface of the sphere in a manner illustrated in FIG. 4A to generate the spherical image CE as illustrated in FIG. 4B. The spherical image CE is represented as the equirectangular projection image EC, which corresponds to a surface facing the center of the sphere. OpenGL ES is a graphics library used for visualizing two-dimensional (2D) data and three-dimensional (3D) data. OpenGL ES is an example of software for executing image processing. Any other software may be used to create the spherical image CE. The spherical image CE may be either a still image or a moving image. Although the image capturing device 10 generates a spherical image in the above description, a device other than the image capturing device 10, such as a communication control apparatus 5, a communication terminal 7, or a communication terminal 9, may perform substantially the same image processing or a part of the image processing.

The equirectangular projection image EC is mapped to cover the sphere surface using the OpenGL ES as illustrated in FIG. 4A to generate the spherical image CE as illustrated in FIG. 4B. The spherical image CE is represented as the equirectangular projection image EC, which corresponds to a surface facing the center of the sphere. OpenGL ES is a graphics library used for visualizing 2D data and 3D data.

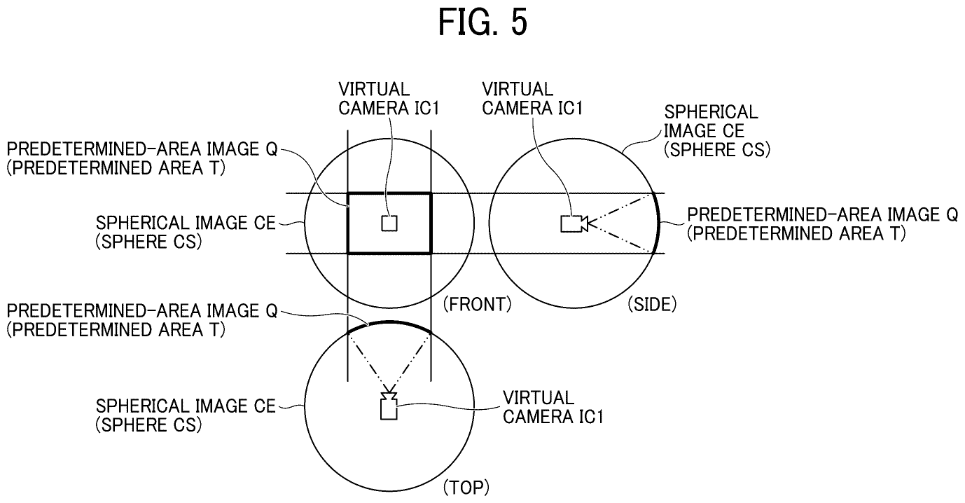

As described above, since the spherical image CE is an image mapped to a sphere in such a manner as to cover the surface of the sphere, part of the image may look distorted when viewed by a user, providing a strange feeling. Accordingly, an image of a predetermined area that is part of the spherical image CE is displayed as a less distorted planar image having fewer curves on the communication terminal 7 or 9 to make the user feel comfortable. The image of the predetermined area is hereinafter referred to as a “predetermined-area image”. The display of the predetermined-area image will be described with reference to FIGS. 5 to 8.

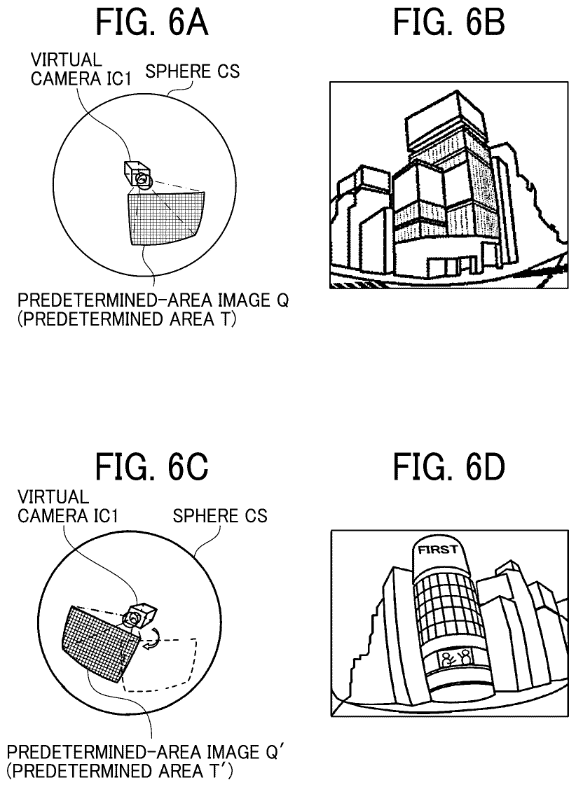

FIG. 5 is a diagram illustrating the position of a virtual camera IC1 and the position of a predetermined area T in a case where the spherical image CE is of a three-dimensional sphere CS. The position of the virtual camera IC1 corresponds to the position of the virtual viewpoint of the user viewing the spherical image CE represented as a surface area of the three-dimensional solid sphere CS. FIG. 6A is a perspective view of the virtual camera IC1 and the predetermined area T illustrated in FIG. 5. FIG. 6B illustrates a predetermined-area image Q obtained in the state illustrated in FIG. 6A and displayed on a display. FIG. 6C illustrates a predetermined area T′ obtained by changing the viewpoint of the virtual camera IC1 illustrated in FIG. 6A. FIG. 6D illustrates a predetermined-area image Q′ obtained in the state illustrated in FIG. 6C and displayed on the display.

Assuming that the spherical image CE generated in the way described above is a surface area of the sphere CS, the virtual camera IC1 is inside the spherical image CE as illustrated in FIG. 5. The predetermined area T in the spherical image CE is an imaging area of the virtual camera IC1. Specifically, the predetermined area T is specified by field-of-view information indicating an imaging direction and an angle of view of the virtual camera IC1 in a three-dimensional virtual space including the spherical image CE. The field-of-view information is also referred to as “area information”.

Zooming in or out of the predetermined area T may be implemented by bringing the virtual camera IC1 closer to or farther away from the spherical image CE. The predetermined-area image Q is an image of the predetermined area T in the spherical image CE. The predetermined area T is defined by an angle of view a of the virtual camera IC1 and a distance f from the virtual camera IC1 to the spherical image CE.

When the virtual viewpoint of the virtual camera IC1 is shifted, or changed, from the state illustrated in FIG. 6A to the right (left in the drawing) as illustrated in FIG. 6C, the predetermined area T in the spherical image CE is shifted to the predetermined area T′. Accordingly, the predetermined-area image Q displayed on the display is changed to the predetermined-area image Q′. As a result, the image displayed on the display changes from the image illustrated in FIG. 6B to the image illustrated in FIG. 6D.

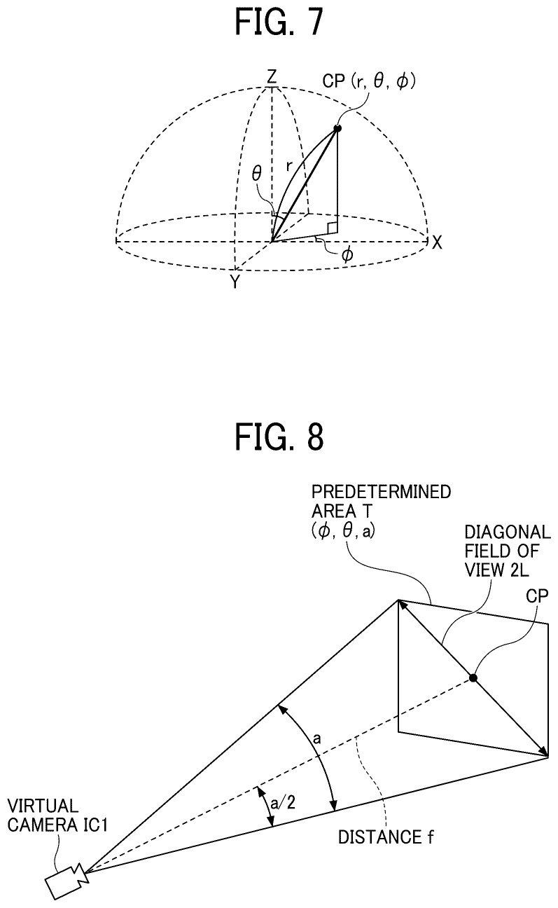

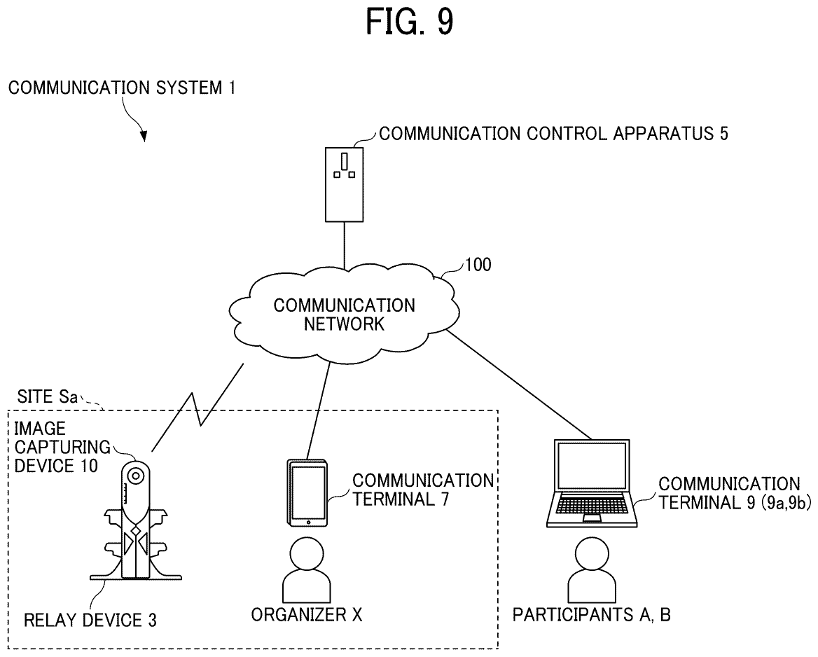

The relationship between the field-of-view information and the image of the predetermined area T will be described with reference to FIGS. 7 and 8.

FIG. 7 illustrates a point in a three-dimensional Euclidean space defined in spherical coordinates. FIG. 8 conceptually illustrates the relationship between the predetermined area T and a point of interest (e.g., a center point CP).

In FIG. 7, the center point CP is represented by a spherical polar coordinate system to obtain position coordinates (r, θ, φ). The position coordinates (r, θ, φ) represent a radius vector, a polar angle, and an azimuth angle, respectively. The radius vector r is a distance from the origin of a three-dimensional virtual space including the spherical image CE to any point (in FIG. 8, the center point CP). Accordingly, the radius vector r is equal to the distance f illustrated in FIG. 8.

As illustrated in FIG. 8, when the center of the predetermined area T, which is the imaging area of the virtual camera IC1, is assumed to be the center point CP illustrated in FIG. 7, a trigonometric function equation typically expressed by Formula (1) below is satisfied.

$$( L / f ) = tan ( a / 2 ) \qquad ( 1 )$$

In Formula (1), f denotes the distance from the virtual camera IC1 to the center point CP of the predetermined area T. L denotes the distance between the center point CP and a given vertex of the predetermined area T, while 2L is a diagonal line, and a denotes the angle of view. In this case, the field-of-view information for specifying the predetermined area T can be represented by pan (θ), tilt (φ), and field of view (fov) (a) values. Zooming in or out of the predetermined area T may be determined by increasing or decreasing the range (arc) of the angle of view a.

### Overview of Communication System

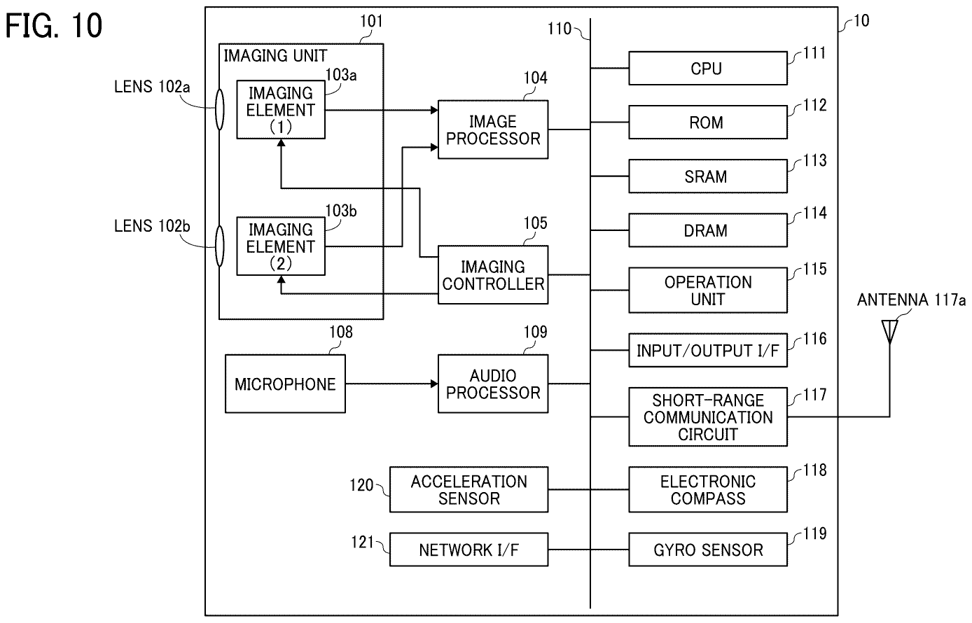

An overview of a communication system 1 according to an embodiment of the present disclosure will be described with reference to FIG. 9. FIG. 9 is a schematic diagram illustrating an example configuration of the communication system 1.

As illustrated in FIG. 9, the communication system 1 includes the image capturing device 10, the relay device 3, the communication control apparatus 5, the communication terminal 7, and communication terminals 9a and 9b. The communication system 1 is an example of an information processing system. The communication terminals 9a and 9b are collectively referred to as the “communication terminal 9”. The communication control apparatus 5, the communication terminal 7, and the communication terminal 9 are examples of an information processing apparatus. Each of the communication terminals 7 and 9 may be referred to as a “display terminal” that displays, for example, an image.

As described above, the image capturing device 10 is a digital camera for capturing a wide-view image (such as a spherical image). The relay device 3 has a cradle function for charging the image capturing device 10 and transmitting and receiving data to and from the image capturing device 10. The relay device 3 can communicate with the image capturing device 10 via a contact point and can communicate with the communication control apparatus 5 via a communication network 100. Examples of the communication network 100 include the Internet, a local area network (LAN), and a (wireless) router.

The communication control apparatus 5 is, for example, a computer, and can communicate with the relay device 3 and the communication terminals 7 and 9 via the communication network 100. The communication control apparatus 5 manages, for example, field-of-view information, and thus may be referred to as an “information management apparatus”. The communication control apparatus 5 may be implemented by a single computer or a plurality of computers.

The communication terminals 7 and 9 are computers such as smartphones or notebook personal computers (PCs), and communicate with the communication control apparatus 5 via the communication network 100. Each of the communication terminals 7 and 9 is installed with OpenGL ES and generates the predetermined-area image (see FIGS. 6A to 6D) from the spherical image received from the communication control apparatus 5.

The image capturing device 10 and the relay device 3 are placed at predetermined positions, for example, by an organizer X on a site Sa such as a construction site, an exhibition venue, an educational institution, or a medical facility. The communication terminal 7 is operated by the organizer X. The communication terminal 9a is operated by a participant A such as a viewer at a remote location from the site Sa. The communication terminal 9b is operated by a participant B such as a viewer at a remote location from the site Sa. The participant A and the participant B may be located in the same location or different locations.

The communication control apparatus 5 transmits (distributes) a wide-view image and sound data, which are obtained from the image capturing device 10 via the relay device 3, to the communication terminals 7 and 9. The communication control apparatus 5 further transmits (distributes) a captured image and sound data, which are obtained from the communication terminal 7 or 9, to the communication terminal 9 or 7. The captured image transmitted from the image capturing device 10 via the relay device 3 is a wide-view image. In a case where a single-lens reflex camera is used instead of the image capturing device 10, the captured image is a standard narrow-field-of-view image. The captured image may be a moving image or a still image.

### Hardware Configuration

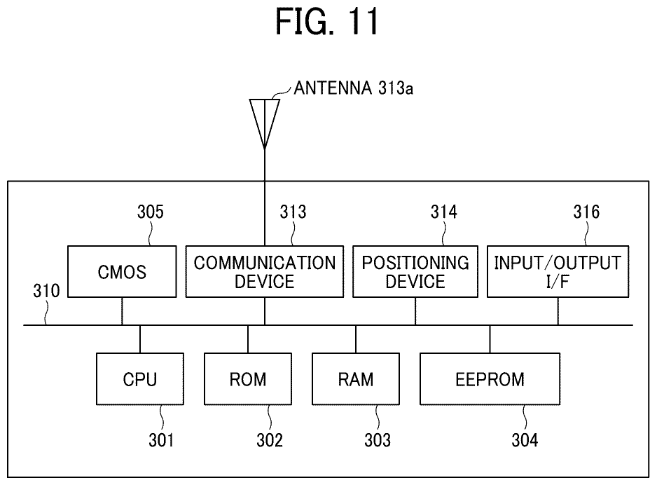

Next, the hardware configurations of the image capturing device 10, the relay device 3, and the communication terminals 7 and 9 according to this embodiment will be described in detail with reference to FIGS. 10 to 12.

### Hardware Configuration of Image Capturing Device

FIG. 10 is a block diagram illustrating an example hardware configuration of the image capturing device 10. As illustrated in FIG. 10, the image capturing device 10 includes an imaging unit 101, an image processor 104, an imaging controller 105, a microphone 108, an audio processor 109, a central processing unit (CPU) 111, a read only memory (ROM) 112, a static random access memory (SRAM) 113, a dynamic random access memory (DRAM) 114, the operation unit 115, an input/output interface (I/F) 116, a short-range communication circuit 117, an antenna 117a for the short-range communication circuit 117, an electronic compass 118, a gyro sensor 119, an acceleration sensor 120, and a network I/F 121.

The imaging unit 101 includes two wide-angle lenses (so-called fish-eye lenses) 102a and 102b (collectively referred to as lens 102 unless distinguished), each having an angle of view of equal to or greater than 180 degrees so as to form a hemispherical image. The imaging unit 101 further includes two imaging elements 103a and 103b corresponding to the lenses 102a and 102b, respectively.

Each of the imaging elements 103a and 103b includes an image sensor such as a complementary metal oxide semiconductor (CMOS) sensor or a charge-coupled device (CCD) sensor, a timing generation circuit, and a group of registers. The image sensor converts an optical image formed by the lens 102a or 102b into an electric signal and outputs image data. The timing generation circuit generates horizontal or vertical synchronization signals, pixel clocks, and the like for the image sensor. In the group of registers, various commands, parameters, and the like for an operation of the imaging element 103a or 103b are set. As a non-limiting example, the imaging unit 101 includes two wide-angle lenses. The imaging unit 101 may include one wide-angle lens or three or more wide-angle lenses.

Each of the imaging elements 103a and 103b of the imaging unit 101 is connected to the image processor 104 via a parallel I/F bus. Further, each of the imaging elements 103a and 103b of the imaging unit 101 is connected to the imaging controller 105 via a serial I/F bus such as an inter-integrated circuit (I2C) bus.

The image processor 104, the imaging controller 105, and the audio processor 109 are connected to the CPU 111 via a bus 110. The ROM 112, the SRAM 113, the DRAM 114, the operation unit 115, the input/output I/F 116, the short-range communication circuit 117, the electronic compass 118, the gyro sensor 119, the acceleration sensor 120, and the network I/F 121 are also connected to the bus 110.

The image processor 104 acquires respective items of image data output from the imaging elements 103a and 103b via the parallel I/F buses and performs predetermined processing on the items of image data. Thereafter, the image processor 104 combines the items of image data to generate data of an equirectangular projection image (an example of a wide-view image) described below.

The imaging controller 105 usually functions as a master device while each of the imaging elements 103a and 103b usually functions as a slave device. The imaging controller 105 sets commands and the like in the group of registers of each of the imaging elements 103a and 103b via the I2C bus. The imaging controller 105 receives various commands from the CPU 111. The imaging controller 105 further acquires status data and the like of the group of registers of each of the imaging elements 103a and 103b via the I2C bus. The imaging controller 105 sends the acquired status data and the like to the CPU 111.

The imaging controller 105 instructs the imaging elements 103a and 103b to output the image data at the time when a shutter button of the operation unit 115 is pressed. In one example, the image capturing device 10 displays a preview image or a moving image (movie) on a display. Examples of the display include a display of a smartphone or any other external terminal that performs short-range communication with the image capturing device 10 through the short-range communication circuit 117. In the case of displaying a movie, image data are continuously output from the imaging elements 103a and 103b at a predetermined frame rate (expressed in frames per minute).

As described below, the imaging controller 105 operates in cooperation with the CPU 111 to synchronize the time when the imaging element 103a outputs image data and the time when the imaging element 103b outputs image data. In this embodiment, the image capturing device 10 does not include a display unit (or display). In some embodiments, the image capturing device 10 may include a display unit. The microphone 108 converts sound to audio data (signals). The audio processor 109 acquires the audio data output from the microphone 108 via an I/F bus and performs predetermined processing on the audio data.

The CPU 111 controls entire operation of the image capturing device 10 and performs predetermined processing. The ROM 112 stores various programs for execution by the CPU 111. Each of the SRAM 113 and the DRAM 114 operates as a work memory to store programs to be executed by the CPU 111 or data being currently processed. More specifically, in one example, the DRAM 114 stores image data currently processed by the image processor 104 and data of the equirectangular projection image on which processing has been performed.

The operation unit 115 collectively refers to various operation buttons such as a shutter button, a power switch, a touch panel having both the display and operation functions, and the like. The user operates the operation unit 115 to input various image capturing modes or image capturing conditions.

The input/output I/F 116 collectively refers to an interface circuit such as a universal serial bus (USB) I/F that allows the image capturing device 10 to communicate with an external medium such as a Secure Digital (SD) card or an external personal computer. The input/output I/F 116 supports at least one of wired communication and wireless communication. The data of the equirectangular projection image, which is stored in the DRAM 114, is stored in the external medium via the input/output I/F 116 or transmitted to an external terminal (apparatus) via the input/output I/F 116, as desired.

The short-range communication circuit 117 communicates with the external terminal (apparatus) via the antenna 117a of the image capturing device 10 by short-range wireless communication technology such as near field communication (NFC), Bluetooth®, or Wi-Fi®. The short-range communication circuit 117 can transmit the data of the equirectangular projection image to the external terminal (apparatus).

The electronic compass 118 calculates an orientation of the image capturing device 10 from the Earth's magnetism and outputs orientation information. The orientation information is an example of related information (metadata) in compliance with exchangeable image file format (Exif). The orientation information is used for image processing such as image correction of a captured image. The related information also includes data of a date and time when the image was captured, and data of a data size of image data.

The gyro sensor 119 detects a change in tilt (roll, pitch, and yaw) of the image capturing device 10 with movement of the image capturing device 10. The change in tilt is one example of related information (metadata) in compliance with Exif. This information is used for image processing such as image correction of a captured image.

The acceleration sensor 120 detects acceleration in three axial directions.

The image capturing device 10 may also calculate the position (an angle with respect to the direction of gravity) of the image capturing device 10 using, for example, the electronic compass 118 and the acceleration sensor 120. The acceleration sensor 120 of the image capturing device 10 improves the accuracy of image correction.

The network I/F 121 is an interface for performing data communication using the communication network 100, such as the Internet, via a router or the like. The hardware elements of the image capturing device 10 are not limited to the illustrated ones as long as the functional configuration of the image capturing device 10 can be implemented. At least some of the hardware elements described above may reside on the relay device 3 or the communication network 100.

### Hardware Configuration of Relay Device

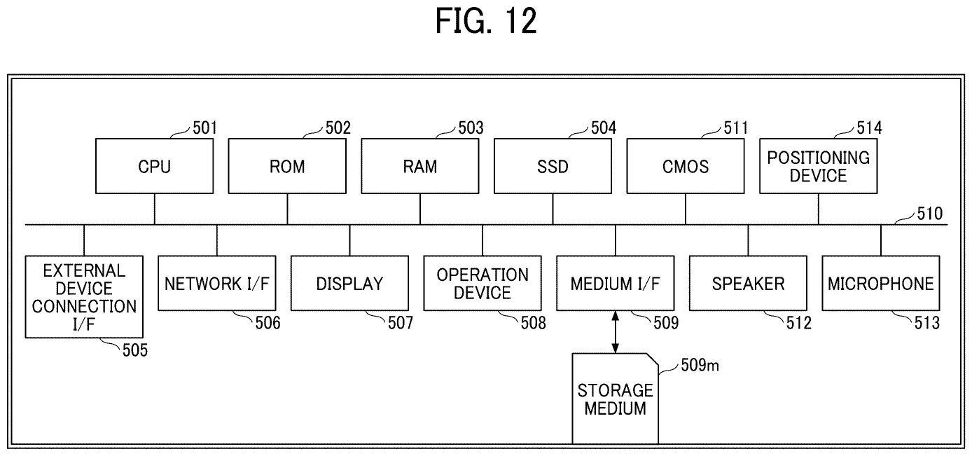

FIG. 11 is a block diagram illustrating an example hardware configuration of the relay device 3. In FIG. 11, the relay device 3 is a cradle having a wireless communication function.

As illustrated in FIG. 11, the relay device 3 includes a CPU 301, a ROM 302, a RAM 303, an electrically erasable and programmable ROM (EEPROM) 304, a CMOS sensor 305, a bus line 310, a communication device 313, an antenna 313a for the communication device 313, a positioning device 314, and an input/output I/F 316.

The CPU 301 controls entire operation of the relay device 3. The ROM 302 stores an initial program loader (IPL) or any other program used for booting the CPU 301. The RAM 303 is used as a work area for the CPU 301.

The EEPROM 304 reads and writes data under the control of the CPU 301. The EEPROM 304 stores an operating system (OS) to be executed by the CPU 301, other programs, and various types of data.

The CMOS sensor 305 is a solid-state imaging element that captures an image of an object under the control of the CPU 301 to obtain image data.

The communication device 313 performs communication with the communication network 100 through the antenna 313a by using a wireless communication signal.

The positioning device 314 receives a positioning signal including position information (latitude, longitude, and altitude) of the relay device 3 using a global navigation satellite system (GNSS) satellite such as a global positioning system (GPS) satellite or using an Indoor Messaging System (IMES) serving as an indoor GPS.

The input/output I/F 316 is an interface circuit, such as a USB I/F, which is electrically connected to the input/output I/F 116 of the image capturing device 10. The input/output I/F 316 supports at least one of wired communication and wireless communication.

The bus line 310 is an address bus, a data bus, or the like for electrically connecting the components such as the CPU 301 to each other.

### Hardware Configuration of Communication Control Apparatus and Communication Terminal

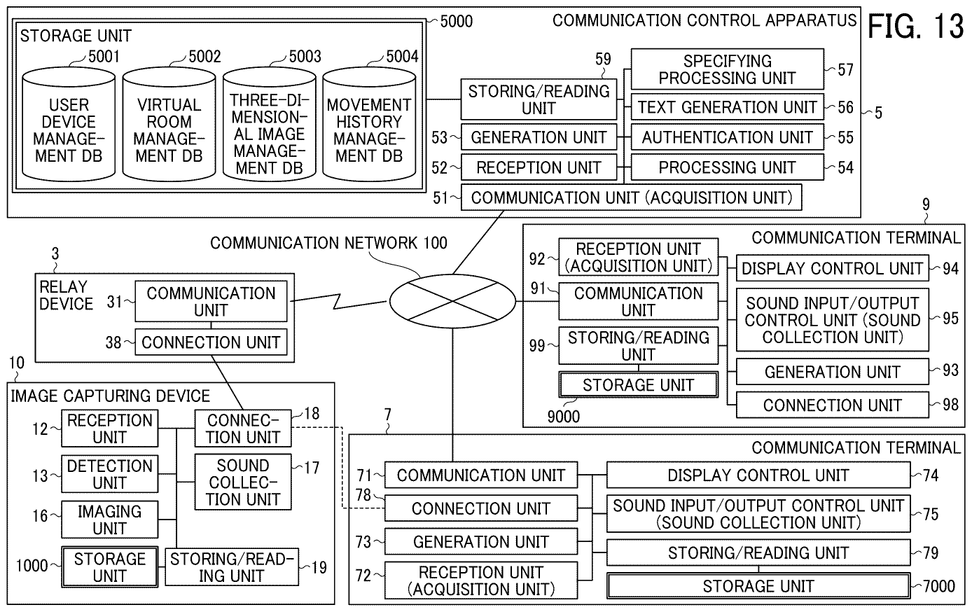

FIG. 12 is a block diagram illustrating an example hardware configuration of each of the communication control apparatus 5, the communication terminal 7, and the communication terminal 9. The hardware configuration of each of the communication terminals 7 and 9 is substantially the same as that of the communication control apparatus 5, and thus the description thereof will be omitted.

As illustrated in FIG. 12, the communication control apparatus 5 includes, as a computer, a CPU 501, a ROM 502, a RAM 503, a solid-state drive (SSD) 504, an external device connection I/F 505, a network I/F 506, a display 507, an operation device 508, a medium I/F 509, a bus line 510, a CMOS sensor 511, a speaker 512, a microphone 513, and a positioning device 514.

The CPU 501 controls entire operation of the communication control apparatus 5. The ROM 502 stores an IPL or any other program used for booting the CPU 501. The RAM 503 is used as a work area for the CPU 501.

The SSD 504 reads and writes various types of data under the control of the CPU 501. In one example, the communication terminals 7 and 9 are smartphones or the like, and each of the communication terminals 7 and 9 does not include the SSD 504. In one example, the communication control apparatus 5 includes a hard disk drive (HDD) in place of the SSD 504. The same applies to the communication terminals 7 and 9.

The external device connection I/F 505 is an interface for connecting the communication control apparatus 5 to various external devices. The external devices include, but are not limited to, a display, a speaker, a keyboard, a mouse, a USB memory, and a printer.

The network I/F 506 is an interface for performing data communication via the communication network 100.

The display 507 is a type of display device such as a liquid crystal display or an organic electroluminescent (EL) display that displays various images.

The operation device 508 is an input device operated by the user to select or execute various instructions, select a target for processing, or move a cursor being displayed. Examples of the input device include various operation buttons, a power switch, a shutter button, and a touch panel.

The medium I/F 509 controls reading or writing (storing) of data from or to a storage medium 509m such as a flash memory. Examples of the storage medium 509m include a digital versatile disc (DVD) and a Blu-ray Disc®.

The CMOS sensor 511 is a type of imaging device for capturing an image of an object under the control of the CPU 501 to obtain image data. The communication control apparatus 5 may include a CCD sensor in place of the CMOS sensor 511.

The speaker 512 is a circuit that converts an electric signal into physical vibration to generate sound such as music or voice. The microphone 513 is a circuit that converts collected (captured) sound into audio data (signals).

The positioning device 514 receives a positioning signal including position information (latitude, longitude, and altitude) of each of the communication terminals 7 and 9 using a GNSS satellite such as a GPS satellite or using an IMES serving as an indoor GPS.

The bus line 510 is an address bus, a data bus, or the like for electrically connecting the components such as the CPU 501 to each other.

### Functional Configurations

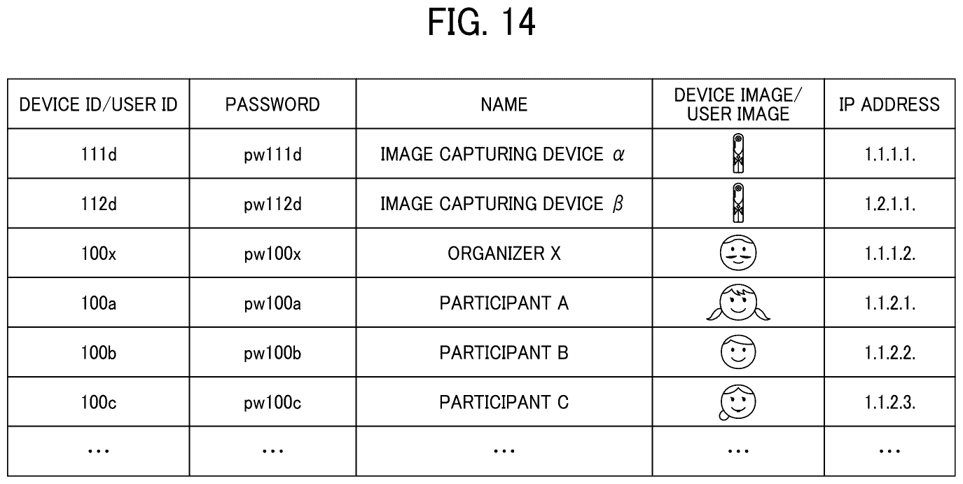

Next, an example functional configuration of the communication system 1 according to this embodiment will be described with reference to FIG. 13.

### Functional Configuration of Image Capturing Device

As illustrated in FIG. 13, the image capturing device 10 includes a reception unit 12, a detection unit 13, an imaging unit 16, a sound collection unit 17, a connection unit 18, and a storing/reading unit 19. The components of the image capturing device 10 are functions or means implemented by any one of the hardware elements illustrated in FIG. 10 operating in accordance with instructions from the CPU 111 according to a program for the image capturing device 10 loaded onto the DRAM 114 from the SRAM 113.

The image capturing device 10 further includes a storage unit 1000. The storage unit 1000 is implemented by at least one of the ROM 112, the SRAM 113, and the DRAM 114 illustrated in FIG. 10.

### Functional Elements of Image Capturing Device

The reception unit 12 of the image capturing device 10 is implemented by the operation unit 115 operating in accordance with instructions from the CPU 111. The reception unit 12 receives an operation input from the user.

The detection unit 13 is implemented by, for example, the electronic compass 118, the gyro sensor 119, and the acceleration sensor 120 operating in accordance with instructions from the CPU 111. The detection unit 13 detects the position of the image capturing device 10 to obtain position information.

The imaging unit 16 is implemented by the imaging unit 101, the image processor 104, and the imaging controller 105 operating in accordance with instructions from the CPU 111. The imaging unit 16 obtains a captured image of scenery and objects.

The sound collection unit 17 is implemented by the audio processor 109 operating in accordance with instructions from the CPU 111. The sound collection unit 17 picks up sounds around the image capturing device 10.

The connection unit 18 is implemented by the input/output I/F 116 operating in accordance with instructions from the CPU 111. The connection unit 18 performs data communication with the relay device 3.

The storing/reading unit 19 is implemented by operation of the CPU 111. The storing/reading unit 19 stores various types of data (or information) in the storage unit 1000 or reads various types of data (or information) from the storage unit 1000.

### Functional Configuration of Relay Device

As illustrated in FIG. 13, the relay device 3 includes a communication unit 31 and a connection unit 38. The components of the relay device 3 are functions or means implemented by any one of the hardware elements illustrated in FIG. 11 operating in accordance with instructions from the CPU 301 according to a program for the relay device 3 loaded onto the RAM 303 from the EEPROM 304.

### Functional Elements of Relay Device

The communication unit 31 of the relay device 3 is implemented by the communication device 313 operating in accordance with instructions from the CPU 301 illustrated in FIG. 11. The communication unit 31 performs data communication with the image capturing device 10 and the communication control apparatus 5 via the communication network 100.

The connection unit 38 is implemented by the input/output I/F 316 operating in accordance with instructions from the CPU 301. The connection unit 38 performs data communication with the image capturing device 10.

### Functional Configuration of Communication Control Apparatus

Next, the functional configuration of the communication control apparatus 5 will be described in detail with reference to FIG. 13. The communication control apparatus 5 includes a communication unit 51, a reception unit 52, a generation unit 53, a processing unit 54, an authentication unit 55, a text generation unit 56, a specifying processing unit 57, and a storing/reading unit 59. The components of the communication control apparatus 5 are functions or means implemented by any one of the hardware elements illustrated in FIG. 12 operating in accordance with instructions from the CPU 501 according to a program for the communication control apparatus 5 loaded onto the RAM 503 from the SSD 504.

The communication control apparatus 5 further includes a storage unit 5000. The storage unit 5000 is implemented by at least one of the RAM 503 and the SSD 504 illustrated in FIG. 12. The storage unit 5000 includes a user device management database (DB) 5001, a virtual room management DB 5002, a three-dimensional image management DB 5003, and a movement history management DB 5004.

### User Device Management DB

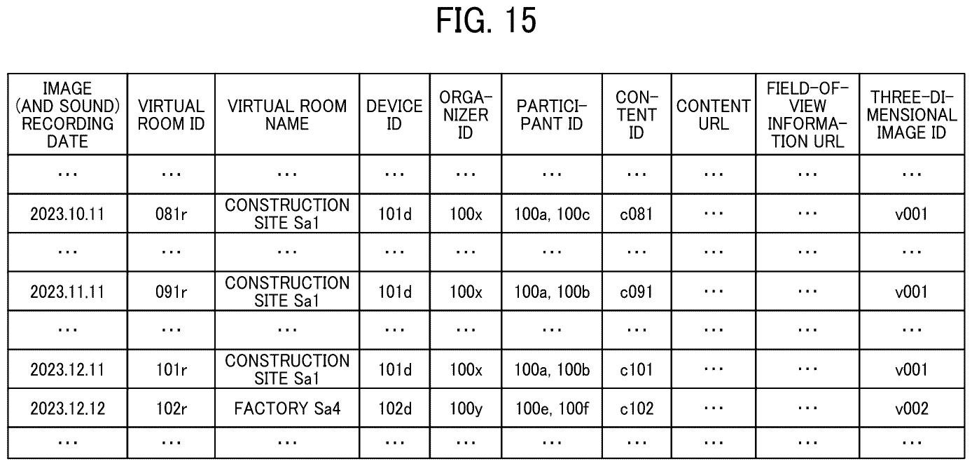

FIG. 14 schematically illustrates a user device management table. The user device management DB 5001 includes the user device management table illustrated in FIG. 14. The user device management table stores a device ID (or user ID), a password, a name, a device image (or user image), and an Internet protocol (IP) address in association with one another as data items to be managed.

The user ID is an example of user identification information for identifying a user, such as the organizer X, the participant A, or the participant B. The device ID is an example of device identification information for identifying a device, such as the image capturing device 10. In one embodiment, a head-mounted display or the like other than the image capturing device 10 is used. In this case, the head-mounted display or the like is also identified as a device.

The name is the name of the user or the device. The name of the user may be the name of the communication terminal used by the user.

The device image is registered in advance by a predetermined user. Examples of the device image include a schematic image of the device, such as the image capturing device 10. The user image is registered in advance by the user. Examples of the user image include a schematic image of the face of the user, and a photograph of the face of the user.

The IP address is an example of information for specifying the address of a device used by the user, such as the image capturing device 10 or the communication terminal 7 or 9.

### Virtual Room Management DB

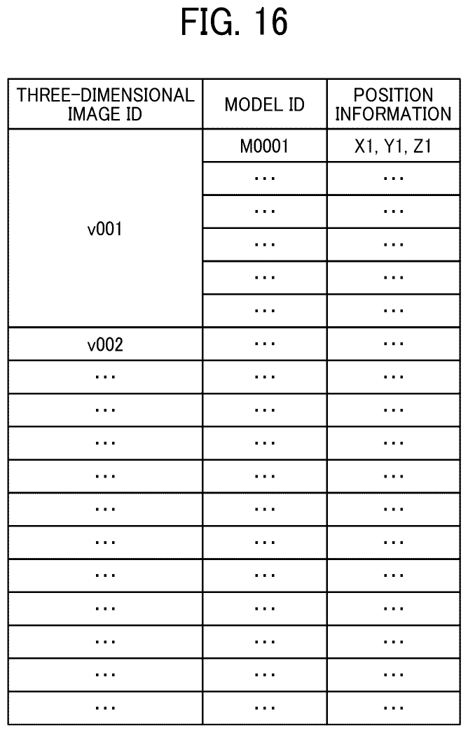

FIG. 15 schematically illustrates a virtual room management table. The virtual room management DB 5002 includes the virtual room management table illustrated in FIG. 15. The virtual room management table stores an image (and sound) recording date, a virtual room ID, a virtual room name, a device ID, an organizer ID, a participant ID, a content ID, a content uniform resource locator (URL) (storage location information of content data including images and sounds), a field-of-view information URL (storage location information of field-of-view information), and a three-dimensional image ID in association with one another as data items to be managed.

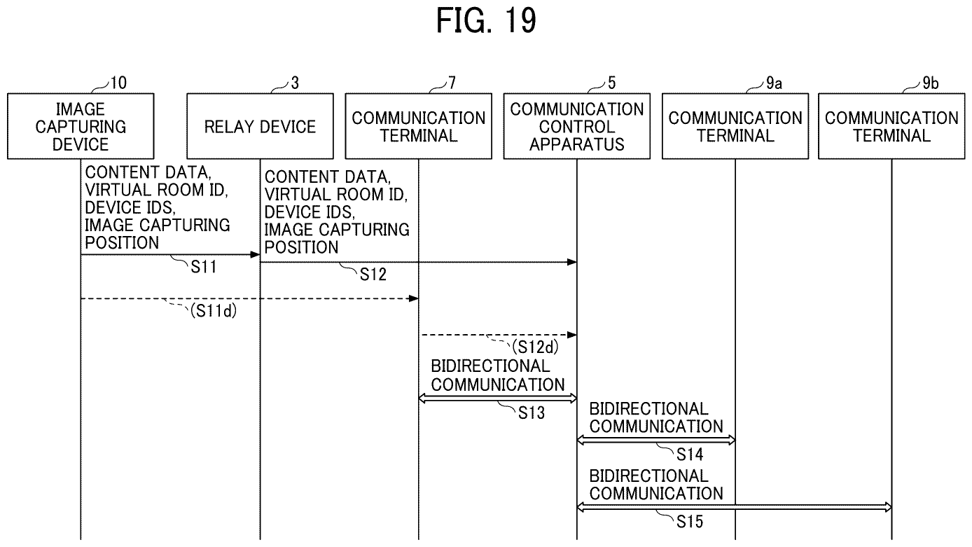

The image (and sound) recording date indicates the date on which the processing of step S36 of FIG. 20 described below is performed.

The virtual room ID is an example of virtual room identification information for identifying a virtual room.

The virtual room name is the name of the virtual room and is assigned by, for example, a user.

The device ID is the same as the device ID illustrated in FIG. 14 and is the ID of a device that has joined the virtual room indicated by the virtual room ID in the same record.

The organizer ID is the ID of an organizer participating in the virtual room indicated by the virtual room ID in the same record. The organizer ID is an example of organizer identification information for identifying an organizer among users indicated by user IDs illustrated in FIG. 14.

The participant ID is the ID of a participant participating in the virtual room indicated by the virtual room ID in the same record. The participant ID is an example of participant identification information for identifying a participant among the users indicated by the user IDs illustrated in FIG. 14.

The content ID is an example of content identification information for identifying content data including images and sounds. In this example, the images include a wide-view image obtained at the time of image capturing, and the sounds include a sound (including voice) obtained at the same time as the time of image capturing.

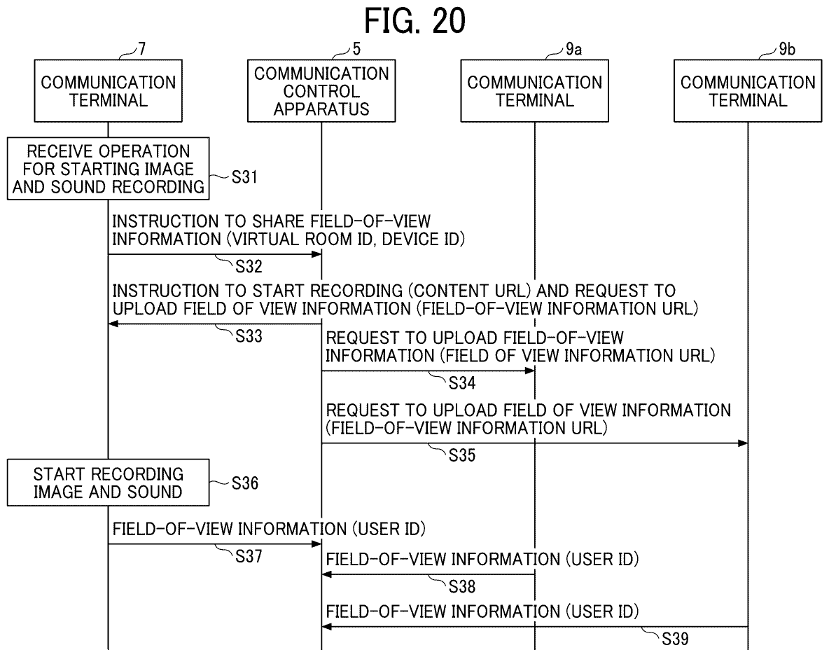

The content URL is an example of content storage location information indicating a location where content data including the wide-view image and the sound data is stored (see step S54 of FIG. 21). The content URL is stored in association with the content data, timestamps indicating the start time and end time of image capturing (or recording) and sound capturing (or recording), and the image capturing position (absolute position on the earth).

The field-of-view information URL is an example of field-of-view information storage location information indicating a storage location of field-of-view information. The field-of-view information indicates a field of view of a predetermined-area image displayed by a user (e.g., the organizer X or the participant A or B) during recording (see steps S37 to S39 of FIG. 20).

The three-dimensional image ID is an example of three-dimensional image identification information for identifying a three-dimensional image displayed in a display area 620 described below.

### Three-Dimensional Image Management DB

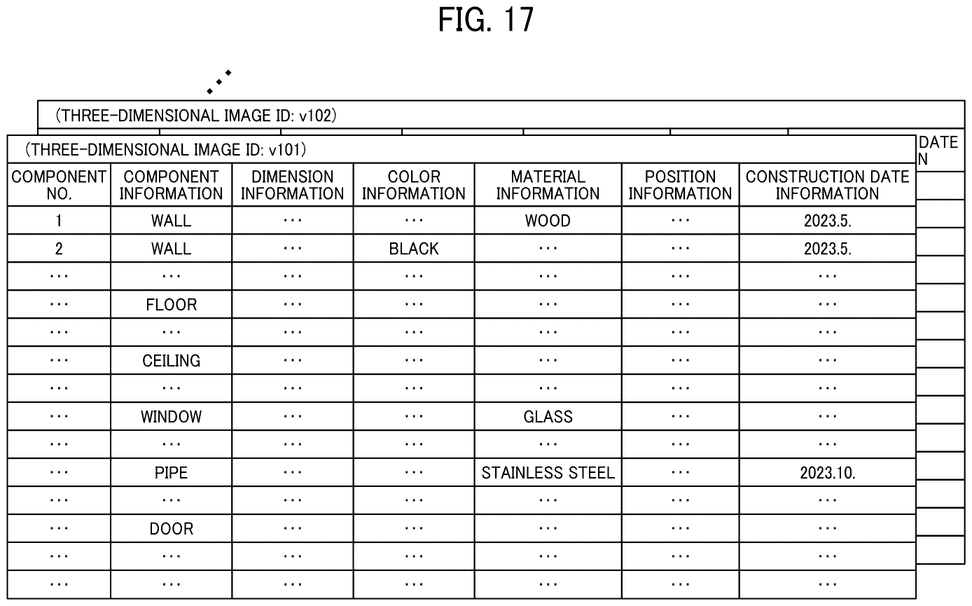

FIG. 16 schematically illustrates an example of a three-dimensional image management table. The three-dimensional image management DB 5003 includes the three-dimensional image management table illustrated in FIG. 16. The three-dimensional image management table illustrated in FIG. 16 stores, for each three-dimensional image ID, a model ID and position information in association with each other as data items to be managed.

The model ID is an example of three-dimensional model identification information for identifying a three-dimensional model. The three-dimensional model is generated based on a point cloud acquired by, for example, a time-of-flight (TOF) camera.

The position information indicates the position of the three-dimensional model in a three-dimensional virtual space using three-dimensional coordinates of XYZ. The position information is indicated by, for example, the three-dimensional coordinates of eight points defining a rectangular parallelepiped space occupied by the three-dimensional model.

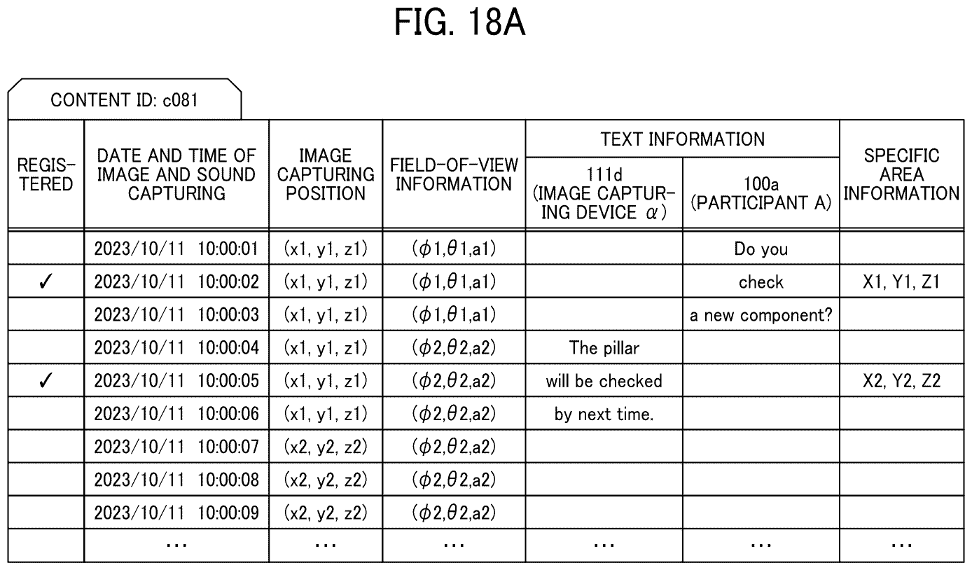

FIG. 17 schematically illustrates another example of a three-dimensional image management table. The three-dimensional image management DB 5003 includes the three-dimensional image management table illustrated in FIG. 17. The three-dimensional image management table illustrated in FIG. 17 is a table for managing attribute information indicating attributes of components (three-dimensional models) of a structure in a three-dimensional virtual space. The three-dimensional image management table illustrated in FIG. 17 stores, for each three-dimensional image ID, a component number (component No.), component information, dimension information, color information, material information, position information, and construction date information in association with one another as attribute information to be managed.

The component information is information for identifying a component that is made up of various parts. Examples of the component include a wall, a floor, a ceiling, a window, a pipe, and a door.

The dimension information is information for identifying the dimensions of the component in the virtual space and is indicated by, for example, numerical values in three-axis directions of XYZ.

The color information is information for identifying the color of the component. The material information is information for identifying the material of the component.

The position information is information for identifying the position of the component in the virtual space and is indicated by, for example, coordinates in three-axis directions of XYZ. The position information may be used to determine whether multiple components are adjacent to each other.

The construction date information is information indicating a scheduled date when the component is scheduled to be constructed in the real world. With the construction date information, a structure excluding an unconstructed component at a certain point in time can be identified.

As described above, the position information illustrated in FIG. 16 and the position information illustrated in FIG. 17 are stored in association with the absolute position on the earth. For example, by associating the origin (X=0, Y=0, Z=0) of the position information illustrated in FIG. 16 and the position information illustrated in FIG. 17 with the absolute positions (latitudes, longitudes, and altitudes) on the earth, all coordinates in the three-dimensional image, including the three-dimensional models or components, are associated with the absolute positions on the earth.

In the three-dimensional image management DB 5003, for example, a three-dimensional point cloud, a mesh object, and a textured mesh object may be managed instead of the three-dimensional models.

### Movement History Management DB

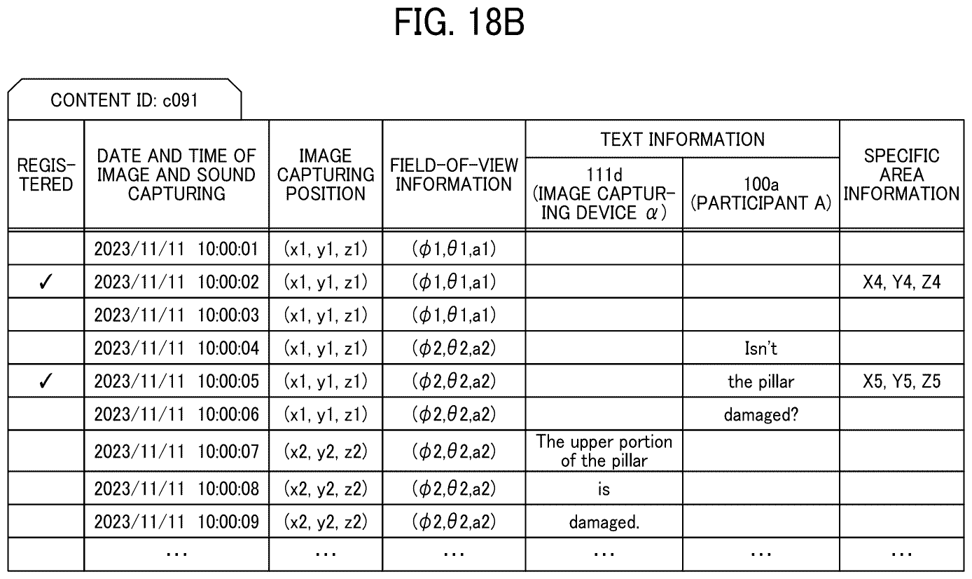

FIG. 18A schematically illustrates a movement history management table generated at a previous time. FIG. 18B schematically illustrates a movement history management table generated at a later time than the movement history management table illustrated in FIG. 18A. FIG. 18C schematically illustrates a movement history management table being generated. The movement history management DB 5004 includes the movement history management tables illustrated in FIGS. 18A, 18B, and 18C. The movement history management DB 5004 is referred to in a display content lock mode.

The display content lock mode is a mode in which the content of a screen (e.g., a screen 600 or 601 described below) is kept to be the same (or at least common) across all of the communication terminals 7, 9a, and 9b, which have joined the same virtual room. Specifically, content is being displayed on one of the communication terminals 7, 9a, and 9b (e.g., the communication terminal 9a), and the same content as the content being displayed is displayed on the other communication terminals (e.g., the communication terminals 7 and 9b).

Each of the movement history management tables illustrated in FIGS. 18A, 18B, and 18C stores, for each content ID, a date and time of image and sound capturing, an image capturing position, field-of-view information, text information, and specific area information in association with one another as data items to be managed. The movement history management table may further include a user ID. When sounds are not collected, the date and time of image capturing is stored instead of the date and time of image and sound capturing. The position of the image capturing device 10 is measured by the positioning device 314 of the relay device 3 to which the image capturing device 10 is attached. The image capturing device 10 may be provided with a positioning unit similar to the positioning device 314 to measure the position of the image capturing device 10. Since the movement history management tables illustrated in FIGS. 18A, 18B, and 18C have similar data structures, the movement history management table illustrated in FIG. 18A will be described, and a description of the movement history management tables illustrated in FIGS. 18B and 18C will be omitted.

The content ID illustrated in FIG. 18A is the same as the content ID illustrated in FIG. 15.

The date and time of image and sound capturing indicate the date and time when the image and the sound are captured by the image capturing device 10.

The image capturing position indicates the position (absolute position on the earth) of the image capturing device 10 at the date and time of image capturing. When sounds are collected, the image capturing position is also a sound collection position.

The field-of-view information is information for specifying a predetermined area indicating a predetermined-area image displayed on any one of the communication terminals 7, 9a, and 9b (in this example, the communication terminal 9a). For example, in the display content lock mode, the content of a screen 600 or 601 described below is displayed on the communication terminal 9a and browsed by the participant A, and the same content is displayed on the communication terminal 7 of the organizer X and the communication terminal 9b of the participant B. In this example, the content being viewed by the participant A is set as target content to be shared in the display content lock mode. The field-of-view information (including the user ID), which is received by the communication control apparatus 5 in step S38 of FIG. 20 described below, is managed using the field-of-view information URL in the virtual room management DB 5002 (see FIG. 15). In addition, the field-of-view information is managed using the date and time of image and sound capturing in the movement history management DB 5004 (see FIG. 18C). In this case, the communication terminals 7 and 9b, other than the communication terminal 9a on which the target content is being displayed, do not transmit the field-of-view information. In other words, the processing of steps S37 and S39 described below is not performed.

In the display content lock mode in which the content being displayed on the communication terminal 9a is set as target content to be shared, the communication control apparatus 5 stores the field-of-view information received in steps S37 to S39 described below in the storage location indicated by the field-of-view information URL, which is managed in the virtual room management DB 5002 (see FIG. 15). The communication control apparatus 5 also manages, in the movement history management DB 5004, the field-of-view information (i.e., the field-of-view information received in step S38) for specifying the predetermined-area image on a screen 600 or 601 described below, which is being displayed on the communication terminal 9a on which the target content is being displayed.

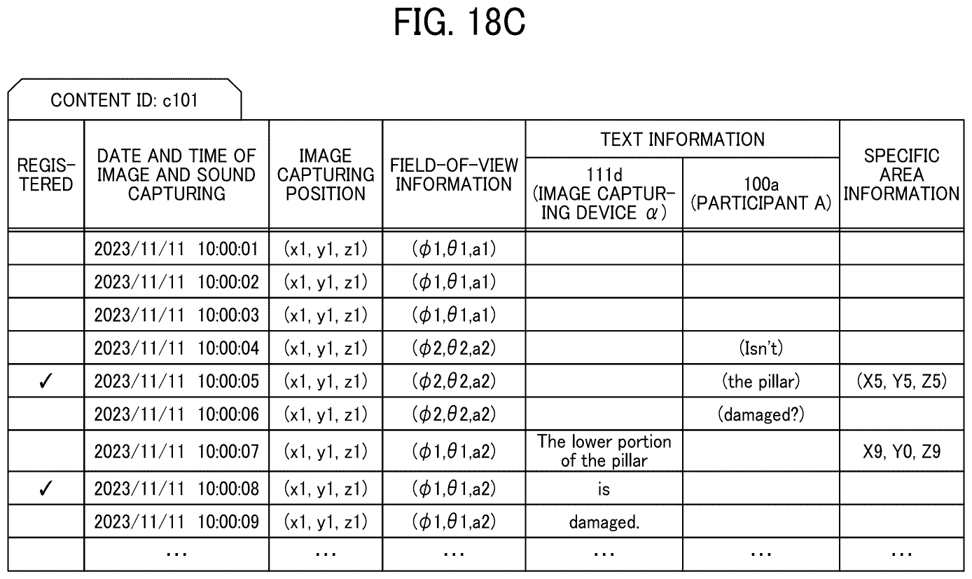

In the display content lock mode in which the content being displayed on the communication terminal 9a is set as target content to be shared, the communication terminals 7 and 9b display the predetermined-area image having the same display content as the communication terminal 9a. The communication control apparatus 5 transmits the field-of-view information (including the user ID of the participant A) received in step S38 to the communication terminal 7 and the communication terminal 9b in steps S13 and S15 of FIG. 19 described below, respectively. Thus, the communication terminal 7 (a display control unit 74) and the communication terminal 9b (a display control unit 94) can display the same content as the content of the predetermined-area image being displayed on the communication terminal 9a.

In the display content lock mode, the screen content displayed on the communication terminal 7 and browsed by the organizer X may be set as the target content, and the same content as that of the communication terminal 7 may be displayed on the other communication terminals 9a and 9b. Alternatively, the screen content displayed on the communication terminal 9b and browsed by the participant B may be set as the target content, and the same content as that of the communication terminal 9b may be displayed on the other communication terminals 7 and 9a.

Transcribed text registered in the “text information” column is information converted from audio data recorded at the date and time of image and sound capturing of the same record. In the “text information” column, transcribed text generated from audio data collected by the image capturing device 10 (e.g., an image capturing device α) is managed for the device ID in chronological order, and transcribed text generated from audio data collected by the communication terminal 7 or 9 (e.g., the communication terminal 9a) is managed for the user ID of the user of the communication terminal 7 or 9 (e.g., the communication terminal 9a) in chronological order. In the “text information” column, transcribed text that is based on audio data collected by the image capturing device 10 and transcribed text that is based on audio data collected by at least one of the communication terminals 7 and 9 are managed. The “text information” column also stores input text entered by a user, in addition to the transcribed text generated from audio that has been collected.

The specific area information is information indicating the position of a specific area specified from a captured image. The information indicating the position of the specific area may be defined by two-dimensional coordinates (plane) or represented by a three-dimensional image (solid). Details of the specific area specified from the captured image will be described below.

Each movement history management table also includes, for each date and time of image capturing, a “registered” field to indicate whether the display position of an icon of the virtual camera IC1 has been registered. When a flag is set in the “registered” field, the generation unit 53 may display, for example, an icon 622a described below of the virtual camera IC1 at the image capturing position in a display area 620 described below. When the flag is set in the “registered” field, the generation unit 53 may further associate the image capturing position in a display area 620 described below with a specific area 611 described below, which is specified from the captured image.

### Functional Elements of Communication Control Apparatus

Next, the functional elements of the communication control apparatus 5 will be described in detail with reference to FIG. 13.

The communication unit 51 of the communication control apparatus 5 is implemented by the network I/F 506 operating in accordance with instructions from the CPU 501 illustrated in FIG. 12. The communication unit 51 performs data communication with other devices, such as the relay device 3 and the communication terminals 7 and 9, via the communication network 100. The communication unit 51 also functions as an acquisition unit and acquires instruction information indicating an instruction transmitted from the communication terminals 7 and 9.

The reception unit 52 is implemented by the operation device 508 operating in accordance with instructions from the CPU 501. The reception unit 52 receives an operation input from the user (e.g., a system administrator or the like).

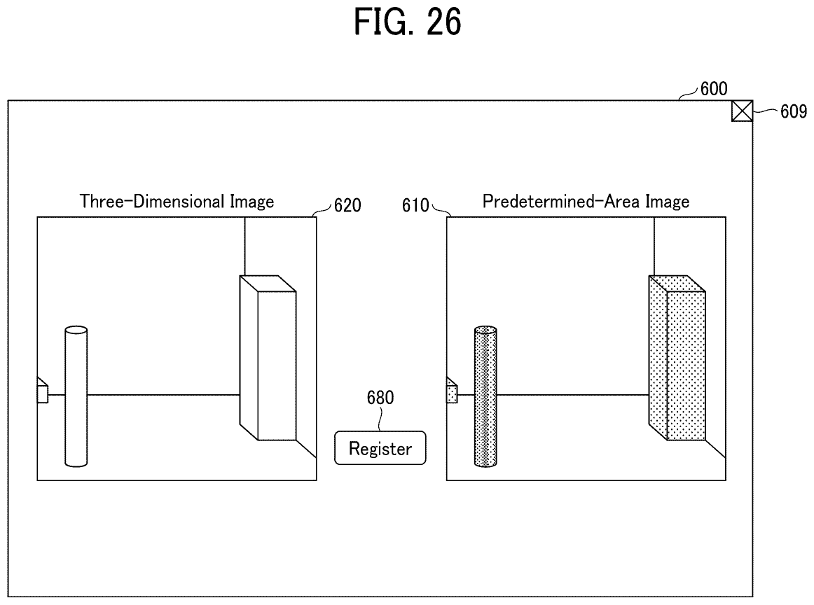

The generation unit 53 is implemented by operation of the CPU 501. The generation unit 53 generates a screen to be transmitted to each of the communication terminals 7 and 9, using, for example, the data stored in the storage unit 5000. For example, the generation unit 53 generates a screen 600 (see FIG. 26). The screen 600 includes a display area 610 and a display area 620. The display area 610 displays a predetermined-area image representing a predetermined area in a wide-view image (an example of a captured image) captured by the image capturing device 10. The display area 620 displays at least a portion of a three-dimensional image including a second position (coordinates). The second position (coordinates) is associated with a first position (coordinates) in the wide-view image by the processing unit 54.

The processing unit 54 is implemented by operation of the CPU 501. The processing unit 54 performs a registration process to associate position information indicating a position (an example of the first position) in a captured image of an object, which is captured by the image capturing device 10, with position information indicating a position (an example of the second position) in a three-dimensional image including a three-dimensional area corresponding to the object. The processing unit 54 further performs a registration process to associate the position (an example of the first position) in the captured image and the position (an example of the second position) in the three-dimensional image with position information indicating a position (an example of a third position) in a predetermined-area image (captured image) of a specific area specified by the specifying processing unit 57. The processing unit 54 may also be referred to as an “association unit”.

The authentication unit 55 is implemented by operation of the CPU 501. The authentication unit 55 performs authentication to determine, for example, whether each user is authorized to use the virtual room.

The text generation unit 56 is implemented by operation of the CPU 501. The text generation unit 56 generates text data from audio data (or voice data) of content data.

The specifying processing unit 57 is implemented by operation of the CPU 501. The specifying processing unit 57 specifies a specific area from the captured image. The specific area is an area specified in the display area 610 by a user through an operation input. The specific area is an area specified by image recognition processing using text information. The text information represents transcribed text generated from sounds collected when the captured image is obtained or input text entered by the user.

The storing/reading unit 59 is implemented by operation of the CPU 501. The storing/reading unit 59 stores various types of data (or information) in the storage unit 5000 or reads various types of data (or information) from the storage unit 5000.

### Functional Configuration of Communication Terminal 7

Next, the functional configuration of the communication terminal 7 will be described in detail with reference to FIG. 13. The communication terminal 7 includes a communication unit 71, a reception unit 72, a generation unit 73, a display control unit 74, a sound input/output control unit 75, a connection unit 78, and a storing/reading unit 79. The components of the communication terminal 7 are functions or means implemented by any one of the hardware elements illustrated in FIG. 12 operating in accordance with instructions from the CPU 501 according to a program for the communication terminal 7 loaded onto the RAM 503 from the SSD 504.

The communication unit 71 of the communication terminal 7 is implemented by the network I/F 506 operating in accordance with instructions from the CPU 501 illustrated in FIG. 12. The communication unit 71 performs data communication with other devices, such as the communication control apparatus 5, via the communication network 100.

The reception unit 72 is implemented by the operation device 508 operating in accordance with instructions from the CPU 501. The reception unit 72 receives an operation input from the user (i.e., the organizer X). The reception unit 72 also functions as an acquisition unit and acquires an instruction provided through a user operation.

The generation unit 73 is implemented by operation of the CPU 501. The generation unit 73 generates a screen to be displayed on the communication terminal 7, using, for example, data stored in a storage unit 7000. In a case where the generation unit 53 of the communication control apparatus 5 generates a screen to be displayed on the communication terminal 7, the communication terminal 7 may or may not include the generation unit 73.

The display control unit 74 is implemented by operation of the CPU 501. The display control unit 74 controls the display 507 of the communication terminal 7 or an external display connected to the external device connection I/F 505 to display various images.

The sound input/output control unit 75 is implemented by operation of the CPU 501. The sound input/output control unit 75 controls the speaker 512 of the communication terminal 7 or an external speaker connected to the external device connection I/F 505 to output sound. The sound input/output control unit 75 further controls the microphone 513 or an external microphone connected to the external device connection I/F 505 to collect sound. The sound input/output control unit 75 also provides functions similar to those of the sound collection unit 17 of the image capturing device 10. Thus, the sound input/output control unit 75 is also an example of a sound collection unit.

The generation unit 73 is implemented by operation of the CPU 501. The generation unit 73 adds a voice-over or subtitles to video and audio content data recorded by the communication terminal 7 to create content data such as for teaching materials.

The storing/reading unit 79 is implemented by operation of the CPU 501. The storing/reading unit 79 stores various types of data (or information) in the storage unit 7000 or reads various types of data (or information) from the storage unit 7000.

### Functional Configuration of Communication Terminal 9

Next, the functional configuration of the communication terminal 9 will be described in detail with reference to FIG. 13.

The communication terminal 9 includes a communication unit 91, a reception unit 92, a generation unit 93, a display control unit 94, a sound input/output control unit 95, a connection unit 98, and a storing/reading unit 99. The components of the communication terminal 9 are functions or means implemented by any one of the hardware elements illustrated in FIG. 12 operating in accordance with instructions from the CPU 501 according to a program for the communication terminal 9 loaded onto the RAM 503 from the SSD 504.

The communication terminal 9 further includes a storage unit 9000. The storage unit 9000 is implemented by the RAM 503 and the SSD 504 illustrated in FIG. 12.

The communication unit 91 of the communication terminal 9 is implemented by the network I/F 506 operating in accordance with instructions from the CPU 501. The communication unit 91 performs data communication with other devices, such as the communication control apparatus 5, via the communication network 100.

The reception unit 92 is implemented by the operation device 508 operating in accordance with instructions from the CPU 501. The reception unit 92 receives an operation input from the user (i.e., a participant). The reception unit 92 also functions as an acquisition unit and acquires an instruction provided through a user operation.

The generation unit 93 is implemented by operation of the CPU 501. The generation unit 93 generates a screen to be displayed on the communication terminal 9, using, for example, data stored in the storage unit 9000. In a case where the generation unit 53 of the communication control apparatus 5 generates a screen to be displayed on the communication terminal 9, the communication terminal 9 may or may not include the generation unit 93.

The display control unit 94 is implemented by operation of the CPU 501. The display control unit 94 controls the display 507 of the communication terminal 9 or an external display connected to the external device connection I/F 505 to display various images.

The sound input/output control unit 95 is implemented by operation of the CPU 501. The sound input/output control unit 95 controls the speaker 512 of the communication terminal 9 or an external speaker connected to the external device connection I/F 505 to output sound. The sound input/output control unit 95 further controls the microphone 513 or an external microphone connected to the external device connection I/F 505 to collect sound. The sound input/output control unit 95 also provides functions similar to those of the sound collection unit 17 of the image capturing device 10. Thus, the sound input/output control unit 95 is also an example of a sound collection unit.

The connection unit 98 is implemented by the external device connection I/F 505 operating in accordance with instructions from the CPU 501. The connection unit 98 performs data communication with an external device connected to the communication terminal 9 in a wired or wireless way.

The storing/reading unit 99 is implemented by operation of the CPU 501. The storing/reading unit 99 stores various types of data (or information) in the storage unit 9000 or reads various types of data (or information) from the storage unit 9000.

### Processes or Operations

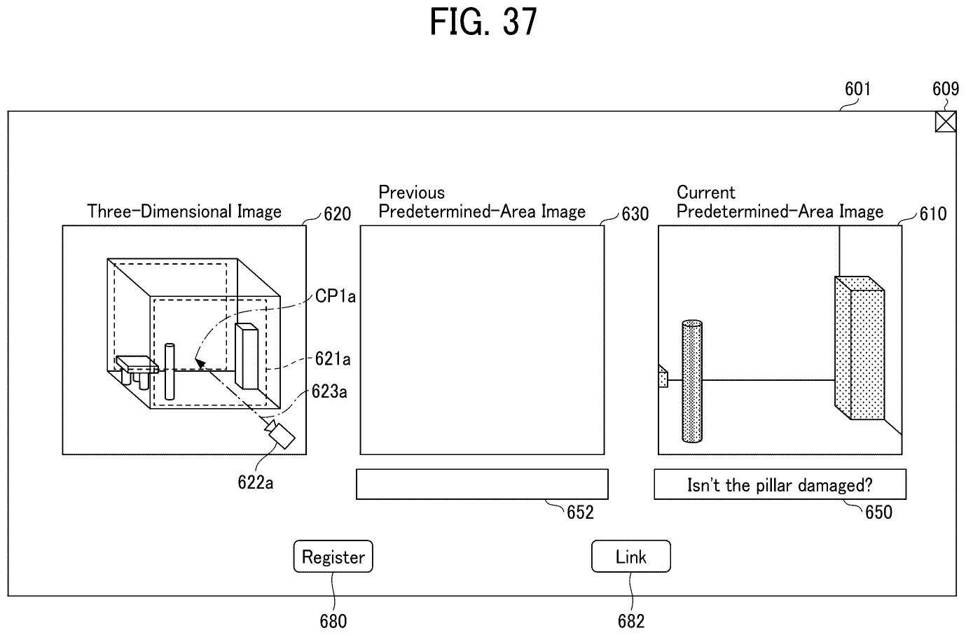

Next, processes or operations according to an embodiment of the present disclosure will be described with reference to FIGS. 19 to 42. The following processes are performed after the image capturing device 10 and the communication terminals 7 and 9 have joined the same virtual room.

### Process for Communicating Content Data in Communication System

A process for communicating content data in the communication system 1 will be described with reference to FIG. 19. FIG. 19 is a sequence diagram illustrating a process of communicating a wide-view image and field-of-view information in the communication system 1. In this embodiment, the image capturing device 10, the communication terminal 7 of the organizer X, the communication terminal 9a of the participant A, and the communication terminal 9b of the participant B are in the same virtual room. In response to the creation of a virtual room, the storing/reading unit 59 adds one record to the virtual room management DB 5002 (see FIG. 15) and manages a virtual room ID, a virtual room name, a device ID, an organizer ID, and a participant ID in association with one another. A content ID, a content URL, a field-of-view information URL, and a three-dimensional image ID are stored later. The processing of steps S11 to S15 of FIG. 19 is repeated, for example, about 30 or 60 times per second.

In step S11, the image capturing device 10 captures a spherical image of an area in the site Sa using the imaging unit 16, and collects sounds around the area in the site Sa using the sound collection unit 17, to obtain content data including the wide-view image and the sound data. After that, the connection unit 18 transmits the content data to the relay device 3. The collected sounds include the voice of the organizer X at the site Sa. The connection unit 18 further transmits the virtual room ID for identifying the virtual room that the image capturing device 10 has joined, and the device ID for identifying the image capturing device 10. The image capturing device 10 further transmits information on an image capturing position, which is a position (absolute position) of the image capturing device 10, to the relay device 3 at predetermined time intervals (e.g., every second). Accordingly, the connection unit 38 of the relay device 3 acquires the content data, the virtual room ID, the device ID, and the information on the image capturing position. The image capturing position is a position obtained by the positioning device 314, and is an absolute position on the earth.

In step S12, the communication unit 31 of the relay device 3 transmits the content data, the virtual room ID, the device ID, and the information on the image capturing position, which are received by the connection unit 38 in step S11, to the communication control apparatus 5 via the communication network 100. Accordingly, the communication unit 51 of the communication control apparatus 5 receives the content data, the virtual room ID, the device ID, and the information on the image capturing position.

The storing/reading unit 59 of the communication control apparatus 5 stores the content data received in step S12 in the virtual room management DB 5002 (see FIG. 15), at the storage location indicated by the content URL corresponding to the virtual room ID received in step S12.

In alternative to performing the processing of step S11, in step S11d, the image capturing device 10 may transmit the content data, the virtual room ID, the device ID, and the information on the image capturing position to the communication terminal 7 without transmitting the data and the information to the relay device 3. Further, in alternative to performing the processing of step S12, in step S12d, the communication terminal 7 transmits the content data, the virtual room ID, the device ID, and the information on the image capturing position to the communication control apparatus 5.

In step S13, in the communication control apparatus 5, the storing/reading unit 59 searches the virtual room management DB 5002 based on the virtual room ID received in step S12 to read the user IDs (the organizer ID and the participant IDs) of the users who are participating in the same virtual room as the image capturing device 10. The storing/reading unit 59 also searches the user device management DB 5001 based on the read organizer ID and participant IDs to read the corresponding user images of the organizer X, the participant A, and the participant B and the corresponding IP addresses of the communication terminal 7, the communication terminal 9a, and the communication terminal 9b. The communication unit 51 refers to the IP address of the communication terminal 7 and communicates bidirectionally with the communication terminal 7. In this case, the communication terminal 7 transmits content data, the virtual room ID, and the user ID of the organizer X, who is the user of the communication terminal 7, to the communication control apparatus 5 at regular intervals (e.g., every 1/30 second or 1/60 second). The content data to be transmitted to the communication control apparatus 5 includes image data of an image captured by the communication terminal 7 and audio data collected by the communication terminal 7. This bidirectional communication will be described below.

In step S14, the communication unit 51 of the communication control apparatus 5 refers to the IP address of the communication terminal 9a and communicates bidirectionally with the communication terminal 9a. In this case, the communication terminal 9a transmits content data, the virtual room ID, and the user ID of the participant A, who is the user of the communication terminal 9a, to the communication control apparatus 5 at regular intervals (e.g., every 1/30 second or 1/60 second). The content data to be transmitted to the communication control apparatus 5 includes image data of an image captured by the communication terminal 9a and audio data collected by the communication terminal 9a. This bidirectional communication will be described below.

In step S15, similarly, the communication unit 51 of the communication control apparatus 5 refers to the IP address of the communication terminal 9b and communicates bidirectionally with the communication terminal 9b. In this case, the communication terminal 9b transmits content data, the virtual room ID, and the user ID of the participant B, who is the user of the communication terminal 9b, to the communication control apparatus 5 at regular intervals (e.g., every 1/30 second or 1/60 second). The content data to be transmitted to the communication control apparatus 5 includes image data of an image captured by the communication terminal 9b and audio data collected by the communication terminal 9b. This bidirectional communication will be described below.

### Process for Starting Image and Sound Recording in Communication System

A process for starting image and sound recording in the communication system 1 will be described with reference to FIG. 20. FIG. 20 is a sequence diagram illustrating a process of starting image and sound recording in the communication system 1.

In step S31, in the communication terminal 7 of the organizer X, the reception unit 72 receives an operation for starting image and sound recording from the organizer X.

Before starting image and sound recording, in step S32, the communication unit 71 of the communication terminal 7 transmits an instruction to share field-of-view information (sharing instruction) to the communication control apparatus 5. The sharing instruction includes the virtual room ID of the virtual room that the communication terminal 7 has joined and the device ID of the image capturing device 10. Accordingly, the communication unit 51 of the communication control apparatus 5 receives the sharing instruction to share the field-of-view information.

In step S33, the storing/reading unit 59 of the communication control apparatus 5 stores the content URL and the field-of-view information URL in the virtual room management DB 5002 (see FIG. 15). The communication unit 51 transmits an instruction to start recording and a request to upload field-of-view information to the communication terminal 7. The instruction to start recording includes information on the content URL indicating a location where the communication terminal 7 stores the content data after recording. The request to upload field-of-view information includes information on the field-of-view information URL indicating a location where the field-of-view information is to be stored. Accordingly, in the communication terminal 7, the communication unit 71 receives the instruction to start recording and the request to upload field-of-view information.

In step S34, the communication unit 51 further transmits a request to upload field-of-view information to the communication terminal 9a. The request to upload field-of-view information includes information on the field-of-view information URL indicating a location where the field-of-view information is to be stored. Accordingly, in the communication terminal 9a, the communication unit 91 receives the request to upload field-of-view information.

In step S35, similarly, the communication unit 51 transmits a request to upload field-of-view information to the communication terminal 9b. The request to upload field-of-view information includes information on the field-of-view information URL indicating a location where the field-of-view information is to be stored. Accordingly, in the communication terminal 9b, the communication unit 91 receives the request to upload field-of-view information.

In step S36, in the communication terminal 7, the storing/reading unit 79 serves as an image recording unit and a sound recording unit, and starts recording the content data received in step S13 illustrated in FIG. 19. In the case where the processing of step S12d is performed instead of step S12 of FIG. 19, the communication terminal 7 starts recording images and sounds, which are included in the content data received from the image capturing device 10 in step S11d, instead of the content data received from the communication control apparatus 5 in step S13.

In the communication terminal 7, for example, in response to the reception unit 72 receiving a change in the field of view from the organizer X while the predetermined-area image (see FIG. 6B) indicating a predetermined area (see FIG. 6A) in the wide-view image received in step S13 is being displayed, in step S37, the display control unit 74 displays a predetermined-area image (see FIG. 6D) indicating a predetermined area (see FIG. 6C) obtained by changing the field of view of the same wide-view image. In this case, the reception unit 72 also serves as an acquisition unit. In response to receiving the display of a predetermined area in the wide-view image from the user (i.e., the organizer X), the reception unit 72 acquires field-of-view information (pan, tilt, and fov) for specifying the predetermined area in the wide-view image to be displayed on the display 507.

The communication unit 71 transmits the field-of-view information for specifying the changed predetermined area to the communication control apparatus 5, so that the field-of-view information URL received in step S33 is updated. The field-of-view information includes the user ID of the organizer X, who is the user of the communication terminal 7 from which the field-of-view information is transmitted. Accordingly, the communication unit 51 of the communication control apparatus 5 receives the field-of-view information.

The storing/reading unit 79 stores the user ID of the organizer X, the field-of-view information, and the reception date and time when the user ID and the field-of-view information are received, in association with the field-of-view information URL managed in the virtual room management DB 5002 (see FIG. 15). The reception date and time is, for example, the date and time when the reception unit 72 of the communication terminal 7 receives the user operation for changing the field of view from the organizer X.

In step S38, processing that is substantially the same as the processing of step S37 is also performed by the communication terminal 9a, independently of the processing of step S37, so that the communication control apparatus 5 receives the field-of-view information. The user ID transmitted in step S38 is the user ID of the participant A. The reception date and time acquired in step S38 is the date and time when the reception unit 92 of the communication terminal 9a receives a user operation for changing the field of view from the participant A.

In step S39, processing that is substantially the same as the processing of step S37 is also performed by the communication terminal 9b, independently of the processing of steps S37 and S38, so that the communication control apparatus 5 receives the field-of-view information. The user ID transmitted in step S39 is the user ID of the participant B. The reception date and time acquired in step S39 is the date and time when the reception unit 92 of the communication terminal 9b receives a user operation for changing the field of view from the participant B.

As described above, in response to receiving a request for changing the predetermined-area image at the communication terminal 7, for example, from the image illustrated in FIG. 6B to the image illustrated in FIG. 6D, the communication control apparatus 5 can manage information regarding the predetermined area that the organizer X is focused on while allowing the organizer X to view the predetermined-area image illustrated in FIG. 6D. Similarly, the communication control apparatus 5 can manage the predetermined area that is viewed and focused on by the participant A on the communication terminal 9a and the predetermined area that is viewed and focused on by the participant B on the communication terminal 9b. The processing of steps S37 to S39 may be collectively executed on the communication control apparatus 5 at the end of the recording.

In the display content lock mode, a particular communication terminal (e.g., the communication terminal 9a) displaying content to be shared transmits the field-of-view information (including the user ID of the participant A) to the communication control apparatus 5, and the other communication terminals do not transmit the field-of-view information in steps S37 to S39. The predetermined-area image, which is displayed at the communication terminal 9a, is displayed at the communication terminals 7 and 9b.

### Process for Stopping Image and Sound Recording in Communication System

A process for stopping image and sound recording in the communication system 1 will be described with reference to FIG. 21. FIG. 21 is a sequence diagram illustrating a process of stopping image and sound recording in the communication system 1.

In step S51, in the communication terminal 7 of the organizer X, the reception unit 72 receives an operation for stopping image and sound recording from the organizer X.

In step S52, the storing/reading unit 79 stops recording the images and sounds included in the content data.

In step S53, the communication unit 71 transmits the content data including the recorded images and sounds to the communication control apparatus 5, so that the content data is uploaded to the storage location indicated by the content URL received in step S33. The content data includes times (timestamps) each indicating a time when the image and the sound are recorded, from the start to the end of the recording. Accordingly, the communication unit 51 of the communication control apparatus 5 receives the content data. The timestamps are the same as the dates and times of image and sound capturing illustrated in FIGS. 18A to 18C.

In step S54, the storing/reading unit 59 of the communication control apparatus 5 stores the content data and the timestamps in the storage location indicated by the content URL. The storing/reading unit 59 converts the timestamps (the dates and times of image and sound capturing) into elapsed playback times, based on the total recording time of the content data for which the recording is stopped, and stores the timestamps and the elapsed playback times in association with each other.

In step S55, the communication unit 51 transmits a notification of the end of recording images and sounds (a recording completion notification) to the communication terminal 7. The recording completion notification includes information indicating the content URL. Accordingly, the communication unit 71 of the communication terminal 7 receives the recording completion notification.

In step S56, similarly, the communication unit 51 transmits a notification of the end of recording images and sounds (a recording completion notification) to the communication terminal 9a. The recording completion notification includes information indicating the content URL. Accordingly, the communication unit 91 of the communication terminal 9a receives the recording completion notification.

In step S57, similarly, the communication unit 51 transmits a notification of the end of recording images and sounds (a recording completion notification) to the communication terminal 9b. The recording completion notification includes information indicating the content URL. Accordingly, the communication unit 91 of the communication terminal 9b receives the recording completion notification.

In one embodiment, in step S55, the recording completion notification does not include the content URL.

### Process for Playing back Recorded Images and Sounds in Communication System

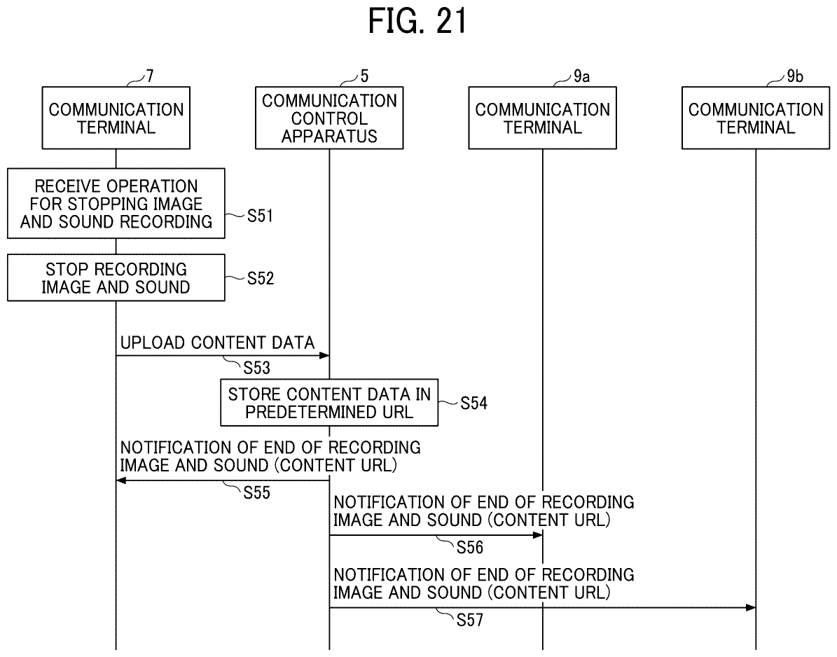

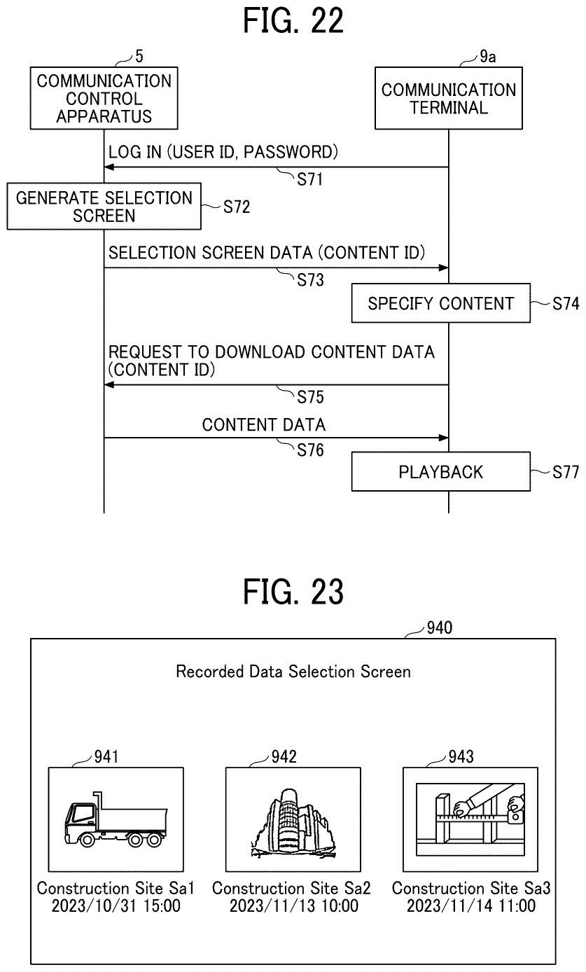

A process for playing back recorded images and sounds in the communication system 1 will be described with reference to FIGS. 22 to 28. FIG. 22 is a sequence diagram illustrating a process of playing back recorded images and sounds in the communication system 1. FIG. 23 is a diagram illustrating a recorded data selection screen. In this example, the participant A uses the communication terminal 9a to play back recorded content data. Alternatively, the organizer X may play back recorded content data using the communication terminal 7, or the participant B may play back recorded content data using the communication terminal 9b.

In response to the reception unit 92 of the communication terminal 9a receiving a login operation of inputting a user ID (the participant ID of the participant A) and a password from the participant A, in step S71, the communication unit 91 transmits a login request to the communication control apparatus 5. The login request includes the user ID and password of the participant A. Accordingly, in the communication control apparatus 5, the communication unit 51 receives the login request, and the authentication unit 55 performs authentication by referring to the user device management DB 5001 (see FIG. 14). The following description is given assuming that the participant A is determined to be an authorized accessor by the login authentication.

In step S72, the generation unit 53 of the communication control apparatus 5 generates a recorded data selection screen 940 as illustrated in FIG. 23. The storing/reading unit 59 searches the virtual room management DB 5002 (see FIG. 15) using the user ID (in this example, the participant ID of the participant A) received in step S71 as a search key, and reads all the corresponding virtual room IDs, virtual room names, and content URLs. The generation unit 53 generates thumbnails 941, 942, and 943 using images included in the content data (with timestamps) stored in the storage locations indicated by the content URLs. As a result, the generation unit 53 assigns each thumbnail a virtual room name, such as “construction site Sa1”, and a recording time, such as “2023/10/31 15:00” (meaning 3 p.m. on Oct. 31, 2023), indicating a predetermined time (e.g., the recording start time) of the timestamp.

In step S73, the communication unit 51 transmits selection screen data of the recorded data selection screen 940 generated in step S72 to the communication terminal 9a. The selection screen data includes, for each thumbnail, a content ID for identifying a wide-view image from which the thumbnail is generated. Accordingly, the communication unit 91 of the communication terminal 9a receives the selection screen data.

In step S74, the display control unit 94 of the communication terminal 9a displays the recorded data selection screen 940 as illustrated in FIG. 23 on the display 507 of the communication terminal 9a. The reception unit 92 receives an operation for specifying (selecting) a particular thumbnail from the participant A. The following description will be given assuming that the thumbnail 941 is specified (selected).

In step S75, the communication unit 91 transmits a request to download the content data from which the selected thumbnail 941 is generated to the communication control apparatus 5. The request includes the content ID associated with the thumbnail 941. Accordingly, the communication unit 51 of the communication control apparatus 5 receives the request to download the content data.

In step S76, the storing/reading unit 59 of the communication control apparatus 5 searches the virtual room management DB 5002 (see FIG. 15) using the content ID received in step S75 as a search key, and reads the content data from the corresponding content URL. The content data also includes position information indicating the position of the image capturing device 10 at the time of image capturing. Further, the storing/reading unit 59 searches the three-dimensional image management DB 5003 (see FIG. 16 or 17) using, as a search key, the three-dimensional image ID associated with the content ID received in step S75 in the virtual room management DB 5002 (see FIG. 15). The storing/reading unit 59 reads the parameters of the model IDs and the position information (see FIG. 16) associated with the three-dimensional ID, or the parameters of the component numbers and the position information (see FIG. 17) associated with the three-dimensional ID.

The communication unit 51 transmits the data of the three-dimensional image together with the requested content data to the communication terminal 9a. Accordingly, the communication unit 91 of the communication terminal 9a receives the content data and the data of the three-dimensional image.

In step S77, the communication terminal 9a performs a playback process. The display control unit 94 of the communication terminal 9a displays a screen including the images that are recorded in step S36 on the display 507 of the communication terminal 9a. The sound input/output control unit 95 outputs the sounds recorded in step S36 through the speaker 512 of the communication terminal 9a.

### Details of Screen Display Process (Registration Process)

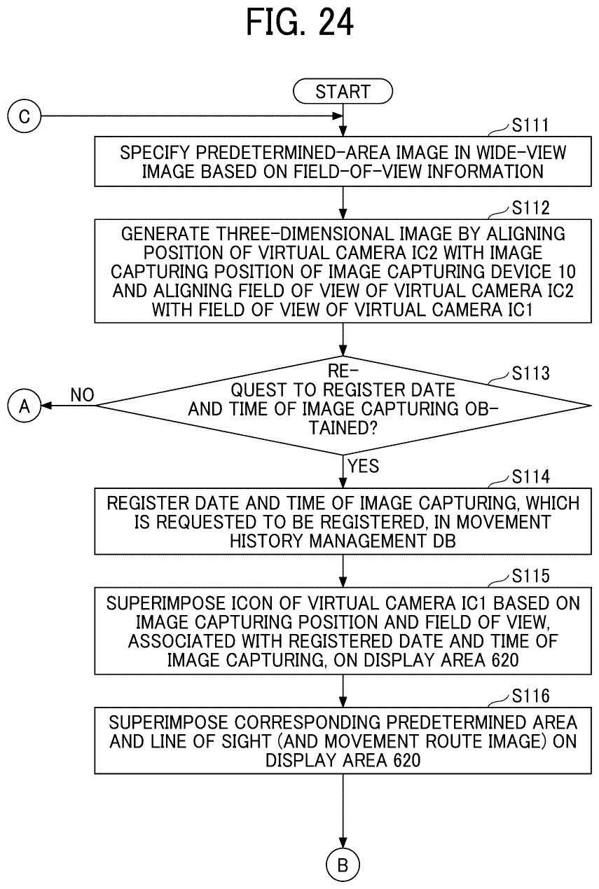

A process in the display content lock mode will be described with reference to FIGS. 24 to 38. The following describes a case in which content displayed on a particular communication terminal (e.g., the communication terminal 9a) is set as target content to be shared. Specifically, of steps S13 to S15 of FIG. 19, the processing of step S14 will be described. When the participant A operates the communication terminal 9a, the reception unit 92 receives the operation, and the communication unit 91 transmits operation information indicating the content of the operation to the communication control apparatus 5. Accordingly, in the communication control apparatus 5, the communication unit 51, which serves as an acquisition unit, acquires the operation information, and the generation unit 53 generates a screen 600 based on the content of the operation indicated by the operation information. The communication unit 51 transmits data of the screen 600 to the communication terminal 9a. The communication unit 91 of the communication terminal 9a receives the data of the screen 600. The display control unit 94 of the communication terminal 9a displays the screen 600 on, for example, the display 507 of the communication terminal 9a. In this example, the communication control apparatus 5 functions as an information processing apparatus.

The communication unit 91 of the communication terminal 9a may receive data used for generating the screen 600 from the communication control apparatus 5. The reception unit 92, which serves as an acquisition unit, may acquire the operation information indicating the content of the operation performed by the participant A. In this case, the generation unit 93 of the communication terminal 9a generates the screen 600 based on the data and the operation information. In this example, the communication terminal 9a functions as an information processing apparatus. Each of the communication terminals 7 and 9b can perform substantially the same process or have substantially the same functions as the communication terminal 9a.

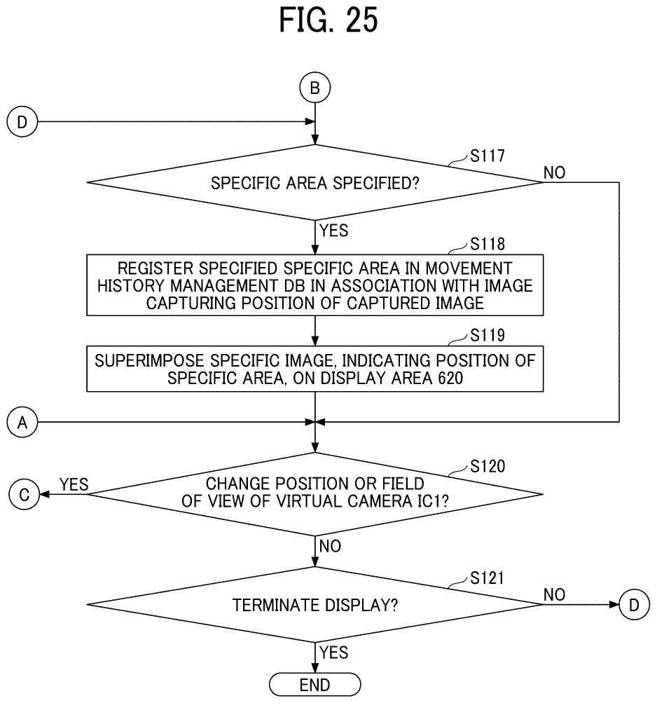

A process for generating the screen 600 to be displayed on the display 507 of the communication terminal 9a, performed by the communication control apparatus 5, will be described. In steps S13 and S15, the communication control apparatus 5 performs the same processing as the processing of step S14, except that the generated screen is displayed on different communication terminals (i.e., the communication terminals 7 and 9b). Thus, descriptions of the processing of steps S13 and S15 will be omitted. FIGS. 24 and 25 illustrate a flowchart of the operation performed by the communication control apparatus 5 in a screen display process.

The generation unit 53 of the communication control apparatus 5 generates the screen 600 to be displayed on the communication terminal 9a, as illustrated in FIG. 26. FIG. 26 is a diagram illustrating an example of an initial display screen displayed on the communication terminal 9a. The screen 600 includes a display area 610 and a display area 620. The display area 610 is an example of a captured image display area. The display area 620 is an example of a three-dimensional image area. In FIG. 26, the display area 610 and the display area 620 are displayed simultaneously in the same size on the screen 600. Alternatively, the display area 610 and the display area 620 may be displayed simultaneously in different sizes. Alternatively, one of the display area 610 and the display area 620 may be selectively displayed in accordance with the selection made by the participant A. Alternatively, the screen 600 may be divided into a plurality of sections. For example, the display area 610 may be displayed on one of two displays, and the display area 620 may be displayed on the other one of the two displays.

The display area 610 displays a predetermined-area image (see FIG. 6B) representing a predetermined area (see FIG. 6A) in a wide-view image. The wide-view image is an example of a captured image and is obtained by the image capturing device 10 capturing an image of objects such as a desk, a pillar, and a window.

When the captured image is not a curved image such as a wide-view image, the display area 610 displays a predetermined-area image representing a predetermined area that is the same area as the imaging area of the captured image.

The display area 620 displays a three-dimensional image that includes three-dimensional models representing the shapes of the objects in three dimensions. The three-dimensional image further includes the coordinates (an example of second coordinates) corresponding to the coordinates of the positions of the objects in the wide-view image (an example of first coordinates). In this case, the display area 620 displays a portion or all of the three-dimensional image.

As described with reference to FIGS. 18A to 18C, the image capturing position, which is the position of the image capturing device 10, is associated with the absolute position on the earth. As described with reference to FIGS. 16 and 17, all coordinates in the three-dimensional image including the three-dimensional models and components managed in the three-dimensional image management DB 5003 are also associated with the absolute positions on the earth.

Accordingly, the processing unit 54 performs alignment processing for the wide-view image and the three-dimensional image. Specifically, the processing unit 54 associates, for example, first coordinates in the wide-view image and second coordinates in the three-dimensional image with each other. The first coordinates indicate, as a first position, the image capturing position in the wide-view image of the content data received by the communication control apparatus 5 in step S12 (or S12d). The second coordinates indicate, as a second position, the position in the three-dimensional image that has the same absolute position as the first coordinates. The coordinates are an example of the position information.

As another example of alignment processing, the processing unit 54 may associate the coordinates indicating the first position in the wide-view image with the coordinates indicating the second position in the three-dimensional image by image processing such as matching features of the edges or texture of the wide-view image and the three-dimensional image, without using the absolute position on the earth (including indoor spaces) or in order to complement the absolute position.

As described above, the generation unit 53 generates the screen 600 including the display area 610 and the display area 620. The display area 610 displays the predetermined-area image, which represents a predetermined area in the wide-view image. The display area 620 displays at least a portion of the three-dimensional image in which the second position (second coordinates) is associated with the first position (first coordinates) in the wide-view image by the processing unit 54.

When the three-dimensional image management DB 5003 illustrated in FIG. 16 or 17 stores, as a data item to be managed, for example, a three-dimensional point cloud, a mesh object, or a textured mesh object instead of the three-dimensional model, the display area 620 displays at least a portion of a three-dimensional image including the three-dimensional point cloud, the mesh object, or the textured mesh object as a three-dimensional area corresponding to an object included in a wide-view image.

The screen 600 further includes a “register” button 680. The “register” button 680 is pressed to display an icon of the virtual camera IC1 in the display area 620 at a position corresponding to the image capturing position of the image capturing device 10. The virtual camera IC1 has an imaging area, which is determined by a field of view (or field-of-view information) for specifying a predetermined area corresponding to the predetermined-area image being displayed in the display area 610.

The screen 600 further includes a close button 609. The close button 609 is pressed to close the screen 600.

The content displayed on the screen 600 will be described in detail below. The virtual camera IC1 is used to specify a predetermined area depicted in the predetermined-area image displayed in the display area 610 (see FIG. 8). A virtual camera IC2 described below is used to specify a three-dimensional image to be displayed in the display area 620.

In step S111, the generation unit 53 of the communication control apparatus 5 specifies, in the wide-view image of the content data received by the communication unit 51, a predetermined-area image to be displayed in the display area 610 as illustrated in FIG. 26, based on the field-of-view information. The field-of-view information indicates a preset virtual field of view of the virtual camera IC1.

In step S112, the processing unit 54 aligns the position of the virtual camera IC2 with the image capturing position included in the wide-view image obtained by the image capturing device 10. The processing unit 54 further aligns the virtual field of view of the virtual camera IC2 (an example of a second field of view) with the preset virtual field of view of the virtual camera IC1 (an example of a first field of view). Accordingly, the generation unit 53 generates a three-dimensional image to be displayed in the display area 620.

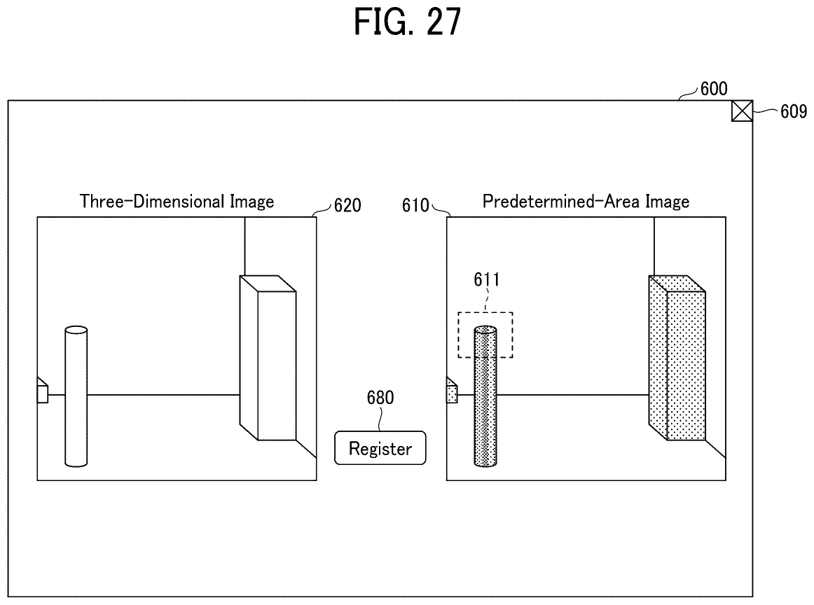

As illustrated in FIG. 27, the specifying processing unit 57 specifies a specific area 611 in the display area 610 from the captured image. FIG. 27 is a diagram illustrating an example of a screen displayed on the communication terminal 9a on which the specific area 611 is specified. The specific area 611 is an area specified in the display area 610 by the user through an operation input. For example, the user specifies the specific area 611 by operating an input device such as the mouse to input an instruction. The user specifies an area of concern (e.g., a defective area) as the specific area 611.

The specific area 611 may be an area specified by image recognition processing using text information by the specifying processing unit 57. The text information represents transcribed text generated from sounds collected when the captured image is obtained or input text entered by the user. For example, the user may specify the specific area 611 by image recognition processing by speaking about an area of concern and using text information representing text generated from the speech made by the user, such as “The upper portion of the pillar is damaged”.

In FIG. 27, the specific area 611 is outlined by a broken line. The specific area 611 may be displayed using another display mode. The display mode may include a broken line and a solid line of a specified color. The broken line and the solid line may have different thicknesses from other parts of the display. The specific area 611 may be an area to be masked.

In step S113, the communication unit 51 determines whether a request to register the date and time of image capturing (a registration request) is obtained from the communication unit 91, based on whether the “register” button 680 has been pressed using the communication terminal 9a.

If the registration request is obtained (YES in step S113), in step S114, the processing unit 54 registers the date and time of image capturing, which is requested to be registered, in the movement history management DB 5004 (see FIG. 18C). The processing unit 54 sets the flag in the “registered” field illustrated in FIG. 18C in accordance with the registration request. The date and time when the registration request is obtained is registered as the date and time of image capturing.

As described above with reference to FIGS. 18A to 18C, the movement history management DB 5004 stores, for each content ID, a date and time of image and sound capturing, an image capturing position, field-of-view information, text information, and specific area information in association with one another as data items to be managed.

As described with reference to FIG. 15, the virtual room management DB 5002 stores a content ID and a content URL in association with each other as data items to be managed. The content URL is storage location information indicating a storage location of content data including a wide-view image and sound.

Accordingly, the image capturing position, the field-of-view information, the wide-view image, the sound (voice), and the specific area information are associated with the registered date and time of image capturing.

The field-of-view information is information for specifying the predetermined area representing the predetermined-area image displayed on the communication terminal 9. Thus, the image capturing position, the predetermined-area image, the sound (voice), and the specific area are associated with the registered date and time of image capturing.

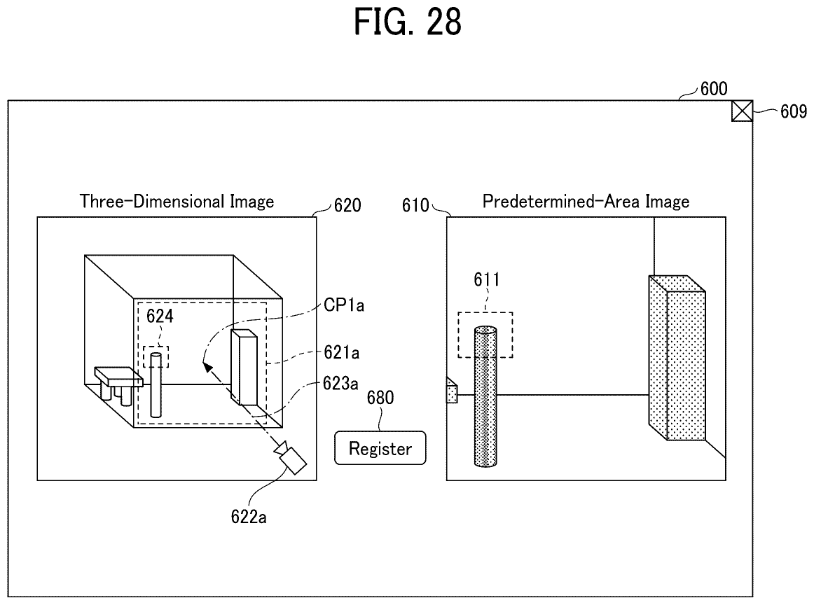

In step S115, as illustrated in FIG. 28, the generation unit 53 superimposes an icon 622a of the virtual camera IC1 on the display area 620 at a position corresponding to the image capturing position, based on the image capturing position and the field of view that are associated with the date and time of image capturing registered in step S114. FIG. 28 is a diagram illustrating an example of a screen on which a corresponding predetermined area, the icon 622a of the virtual camera IC1, and a line indicating the line of sight of the virtual camera IC1 are displayed in the display area 620.

In step S116, as illustrated in FIG. 28, the generation unit 53 further superimposes a corresponding predetermined area 621a on the display area 620. The corresponding predetermined area 621a corresponds to the field of view of the virtual camera IC1. FIG. 28 illustrates a state in which a screen on which the icon 622a of the virtual camera IC1, the corresponding predetermined area 621a, and the line indicating the line of sight of the virtual camera IC1 are superimposed is displayed on the communication terminal 9a. The corresponding predetermined area 621a is an area in the display area 620, which corresponds to the predetermined area depicted in the predetermined-area image displayed in the display area 610. In FIG. 28, the corresponding predetermined area 621a is outlined by a broken line. The corresponding predetermined area 621a may be displayed using another display mode. The display mode may include a broken line and a solid line of a specified color. The broken line and the solid line may have different thicknesses from other parts of the display.

The generation unit 53 superimposes the icon 622a of the virtual camera IC1 on the display area 620 at a position corresponding to the image capturing position of the image capturing device 10. The icon 622a is placed so that the virtual camera IC1 is directed to a center point CP1a of the corresponding predetermined area 621a. The icon 622a is an example of a schematic diagram (image) of the virtual camera IC1. The schematic diagram may include, for example, characters such as “camera” or a figure including the characters, in addition to the icon.

Further, the generation unit 53 superimposes a line 623a on the display area 620 to indicate the line of sight of the virtual camera IC1 from the icon 622a towards the center point CP1a of the corresponding predetermined area 621a. The line 623a may be a solid line or a broken line or may be displayed with a thickness or color different from those of other lines.

In step S117, as illustrated in FIG. 28, the specifying processing unit 57 determines whether the specific area 611 is specified in the display area 610.

If it is determined that the specific area 611 is specified (YES in step S117), in step S118, the processing unit 54 registers the specified specific area 611 in the movement history management DB 5004 (see FIG. 18C) in association with the image capturing position of the captured image.

In step S119, as illustrated in FIG. 28, the generation unit 53 further superimposes a specific image 624, which indicates the position of the specific area 611, on the display area 620. The specific image 624 indicates the position of the specific area 611 specified in the display area 610. By referring to a three-dimensional image on which the specific image 624 indicating the position of the specific area 611 is superimposed, the user can easily recognize the position of the specific area 611, resulting in improved convenience.

In FIG. 28, the specific image 624 is outlined by a broken line. The specific image 624 may be displayed using another display mode. The display mode may include a broken line and a solid line of a specified color. The broken line and the solid line may have different thicknesses from other parts of the display.

After the processing of step S119, or if the registration request is not obtained in step S113 (NO in step S113), in step S120, the generation unit 53 determines whether the position or the field of view of the virtual camera IC1 in the display area 610 has been changed (see FIG. 6C). For example, when the participant A performs an operation of changing the predetermined-area image in the display area 610 illustrated in FIG. 28, the reception unit 92 receives the changed field of view, and the communication unit 91 transmits field-of-view information indicating the changed field of view to the communication control apparatus 5. When the communication unit 51 receives the field-of-view information indicating the changed field of view, the generation unit 53 determines that the field of view of the virtual camera IC1 has been changed. If the position or the field of view of the virtual camera IC1 has been changed (YES in step S120), the process returns to step S111. Through the repetition of the processing of steps S111 to S119, even when the “register” button 680 is pressed at different times, the communication unit 51 accepts a registration request each time the “register” button 680 is pressed. The processing unit 54 registers a flag corresponding to each registration request in the movement history management DB 5004. The generation unit 53 may superimpose icons 622a of a plurality of virtual cameras IC1 on the display area 620.

When the image capturing positions of the plurality of virtual cameras IC1 are the same, the generation unit 53 may superimpose the icon 622a of one virtual camera IC1 among the virtual cameras IC1 on the display area 620, and register a flag corresponding to each registration request in the movement history management DB 5004 in association with the icon 622a of the one virtual camera IC1.

If the reception unit 92 receives an instruction to terminate the display of the screen 600 in response to, for example, the close button 609 being pressed by the participant A (YES in step S121), the display control unit 94 terminates the display of the screen 600. If the reception unit 92 does not receive an instruction to terminate the display of the screen 600 (NO in step S121), the process returns to S117. The process illustrated in FIGS. 24 and 25 is continued until the transmission of the content data to the communication control apparatus 5, performed in step S14 of FIG. 19, ends.

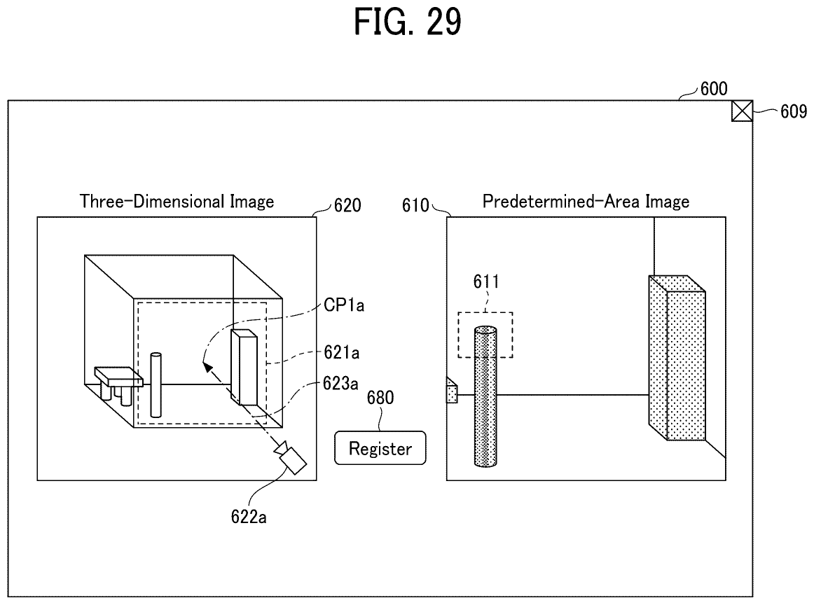

The specific area 611 may be specified from the captured image at, for example, a time within a time period during which a screen 600 illustrated in FIG. 29 is displayed, instead of a time within the time period during which the screen 600 illustrated in FIG. 27 is displayed.

As illustrated in FIG. 29, the specifying processing unit 57 specifies a specific area 611 in the display area 610 from the captured image. FIG. 29 is a diagram illustrating an example of a screen displayed on the communication terminal 9a on which the specific area 611 is specified. The specific area 611 is an area specified in the display area 610 by the user through an operation input. The specific area 611 may be an area specified by image recognition processing using text information. The text information corresponds to text generated from sounds collected when the captured image is obtained or text entered by the user.

In response to the “register” button 680 being pressed on the screen 600 illustrated in FIG. 29, the processing unit 54 performs the processing of steps S114 to S119, and stores, in the movement history management DB 5004 (see FIG. 18C), for each content ID, the date and time of image and sound capturing, the image capturing position, the field-of-view information, the text information, and the specific area information in association with one another. Accordingly, the image capturing position, the field-of-view information, the wide-view image, the sound (voice), and the specific area information are associated with the registered date and time of image capturing.

As illustrated in FIG. 29, the generation unit 53 superimposes the icon 622a of the virtual camera IC1 on the display area 620 at a position corresponding to the image capturing position, based on the image capturing position and the field of view that are associated with the date and time of image capturing registered in step S114.

As illustrated in FIG. 29, the generation unit 53 further superimposes the corresponding predetermined area 621a, which corresponds to the field of view of the virtual camera IC1, on the display area 620. The generation unit 53 superimposes the icon 622a of the virtual camera IC1 on the display area 620 at a position corresponding to the image capturing position of the image capturing device 10. The icon 622a is placed so that the virtual camera IC1 is directed to the center point CP1a of the corresponding predetermined area 621a. Further, the generation unit 53 superimposes the line 623a on the display area 620 to indicate the line of sight of the virtual camera IC1 from the icon 622a towards the center point CP1a of the corresponding predetermined area 621a.

As illustrated in FIG. 28, the generation unit 53 further superimposes the specific image 624, which indicates the position of the specific area 611, on the display area 620. As described above, the specific area 611 may be specified from the captured image at a time within the time period during which the screen 600 illustrated in FIG. 27 is displayed before the icon 622a is displayed or at a time within the time period during which the screen 600 illustrated in FIG. 29 is displayed after the icon 622a is displayed.

### Variation (1) of Registration Process

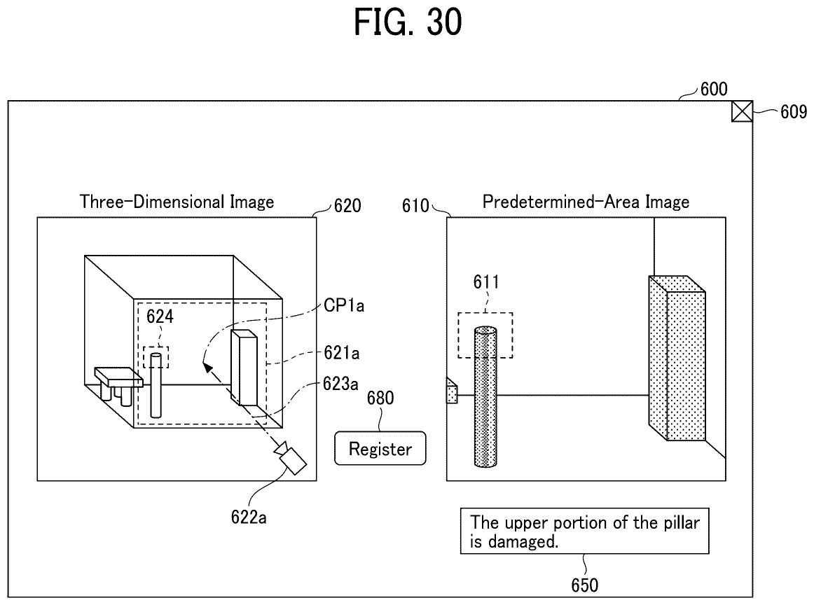

Variation (1) of the registration process will be described with reference to FIGS. 30 to 35.

In one example, as illustrated in FIG. 30, the screen 600 may also display a display area 650 for displaying text information. FIG. 30 is a diagram illustrating a screen that includes a display area for displaying text information.

The display area 650 is displayed below the display area 610 on the screen 600 illustrated in FIG. 30. The display area 650 displays text information. The text information corresponds to text based on audio produced within a predetermined time period including the elapsed playback time of the image being displayed in the display area 610. For example, in FIG. 18C, the date and time of image and sound capturing (elapsed playback time) is “2023/12/11 10:00:08”, which means 10:00:08 on Dec. 11, 2023. In this case, the generation unit 53 uses the text “The lower portion of the pillar is damaged”, which is registered in the period from 2023/12/11 10:00:07 to 2023/12/11 10:00:09, which means the period from 10:00:07 to 10:00:09 on Dec. 11, 2023, to generate text information (e.g., a text message) to be displayed in the display area 650. In the period from 2023/12/11 10:00:07 to 2023/12/11 10:00:09, no change is made to the image capturing position or the field-of-view information. The display area 650 may display text information corresponding to text entered by the user.

In response to the “register” button 680 being pressed on the screen 600 illustrated in FIG. 30, the processing unit 54 performs the processing of steps S114 to S119, and stores, in the movement history management DB 5004 (see FIG. 18C), for each content ID, the date and time of image and sound capturing, the image capturing position, the field-of-view information, the text information (the text “The upper portion of the pillar is damaged.”), and the specific area 611 in association with one another. Accordingly, the image capturing position, the field-of-view information, the wide-view image, the text information in the display area 650, and the specific area 611 in the display area 610 are associated with the registered date and time of image capturing.

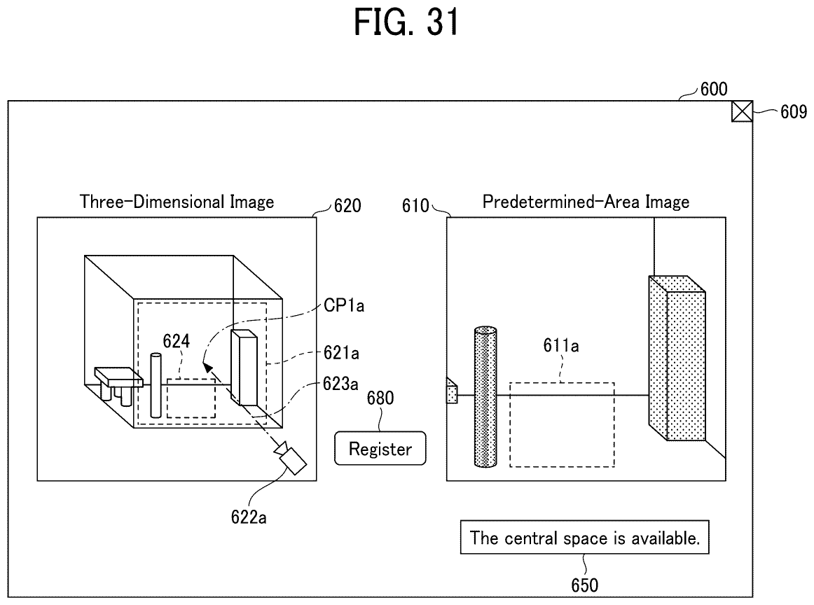

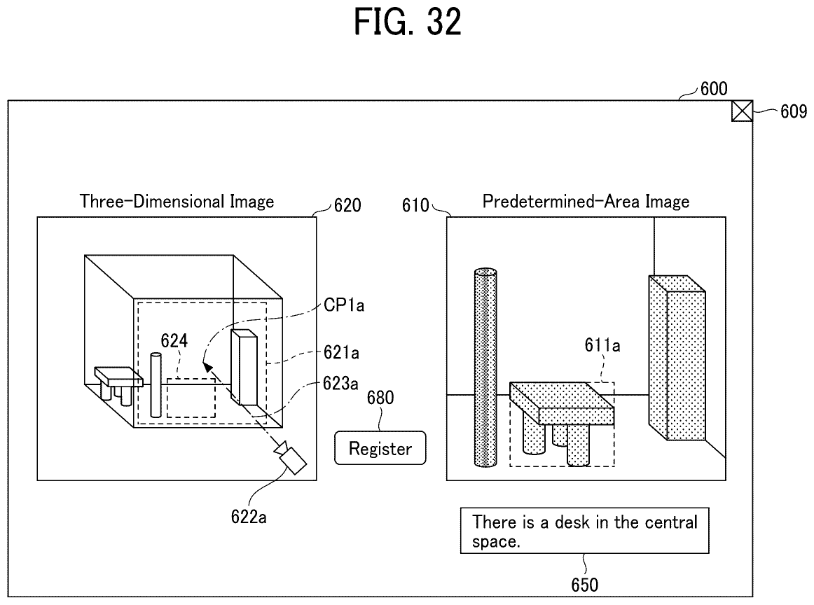

As presented on screens 600 illustrated in FIGS. 31 and 32, the processing unit 54 performs a process for associating a specific area 611 in each of a plurality of captured images, which are captured at different times based on the position information indicating the image capturing position where the image capturing device 10 captures an image and audio, with the icon 622a of the virtual camera IC1 based on the image capturing position and the field of view that are associated with the date and time of image capturing registered in step S114.

For example, as illustrated in FIG. 31, the specifying processing unit 57 specifies a specific area 611a in the display area 610 from the captured image. FIG. 31 is a diagram illustrating an example of a screen displayed on the communication terminal 9a on which the specific area 611a is specified. The specific area 611a is an area specified in the display area 610 by the user through an operation input. For example, the user specifies the specific area 611a by operating an input device such as the mouse to input an instruction. The specific area 611a may be an area specified in the display area 610 from the captured image by image recognition processing using text information (the text “The central space is available.”) displayed in the display area 650.

In response to the “register” button 680 being pressed on the screen 600 illustrated in FIG. 31, the processing unit 54 performs the processing of steps S114 to S119, and stores, in the movement history management DB 5004 (see FIG. 18C), for each content ID, the date and time of image and sound capturing, the image capturing position, the field-of-view information, the user ID, the text information (the text “The central space is available.”), and the specific area 611a in association with one another. Accordingly, the processing unit 54 associates the specific area 611a, which is specified in the display area 610 from the captured image, with the icon 622a of the virtual camera IC1 based on the image capturing position and the field of view that are associated with the date and time of image capturing registered in step S114.

For example, as illustrated in FIG. 32, the specifying processing unit 57 specifies a specific area 611a in the display area 610 from the captured image. FIG. 32 is a diagram illustrating an example of a screen displayed on the communication terminal 9a on which the specific area 611a is specified. The specific area 611a is an area specified in the display area 610 by the user through an operation input. For example, the user specifies the specific area 611a by operating an input device such as the mouse to input an instruction. The specific area 611a may be an area specified in the display area 610 from the captured image by image recognition processing using text information (the text “There is a desk in the central space.”) displayed in the display area 650.

In response to the “register” button 680 being pressed on the screen 600 illustrated in FIG. 32, the processing unit 54 performs the processing of steps S114 to S119, and stores, in the movement history management DB 5004 (see FIG. 18C), for each content ID, the date and time of image and sound capturing, the image capturing position, the field-of-view information, the text information (the text “There is a desk in the central space.”), and the specific area 611a in association with one another. Accordingly, the processing unit 54 associates the specific area 611a, which is specified in the display area 610 from the captured image, with the icon 622a of the virtual camera IC1 based on the image capturing position and the field of view that are associated with the date and time of image capturing registered in step S114.

The specific area 611a illustrated in FIG. 31 and the specific area 611a illustrated in FIG. 32 are examples of specific areas 611 corresponding to respective ones of a plurality of images captured at different times. When the user presses the “register” button 680 on each of the screens 600 illustrated in FIGS. 31 and 32, each of the specific areas 611 corresponding to respective ones of a plurality of images captured at different times can be associated with the icon 622a of the virtual camera IC1 based on the image capturing position and the field of view that are associated with the date and time of image capturing registered in step S114.

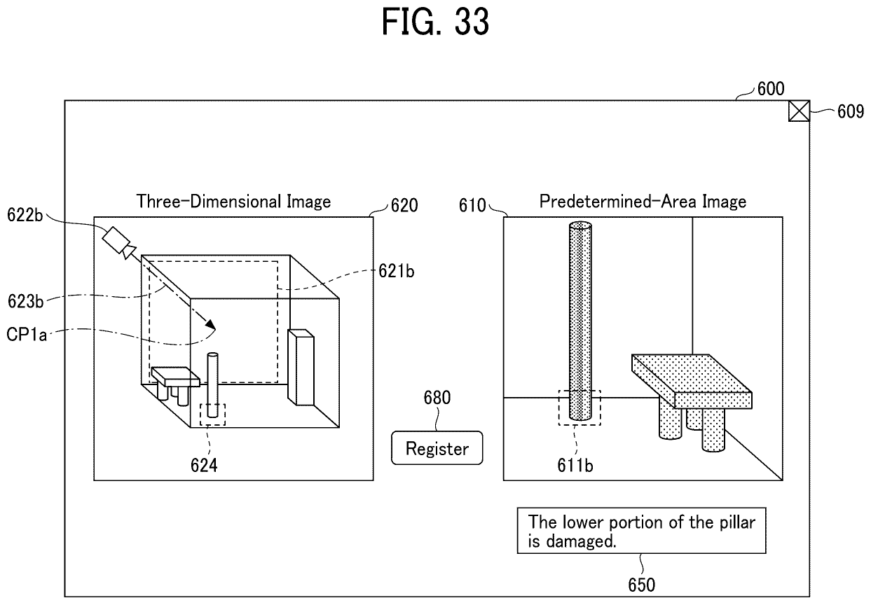

FIG. 33 is a diagram illustrating another example of a screen displayed on the communication terminal 9a on which an icon of the virtual camera IC1, a corresponding predetermined area, and a line indicating the line of sight of the virtual camera IC1 are superimposed. As illustrated in FIG. 33, as the image capturing position of the image capturing device 10 changes from the image capturing position illustrated in FIG. 30 to the image capturing position illustrated in FIG. 33, the content displayed in the display areas 610 and 620 also changes from the content displayed in the display areas 610 and 620 illustrated in FIG. 30 to the content displayed in the display areas 610 and 620 illustrated in FIG. 33. The display area 620 illustrated in FIG. 33 displays a corresponding predetermined area 621b, an icon 622b of the virtual camera IC1, and a line 623b indicating the line of sight of the virtual camera IC1.

As presented on the screens 600 illustrated in FIGS. 30 and 33, the positions of the icon 622a of the virtual camera IC1 and the specific area 611 illustrated in FIG. 30 are different from the positions of the icon 622b of the virtual camera IC1 and a specific area 611b illustrated in FIG. 33. The processing unit 54 performs a process on each of a plurality of images captured at different image capturing positions to associate an image (e.g., the icon 622a) indicating one of the image capturing positions with the specific area 611 and associate an image (e.g., the icon 622b) indicating another of the image capturing positions with the specific area 611b.

For example, as illustrated in FIG. 33, the specifying processing unit 57 specifies the specific area 611b in the display area 610 from the captured image. The specific area 611b is an area specified in the display area 610 by the user through an operation input. The specific area 611b may be an area specified in the display area 610 from the captured image by image recognition processing using text information (the text “The lower portion of the pillar is damaged.”) displayed in the display area 650.

In response to the “register” button 680 being pressed on the screen 600 illustrated in FIG. 33, the processing unit 54 performs the processing of steps S114 to S119, and stores, in the movement history management DB 5004 (see FIG. 18C), for each content ID, the date and time of image and sound capturing, the image capturing position, the field-of-view information, the text information (the text “The lower portion of the pillar is damaged.”), and the specific area 611b in association with one another. Accordingly, the processing unit 54 associates the specific area 611b, which is specified in the display area 610 from the captured image, with the icon 622b of the virtual camera IC1 based on the image capturing position and the field of view that are associated with the date and time of image capturing registered in step S114.

When the user presses the “register” button 680 on the screen 600 illustrated in FIG. 30, the specific area 611 and the icon 622a of the virtual camera IC1 can be associated with each other on the screen 600 illustrated in FIG. 30. When the user presses the “register” button 680 on the screen 600 illustrated in FIG. 33, the specific area 611b and the icon 622b of the virtual camera IC1 can be associated with each other on the screen 600 illustrated in FIG. 33.

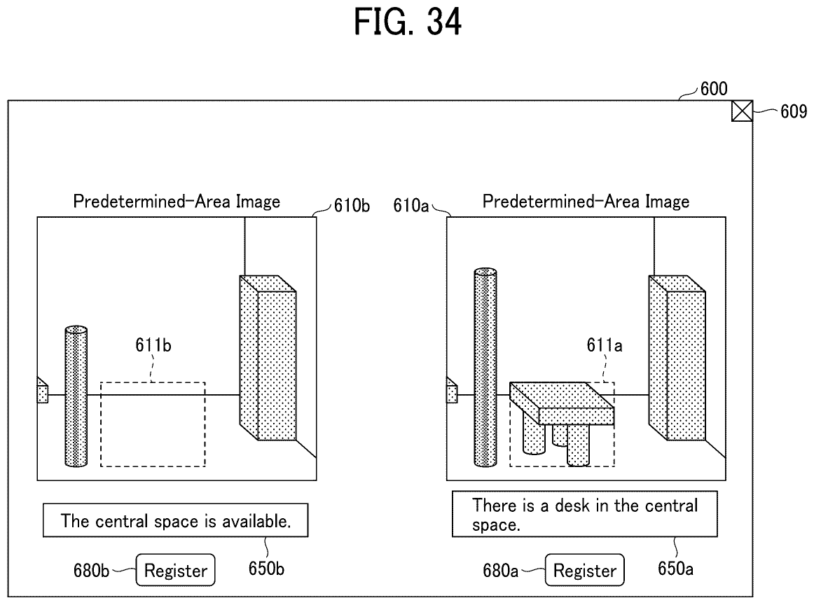

As illustrated in FIG. 34, the generation unit 53 may generate the screen 600, which displays specific areas 611a and 611b specified in the captured image, and display areas 650a and 650b respectively associated with the specific areas 611a and 611b, to allow the user to specify a specific area to be associated with the icon 622a of the virtual camera IC1 based on the image capturing position and the field of view that are associated with the date and time of image capturing registered in step S114.

In another example, the screen 600 illustrated in FIG. 34 includes “register” buttons 680a and 680b. In response to the “register” button 680a being pressed on the screen 600 illustrated in FIG. 34, the processing unit 54 associates a specific area 611a, which is specified in a display area 610a from the captured image, with the icon 622a of the virtual camera IC1 based on the image capturing position and the field of view. In response to the “register” button 680b being pressed on the screen 600 illustrated in FIG. 34, the processing unit 54 associates a specific area 611b, which is specified in a display area 610b from the captured image, with the icon 622a of the virtual camera IC1 based on the image capturing position and the field of view.

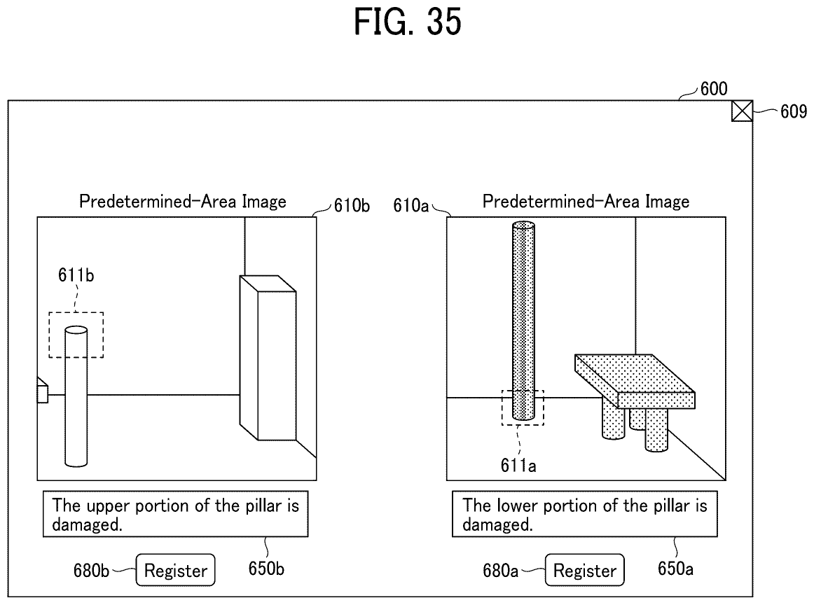

In another example, as illustrated in FIG. 35, the generation unit 53 may generate the screen 600, which displays specific areas 611a and 611b each specified in the captured image, and display areas 650a and 650b respectively associated with the specific areas 611a and 611b, to allow the user to specify a specific area to be associated with the icon 622a or 622b of the virtual camera IC1 based on the image capturing position and the field of view that are associated with the date and time of image capturing registered in step S114.

The screen 600 illustrated in FIG. 35 includes “register” buttons 680a and 680b. In response to the “register” button 680a being pressed on the screen 600 illustrated in FIG. 35, the processing unit 54 associates a specific area 611a, which is specified in a display area 610a from the captured image, with the icon 622a or 622b of the virtual camera IC1 based on the image capturing position and the field of view. In response to the “register” button 680b being pressed on the screen 600 illustrated in FIG. 35, the processing unit 54 associates a specific area 611b, which is specified in a display area 610b from the captured image, with the icon 622a or 622b of the virtual camera IC1 based on the image capturing position and the field of view.

### Variation (2) of Registration Process

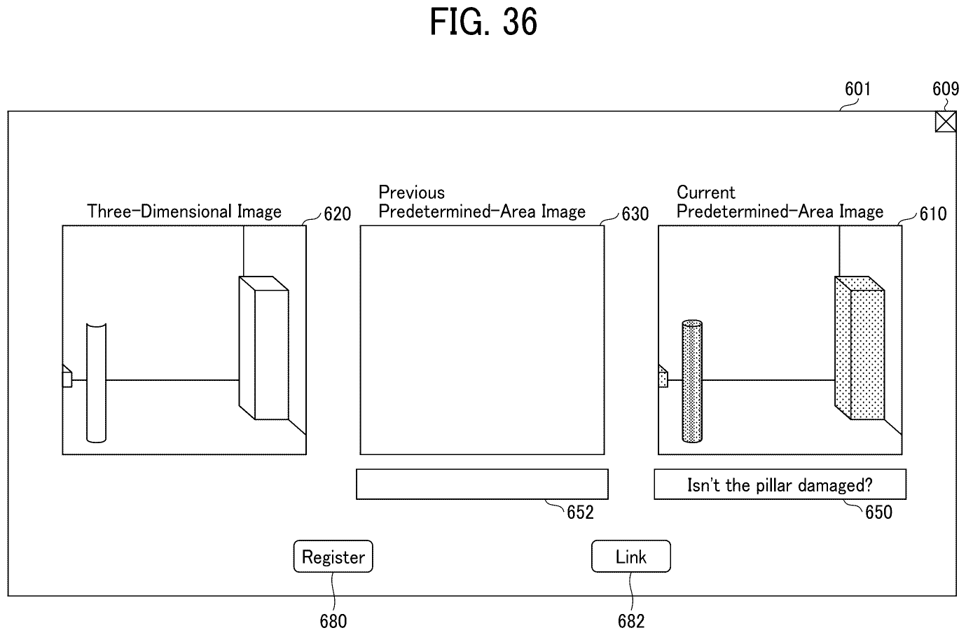

Variation (2) of the registration process will be described with reference to FIGS. 36 to 38.

The generation unit 53 of the communication control apparatus 5 generates a screen 601 to be displayed on the communication terminal 9a, as illustrated in FIG. 36. FIG. 36 is a diagram illustrating an example of an initial display screen displayed on the communication terminal 9a. The screen 601 includes a display area 610, a display area 620, and a display area 630. The display area 610 is an example of a first captured image display area. The display area 620 is an example of a three-dimensional image area. The display area 630 is an example of a second captured image display area. In FIG. 36, the display area 610, the display area 620, and the display area 630 are displayed simultaneously in the same size on the screen 601. Alternatively, the display area 610, the display area 620, and the display area 630 may be displayed simultaneously in different sizes. Alternatively, one of the display area 610, the display area 620, and the display area 630 may be selectively displayed in accordance with the selection made by the participant A. Alternatively, the screen 601 may be divided into a plurality of sections. For example, each of the display areas 610, 620, and 630 may be displayed on one of three displays.

The display area 610 displays a predetermined-area image (see FIG. 6B), which is a predetermined area (see FIG. 6A) in a current wide-view image. The current wide-view image is an example of a current captured image and is obtained by the image capturing device 10 capturing an image of objects such as a desk, a pillar, and a window. When the current captured image is not a curved image such as a wide-view image, the display area 610 displays a predetermined-area image representing a predetermined area that is the same area as the imaging area of the current captured image.

The display area 620 displays a portion of or all of a three-dimensional image that includes a three-dimensional model representing the shape of an object, such as a table or a pillar, in three dimensions. In the three-dimensional image, coordinates (an example of second coordinates) are associated with coordinates (an example of first coordinates) in the wide-view image.

The display area 630 displays a predetermined-area image (see FIG. 6B), which is a predetermined area (see FIG. 6A) in a previous wide-view image. The previous wide-view image is an example of a previous captured image and is obtained by the image capturing device 10 capturing an image of the objects. When the previous captured image is not a curved image such as a wide-view image, the display area 630 displays a predetermined-area image representing a predetermined area that is the same area as the imaging area of the previous captured image.

As described with reference to FIGS. 18A to 18C, the image capturing position, which is the position of the image capturing device 10, is associated with the absolute position on the earth. As described with reference to FIGS. 16 and 17, all coordinates in the three-dimensional image including the three-dimensional models and components managed in the three-dimensional image management DB 5003 are also associated with the absolute positions on the earth.

Accordingly, the processing unit 54 performs alignment processing. For example, the processing unit 54 associates coordinates in the current wide-view image, coordinates in the three-dimensional image, and coordinates in the previous wide-view image with one another. The coordinates in the current wide-view image indicate, as a first position, the image capturing position in the current wide-view image of the content data received by the communication control apparatus 5 in step S12 (or S12d). The coordinates in the three-dimensional image indicate, as a second position, the position in the three-dimensional image that has the same absolute position as the coordinates in the current wide-view image. The coordinates in the previous wide-view image indicate, as a third position, the image capturing position in the previous wide-view image. The coordinates are an example of the position information.

As another example of alignment processing, the processing unit 54 may associate the coordinates indicating the first position in the current wide-view image, the coordinates indicating the second position in the three-dimensional image, and the coordinates indicating the third position in the previous wide-view image with one another by image processing such as matching features of the current wide-view image and the three-dimensional image, without using the absolute position on the earth, for example.

As described above, the generation unit 53 generates the screen 601 including the display area 610, the display area 620, and the display area 630. The display area 610 displays the predetermined-area image, which represents a predetermined area in the current wide-view image. The display area 620 displays at least a portion of the three-dimensional image in which the second position (second coordinates) is associated with the first position (first coordinates) in the current wide-view image. The display area 630 displays the predetermined-area image, which represents a predetermined area in the previous wide-view image in which the third position (third coordinates) is associated with the first position (first coordinates).

When the three-dimensional image management DB 5003 illustrated in FIG. 16 or 17 stores, as a data item to be managed, for example, a three-dimensional point cloud, a mesh object, or a textured mesh object instead of the three-dimensional model, the display area 620 displays at least a portion of a three-dimensional image including the three-dimensional point cloud, the mesh object, or the textured mesh object as a three-dimensional area corresponding to an object included in a wide-view image.

The screen 601 further includes a “register” button 680 and a “link” button 682. The “register” button 680 is pressed to display an icon of the virtual camera IC1 in the display area 620 at a position corresponding to the image capturing position of the image capturing device 10. The virtual camera IC1 has an imaging area, which is determined by a field of view (or field-of-view information) for specifying a predetermined area corresponding to the predetermined-area image being displayed in the display area 610. The “link” button 682 is pressed to link the current captured image and the previous captured image using a specific image indicating the position of a specific area described below.

The screen 601 further includes a close button 609. The close button 609 is pressed to close the screen 601.

The content displayed on the screen 601 will be described in detail below. The virtual camera IC1 is used to specify a predetermined area depicted in the predetermined-area image displayed in the display area 610 (see FIG. 8). A virtual camera IC2 described below is used to specify a three-dimensional image to be displayed in the display area 620.

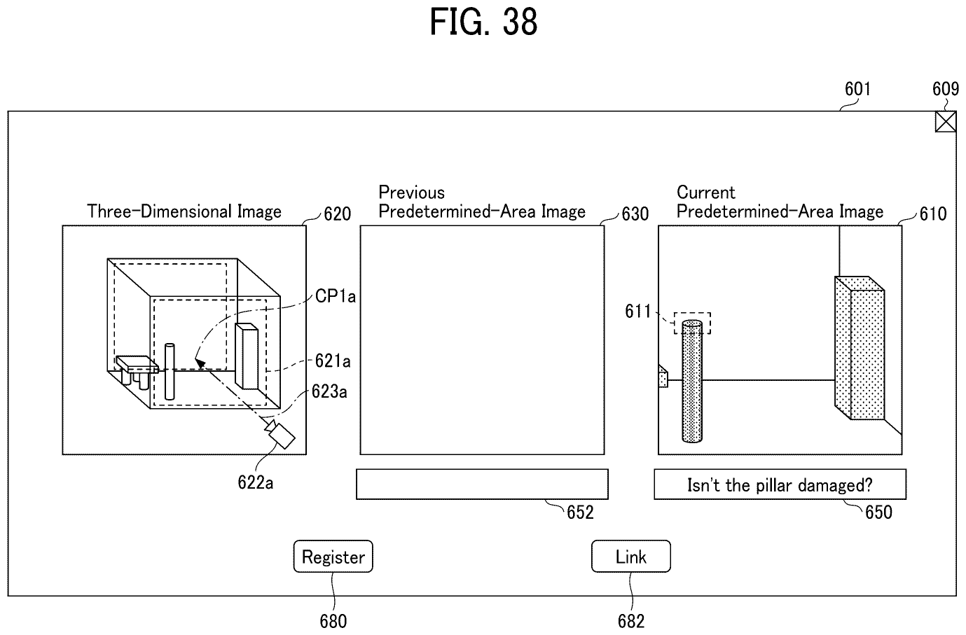

In this case, as illustrated in FIG. 38, the specifying processing unit 57 specifies a specific area 611 in the display area 610 from the current captured image. FIG. 38 is a diagram illustrating an example of a screen displayed on the communication terminal 9a on which the specific area 611 is specified. The specific area 611 is an area specified in the display area 610 by the user through an operation input. For example, the user specifies the specific area 611 by operating an input device such as the mouse to input an instruction. The user may specify an area of concern (e.g., a defective area) as the specific area 611.

The specific area 611 may be an area specified by image recognition processing using text information. The text information corresponds to text generated from sounds collected when the current captured image is obtained or text entered by the user. For example, the user may specify the specific area 611 by image recognition processing by speaking about an area of concern and using text information representing text generated from the speech made by the user, such as “The upper portion of the pillar is damaged”.

In FIG. 38, the specific area 611 is outlined by a broken line. The specific area 611 may be displayed using another display mode. The display mode may include a broken line and a solid line of a specified color. The broken line and the solid line may have different thicknesses from other parts of the display. The specific area 611 may be an area to be masked.

The specific area 611 may be specified from the captured image at, for example, a time within a time period during which the screen 601 illustrated in FIG. 36 is displayed, instead of a time within a time period during which the screen 601 illustrated in FIG. 38 is displayed.

The screen 601 further displays a display area 652 below the display area 630. The display area 652 displays text information. The text information corresponds to text based on audio produced within a predetermined time period including the elapsed playback time of the image being displayed in the display area 630. The display area 652 may display text information corresponding to text entered by the user.

In response to the “register” button 680 being pressed on the screen 601 illustrated in FIG. 38, the processing unit 54 performs the processing of steps S114 to S119, and stores, in the movement history management DB 5004 (see FIG. 18C), for each content ID, the date and time of image and sound capturing, the image capturing position, the field-of-view information, the text information, and the specific area 611 in association with one another. Accordingly, the image capturing position, the field-of-view information, text information, which represents transcribed text generated from audio produced by a predetermined user or audio collected by a predetermined image capturing device (or text entered by the user), and the specific area 611 in the display area 610 are associated with the registered date and time of image capturing.

### Details of Screen Display Process (after Registration Process)

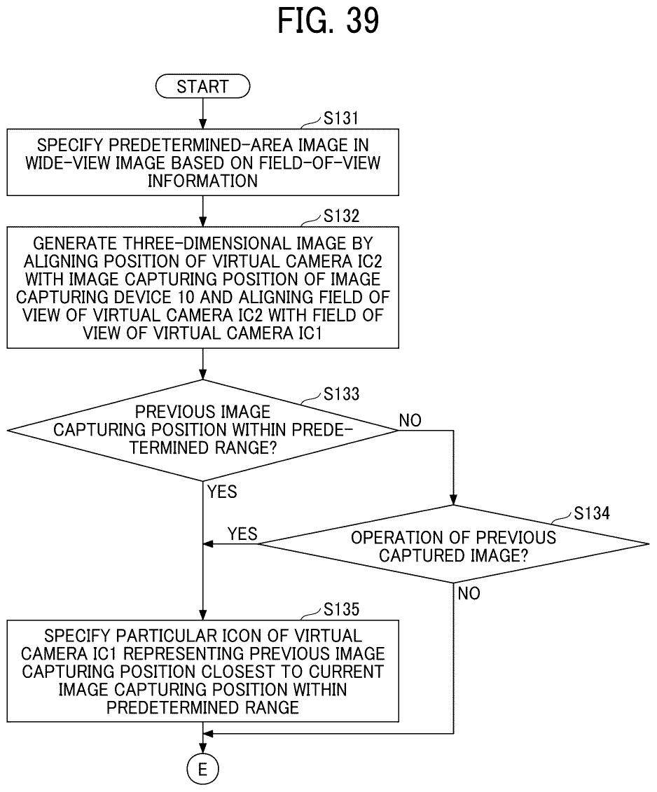

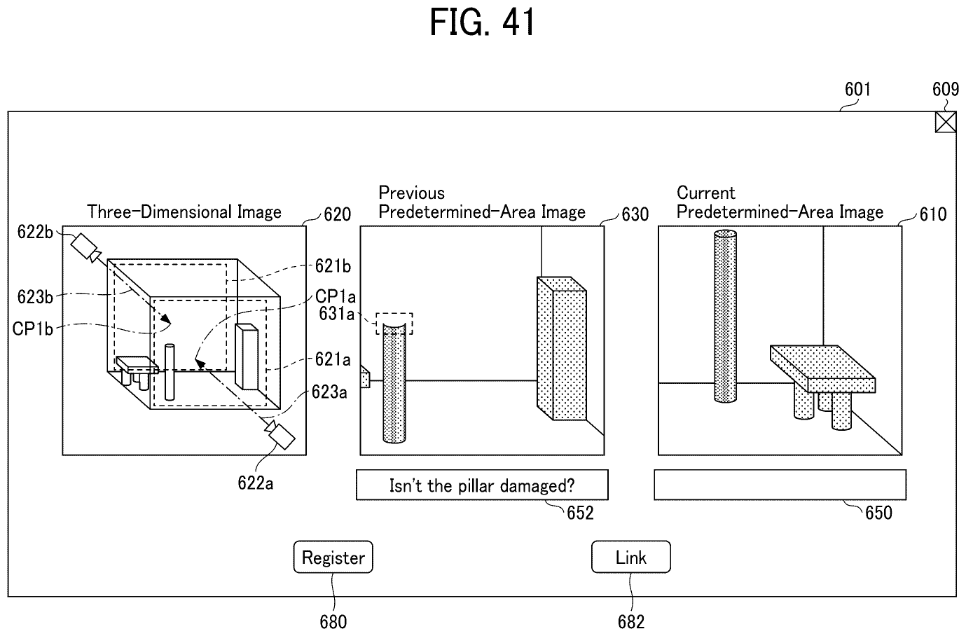

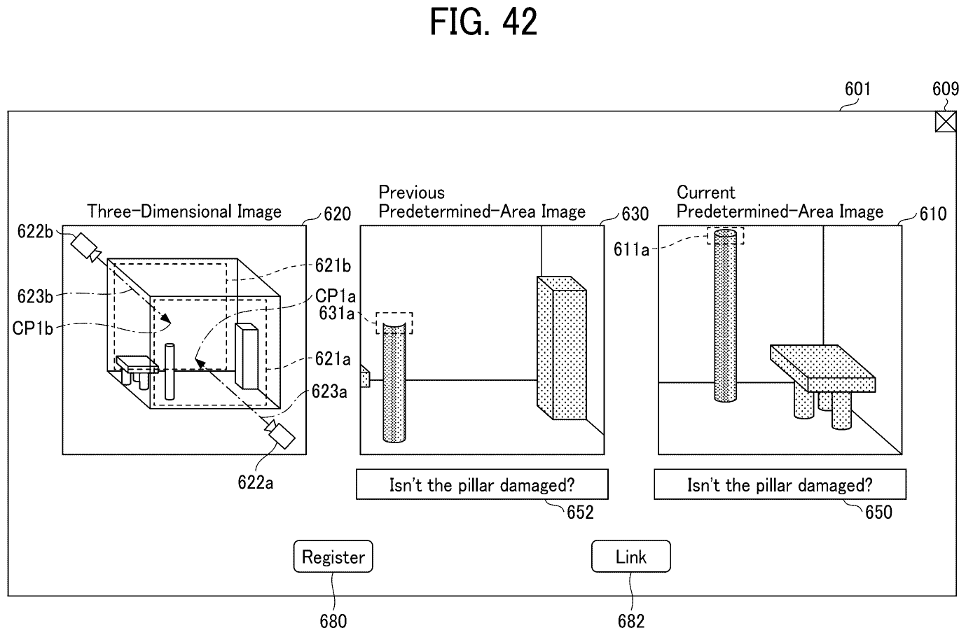

Referring to FIGS. 39 to 42, a screen display process after the registration process in step S14 among steps S13 to S15 of FIG. 19 will be described. In FIGS. 41 and 42, components designated by the same reference numerals as those in FIGS. 36 to 38 perform substantially the same operations or functions. When the participant A operates the communication terminal 9a, the reception unit 92 receives the operation, and the communication unit 91 transmits operation information indicating the content of the operation to the communication control apparatus 5. Accordingly, in the communication control apparatus 5, the communication unit 51, which serves as an acquisition unit, acquires the operation information, and the generation unit 53 generates a screen 601 based on the content of the operation indicated by the operation information. The communication unit 51 transmits data of the screen 601 to the communication terminal 9a. The communication unit 91 of the communication terminal 9a receives the data of the screen 601. The display control unit 94 of the communication terminal 9a displays the screen 601 on, for example, the display 507 of the communication terminal 9a. In this example, the communication control apparatus 5 functions as an information processing apparatus.

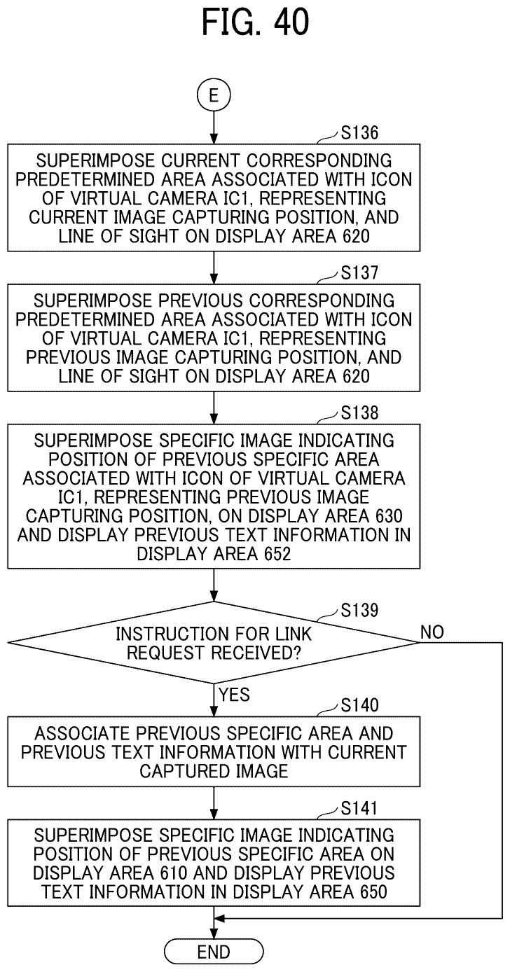

A process for generating the screen 601 to be displayed on the display 507 of the communication terminal 9a, performed by the communication control apparatus 5, will be described. In steps S13 and S15, the communication control apparatus 5 performs the same processing as the processing of step S14, except that the generated screen is displayed on different communication terminals (i.e., the communication terminals 7 and 9b). Thus, descriptions of the processing of steps S13 and S15 will be omitted. FIGS. 39 and 40 illustrate a flowchart of the operation performed by the communication control apparatus 5 in a screen display process after the date and time of image capturing is registered.

The generation unit 53 of the communication control apparatus 5 generates the screen 601 to be displayed on the communication terminal 9a, as illustrated in FIG. 41. FIG. 41 is a diagram illustrating a screen on the communication terminal 9a for displaying a current predetermined-area image after the date and time of image capturing is registered. The screen 601 includes a display area 610, a display area 620, and a display area 630. The display area 610 is an example of a first captured image display area. The display area 620 is an example of a three-dimensional image area. The display area 630 is an example of a second captured image display area. In FIG. 41, the display area 610, the display area 620, and the display area 630 are displayed simultaneously in the same size on the screen 601. Alternatively, the display area 610, the display area 620, and the display area 630 may be displayed simultaneously in different sizes. Alternatively, one of the display area 610, the display area 620, and the display area 630 may be selectively displayed in accordance with the selection made by the participant A. Alternatively, the screen 601 may be divided into a plurality of sections. For example, each of the display areas 610, 620, and 630 may be displayed on one of three displays.

The display area 610 displays a predetermined-area image (see FIG. 6B), which is a predetermined area (see FIG. 6A) in a current wide-view image. The current wide-view image is an example of a current captured image and is obtained by the image capturing device 10 capturing an image of objects.

The display area 620 displays a portion of or all of a three-dimensional image that includes a three-dimensional model representing the shape of an object, such as a table or a pillar, in three dimensions. In the three-dimensional image, coordinates (an example of second coordinates) are associated with coordinates (an example of first coordinates) in the wide-view image.

The display area 630 displays a predetermined-area image (see FIG. 6B), which is a predetermined area (see FIG. 6A) in a previous wide-view image. The previous wide-view image is an example of a previous captured image and is obtained by the image capturing device 10 capturing an image of the objects.

When the captured image is not a curved image such as a wide-view image, each of the display areas 610 and 630 displays a predetermined-area image representing a predetermined area that is the same area as the imaging area of the captured image.

The display area 620 displays a portion of or all of a three-dimensional image that includes a three-dimensional model representing the shape of an object in three dimensions. In the three-dimensional image, coordinates (an example of second coordinates) are associated with coordinates (an example of first coordinates) in the wide-view image.

As described above, the processing unit 54 aligns the positions of the display areas 610, 620, and 630. As described above, the generation unit 53 generates the screen 601 including the display area 610, the display area 620, and the display area 630. The display area 610 displays the predetermined-area image, which represents a predetermined area in the current wide-view image. The display area 620 displays at least a portion of the three-dimensional image in which the second position (second coordinates) is associated with the first position (first coordinates) in the current wide-view image. The display area 630 displays the predetermined-area image, which represents a predetermined area in the previous wide-view image in which the third position (third coordinates) is associated with the first position (first coordinates).

The screen 601 further includes a “register” button 680 and a “link” button 682. As described above, the “register” button 680 is pressed to display an icon of the virtual camera IC1 in the display area 620 at a position corresponding to the image capturing position of the image capturing device 10. The virtual camera IC1 has an imaging area, which is determined by a field of view (or field-of-view information) for specifying a predetermined area corresponding to the predetermined-area image being displayed in the display area 610. As described above, the “link” button 682 is pressed to associate a specific image indicating the position of a specific area 631a in the previous captured image with the current captured image.

The content displayed on the screen 601 will be described in detail below. The virtual camera IC1 is used to specify a predetermined area depicted in the predetermined-area image displayed in each of the display areas 610 and 630 (see FIG. 8). A virtual camera IC2 is used to specify a three-dimensional image to be displayed in the display area 620.

In step S131, the generation unit 53 of the communication control apparatus 5 specifies, in the current wide-view image of the content data received by the communication unit 51, a current predetermined-area image to be displayed in the display area 610 as illustrated in FIG. 41, based on the field-of-view information. The field-of-view information indicates a preset virtual field of view of the virtual camera IC1.

In step S132, the processing unit 54 aligns the position of the virtual camera IC2 with the image capturing position included in the current wide-view image (content data). The processing unit 54 further aligns the virtual field of view of the virtual camera IC2 (an example of a second field of view) with the preset virtual field of view of the virtual camera IC1 (an example of a first field of view). Accordingly, the generation unit 53 generates a three-dimensional image to be displayed in the display area 620.

In response to the “register” button 680 as illustrated in FIG. 41 being pressed, processing similar to the processing of steps S113 to S116 described above is performed. As a result, the generation unit 53 can superimpose a corresponding predetermined area 621b on the display area 620 at a position corresponding to the current image capturing position. The generation unit 53 can further superimpose a line 623b on the display area 620 to indicate the line of sight of the virtual camera IC1 from an icon 622b of the virtual camera IC1 toward a center point CP1b of the corresponding predetermined area 621b. The icon 622b is an example of an image indicating a first virtual camera.

In step S133, the generation unit 53 determines whether there is any icon of the virtual camera IC1, which represents a previous image capturing position within a predetermined range from the current image capturing position. The predetermined range is, for example, 3 meters when an absolute position is assumed.

If no previous image capturing position is present within the predetermined range from the current image capturing position (NO in step S133), in step S134, the communication unit 51 determines whether an instruction has been acquired to operate a previous captured image.

For example, the communication unit 51 determines whether an instruction has been acquired from the participant A to select (or designate) an icon of the virtual camera IC1, which represents a particular previous image capturing position among a plurality of previous image capturing positions. If the communication unit 51 has not acquired an instruction to operate a previous captured image (NO in step S134), the communication unit 51 performs the processing of step S136.

If a previous image capturing position is present within the predetermined range from the current image capturing position (YES in step S133) or if an instruction has been acquired to operate a previous captured image (YES in step S134), in step S135, the generation unit 53 specifies a particular icon representing a previous image capturing position closest to the current image capturing position (the position of the icon 622b of the virtual camera IC1) within the predetermined range from the current image capturing position. In this example, the icon 622a is specified.

In step S136, as in step S116, the generation unit 53 superimposes, on the display area 620, the corresponding predetermined area 621b associated with the icon 622b of the virtual camera IC1, which represents the current image capturing position, and the line 623b indicating the line of sight of the virtual camera IC1 from the icon 622b toward the center point CP1b of the corresponding predetermined area 621b.

In step S137, as in step S116, the generation unit 53 superimposes, on the display area 620, the corresponding predetermined area 621a associated with the icon 622a of the virtual camera IC1, which represents the previous image capturing position, and the line 623a indicating the line of sight of the virtual camera IC1 from the icon 622a toward the center point CP1a of the corresponding predetermined area 621a.

In step S138, as illustrated in FIG. 41, the generation unit 53 superimposes the specific image indicating the position of the specific area 631a, which is specified from the previous captured image, on the display area 630 (an example of a second captured image display area). The display area 630 displays the previous predetermined-area image (an example of a second predetermined-area image) corresponding to the icon 622a of the virtual camera IC1. The generation unit 53 further displays text information, which is obtained when the previous predetermined-area image is captured, in the display area 652 below the display area 630 on the screen 601.

In step S139, the processing unit 54 determines whether an instruction for a link request has been received. The link request is triggered by pressing the “link” button 682, through the acquisition unit (the reception unit 92 and the communication unit 51), to link the current captured image and the previous captured image, using the specific image indicating the position of the specific area 631a, which is specified from the previous captured image.

If an instruction for a link request has been received (YES in step S139), in step S140, the processing unit 54 registers, in the “specific area information” column of the movement history management DB 5004 (see FIG. 18C), the specific area 631a (e.g., (X8, Y8, Z8)), which is being displayed in the display area 630, in association with the date and time of image and sound capturing of the current predetermined-area image (predetermined area) being displayed in the display area 610.

The processing unit 54 further registers, in the “text information” column of the movement history management DB 5004 (see FIG. 18C), previous transcribed text (e.g., “Isn't the pillar damaged?”), which is being displayed in the display area 652, in association with the date and time of image and sound capturing of the current predetermined-area image (predetermined area) being displayed in the display area 610.

In this case, the processing unit 54 registers the transcribed text in the movement history management DB 5004 (see FIG. 18C) under the column for the user ID that matches the user ID (e.g., 100a) in the movement history management DB 5004 (see FIG. 18B). If no matching user ID is found, the processing unit 54 may register the transcribed text in the movement history management DB 5004 (see FIG. 18C) under the column for any user ID managed in the movement history management DB 5004 (see FIG. 18C). In FIG. 18C, parentheses are used to indicate that the data registered in the “user ID” column and the “specific area information” column has been duplicated later, such as “(Isn't the pillar damaged?)” and “(X5, Y5, Z5)”.

As illustrated in FIG. 42, in step S141, the generation unit 53 generates the screen 601 such that a specific image representing a specific area 611a is displayed in a superimposed manner on the display area 610. The specific area 611a indicates the position of the specific area 631a, which is specified from the previous captured image being displayed in the display area 630. As illustrated in FIG. 42, furthermore, the generation unit 53 generates the screen 601 such that the previous text information, which is being displayed in the display area 652, is displayed in the display area 650 below the display area 610. FIG. 42 is a diagram illustrating a screen on the communication terminal 9a for displaying a current predetermined-area image after the date and time of image capturing is registered.

As illustrated in FIGS. 41 and 42, the specific image indicating the position of the specific area 631a, which is specified from the previous captured image, can be displayed in a superimposed manner on the specific area 611a in the current predetermined-area image displayed in the display area 610. Thus, an area of concern (e.g., a defective area) in the previous captured image can also be visually identified by the user in the current captured image.

As illustrated in FIGS. 41 and 42, furthermore, the previous text information, which is being displayed in the display area 652, can be displayed in addition to the current text information being displayed in the display area 650. Thus, the area of concern in the previous captured image can be checked by the user using the text information in addition to the specific image, resulting in improved recognizability.

### Variation (1) of Screen Display Process (after Registration Process)

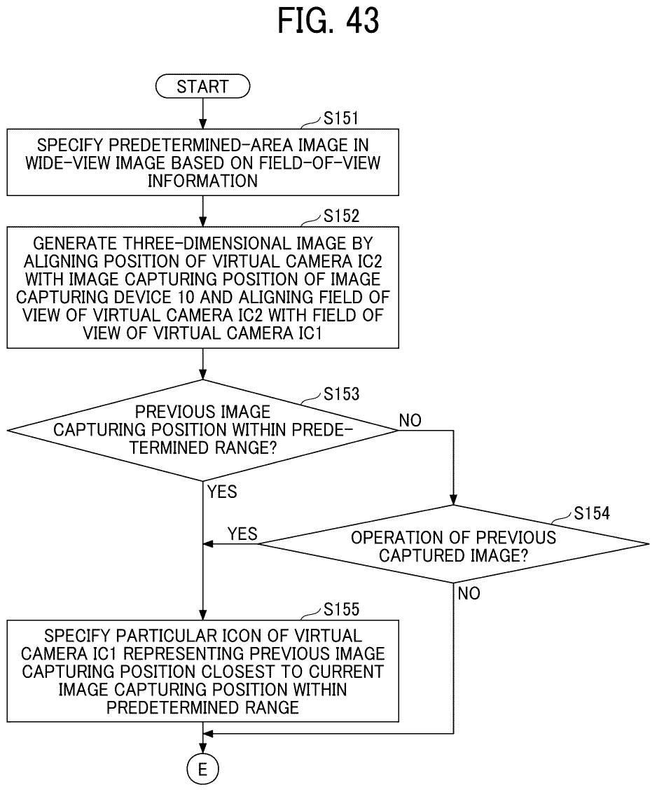

Variation (1) of the screen display process (after the registration process) will be described with reference to FIGS. 43 to 46.

In step S133 of FIG. 39, it is determined whether there is any icon of the virtual camera IC1, which represents a previous image capturing position within the predetermined range from the current image capturing position, by way of example but not limitation. In another example, it may be determined whether there is any previous captured image similar to the current captured image.

If it is determined that there is a previous captured image similar to the current captured image, in step S135, the generation unit 53 specifies a particular icon representing a previous image capturing position associated with the previous captured image similar to the current captured image. The similarity of images may be measured using, for example, existing image similarity indices.

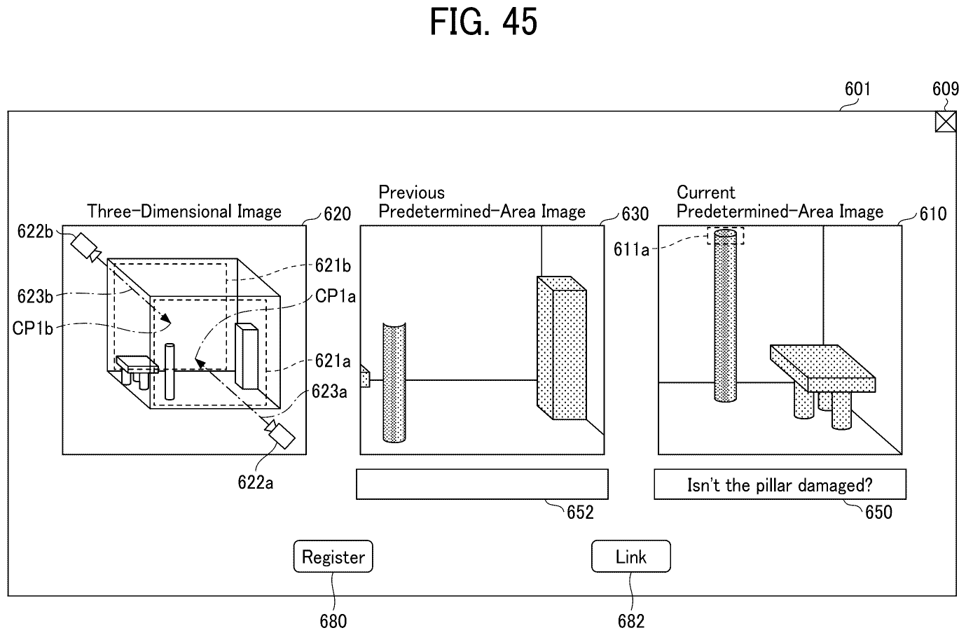

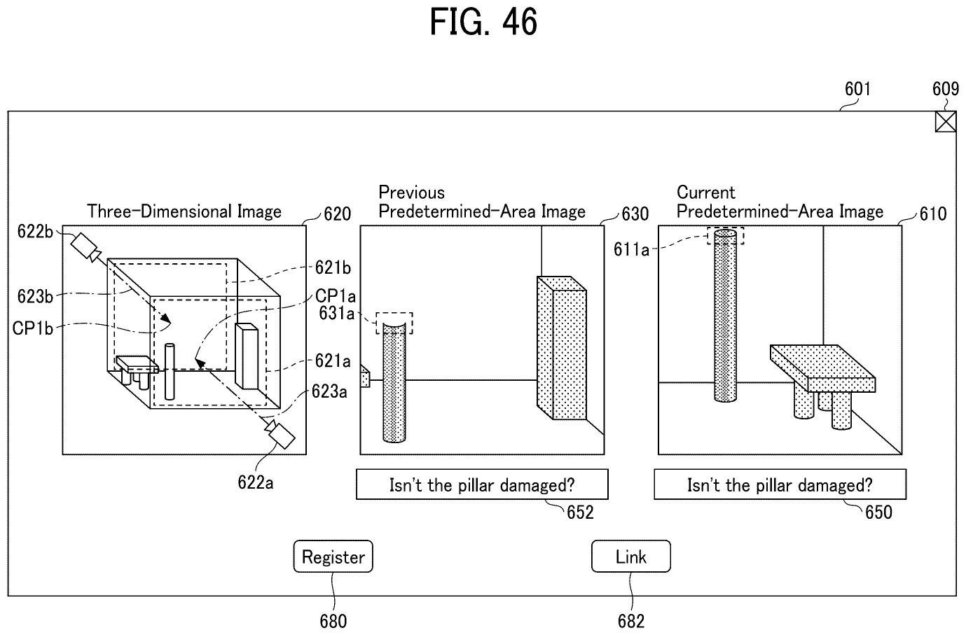

Referring to FIGS. 43 to 46, a screen display process after the registration process in step S14 among steps S13 to S15 of FIG. 19 will be described. In FIGS. 45 and 46, components designated by the same reference numerals as those in FIGS. 36 to 38 perform substantially the same operations or functions. When the participant A operates the communication terminal 9a, the reception unit 92 receives the operation, and the communication unit 91 transmits operation information indicating the content of the operation to the communication control apparatus 5. Accordingly, in the communication control apparatus 5, the communication unit 51, which serves as an acquisition unit, acquires the operation information, and the generation unit 53 generates a screen 601 based on the content of the operation indicated by the operation information. The communication unit 51 transmits data of the screen 601 to the communication terminal 9a. The communication unit 91 of the communication terminal 9a receives the data of the screen 601. The display control unit 94 of the communication terminal 9a displays the screen 601 on, for example, the display 507 of the communication terminal 9a. In this example, the communication control apparatus 5 functions as an information processing apparatus.

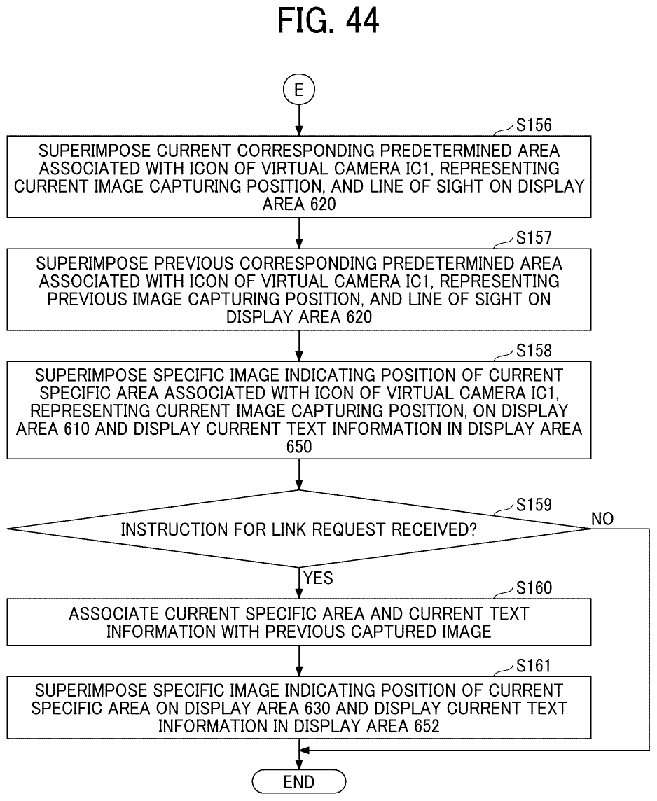

A process for generating the screen 601 to be displayed on the display 507 of the communication terminal 9a, performed by the communication control apparatus 5, will be described. In steps S13 and S15, the communication control apparatus 5 performs the same processing as the processing of step S14, except that the generated screen is displayed on different communication terminals (i.e., the communication terminals 7 and 9b). Thus, descriptions of the processing of steps S13 and S15 will be omitted. FIGS. 43 and 44 illustrate a flowchart of the operation performed by the communication control apparatus 5 in a screen display process after the date and time of image capturing is registered.

The generation unit 53 of the communication control apparatus 5 generates the screen 601 to be displayed on the communication terminal 9a, as illustrated in FIG. 45. FIG. 45 is a diagram illustrating a screen on the communication terminal 9a for displaying a current predetermined-area image after the date and time of image capturing is registered. The screen 601 includes a display area 610, a display area 620, and a display area 630. The display area 610 is an example of a first captured image display area. The display area 620 is an example of a three-dimensional image area. The display area 630 is an example of a second captured image display area. In FIG. 45, the display area 610, the display area 620, and the display area 630 are displayed simultaneously in the same size on the screen 601. Alternatively, the display area 610, the display area 620, and the display area 630 may be displayed simultaneously in different sizes. Alternatively, one of the display area 610, the display area 620, and the display area 630 may be selectively displayed in accordance with the selection made by the participant A. Alternatively, the screen 601 may be divided into a plurality of sections. For example, each of the display areas 610, 620, and 630 may be displayed on one of three displays.

In step S151, the generation unit 53 of the communication control apparatus 5 specifies, in the current wide-view image of the content data received by the communication unit 51, a current predetermined-area image to be displayed in the display area 610 as illustrated in FIG. 45, based on the field-of-view information. The field-of-view information indicates a preset virtual field of view of the virtual camera IC1.

In step S152, the processing unit 54 aligns the position of the virtual camera IC2 with the image capturing position included in the current wide-view image (content data). The processing unit 54 further aligns the virtual field of view of the virtual camera IC2 (an example of a second field of view) with the preset virtual field of view of the virtual camera IC1 (an example of a first field of view). Accordingly, the generation unit 53 generates a three-dimensional image to be displayed in the display area 620.

In response to the “register” button 680 as illustrated in FIG. 45 being pressed, processing similar to the processing of steps S113 to S116 described above is performed. As a result, the generation unit 53 can superimpose a corresponding predetermined area 621b on the display area 620 at a position corresponding to the current image capturing position. The generation unit 53 can further superimpose a line 623b on the display area 620 to indicate the line of sight of the virtual camera IC1 from an icon 622b of the virtual camera IC1 toward a center point CP1b of the corresponding predetermined area 621b. The icon 622b is an example of an image indicating a first virtual camera.

In step S153, the generation unit 53 determines whether there is any icon of the virtual camera IC1, which represents a previous image capturing position within a predetermined range from the current image capturing position. The predetermined range is, for example, 3 meters when an absolute position is assumed.

If no previous image capturing position is present within the predetermined range from the current image capturing position (NO in step S153), in step S154, the communication unit 51 determines whether an instruction has been acquired to operate a previous captured image.

For example, the communication unit 51 determines whether an instruction has been acquired from the participant A to select (or designate) an icon of the virtual camera IC1, which represents a particular previous image capturing position among a plurality of previous image capturing positions. If the communication unit 51 has not acquired an instruction to operate a previous captured image (NO in step S154), the communication unit 51 performs the processing of step S156.

If a previous image capturing position is present within the predetermined range from the current image capturing position (YES in step S153) or if an instruction has been acquired to operate a previous captured image (YES in step S154), in step S155, the generation unit 53 specifies a particular icon representing a previous image capturing position closest to the current image capturing position (the position of the icon 622b of the virtual camera IC1) within the predetermined range from the current image capturing position. In this example, the icon 622a is specified.

In step S156, as in step S116, the generation unit 53 superimposes, on the display area 620, the corresponding predetermined area 621b associated with the icon 622b of the virtual camera IC1, which represents the current image capturing position, and the line 623b indicating the line of sight of the virtual camera IC1 from the icon 622b toward the center point CP1b of the corresponding predetermined area 621b.

In step S157, as in step S116, the generation unit 53 superimposes, on the display area 620, the corresponding predetermined area 621a associated with the icon 622a of the virtual camera IC1, which represents the previous image capturing position, and the line 623a indicating the line of sight of the virtual camera IC1 from the icon 622a toward the center point CP1a of the corresponding predetermined area 621a.

In step S158, as illustrated in FIG. 45, the generation unit 53 superimposes the specific image indicating the position of the specific area 611a, which is specified from the current captured image, on the display area 610 (an example of a first captured image display area). The display area 610 displays the current predetermined-area image (an example of a first predetermined-area image) corresponding to the icon 622b of the virtual camera IC1. The generation unit 53 further displays text information, which is obtained when the current predetermined-area image is captured, in the display area 650 below the display area 610 on the screen 601.

In step S159, the processing unit 54 determines whether an instruction for a link request has been received. The link request is triggered by pressing the “link” button 682, through the acquisition unit (the reception unit 92 and the communication unit 51), to link the current captured image and the previous captured image, using the specific image indicating the position of the specific area 611a, which is specified from the current captured image.

If an instruction for a link request has been received (YES in step S159), in step S160, conversely to step S140, the processing unit 54 registers, in the “specific area information” column of the movement history management DB 5004 (see FIG. 18B), the specific area 611a, which is being displayed in the display area 610, in association with the date and time of image and sound capturing of the previous predetermined-area image (predetermined area) being displayed in the display area 630. The processing unit 54 further registers, in the “text information” column of the movement history management DB 5004 (see FIG. 18B), the current text (i.e., text information), which is being displayed in the display area 650, in association with the date and time of image and sound capturing of the previous predetermined-area image (predetermined area) being displayed in the display area 630.

In this case, the processing unit 54 registers the transcribed text in the movement history management DB 5004 (see FIG. 18B) under the column for the user ID that matches the user ID (e.g., 100a) in the movement history management DB 5004 (see FIG. 18C). If no matching user ID is found, the processing unit 54 may register the transcribed text in the movement history management DB 5004 (see FIG. 18B) under the column for any user ID managed in the movement history management DB 5004 (see FIG. 18B).

As illustrated in FIG. 46, in step S161, the generation unit 53 generates the screen 601 such that a specific image representing a specific area 631a is displayed in a superimposed manner on the display area 630. The specific area 631a indicates the position of the specific area 611a, which is specified from the current captured image being displayed in the display area 610. As illustrated in FIG. 46, furthermore, the generation unit 53 generates the screen 601 such that the current text information, which is being displayed in the display area 650, is included in the display area 652 below the display area 630. FIG. 46 is a diagram illustrating a screen on the communication terminal 9a for displaying a current predetermined-area image after the date and time of image capturing is registered.

As illustrated in FIGS. 45 and 46, the specific image indicating the position of the specific area 611a, which is specified from the current captured image, can be displayed in a superimposed manner on the specific area 631a in the previous predetermined-area image displayed in the display area 630. Thus, an area of concern (e.g., a defective area) in the current captured image can also be visually identified by the user in the previous captured image.

As illustrated in FIGS. 45 and 46, furthermore, the current text information, which is being displayed in the display area 650, can be displayed in addition to the previous text information being displayed in the display area 652. Thus, the area of concern in the current captured image can be checked by the user using the text information in addition to the specific image, resulting in improved recognizability.

### Variation (2) of Screen Display Process (after Registration Process)

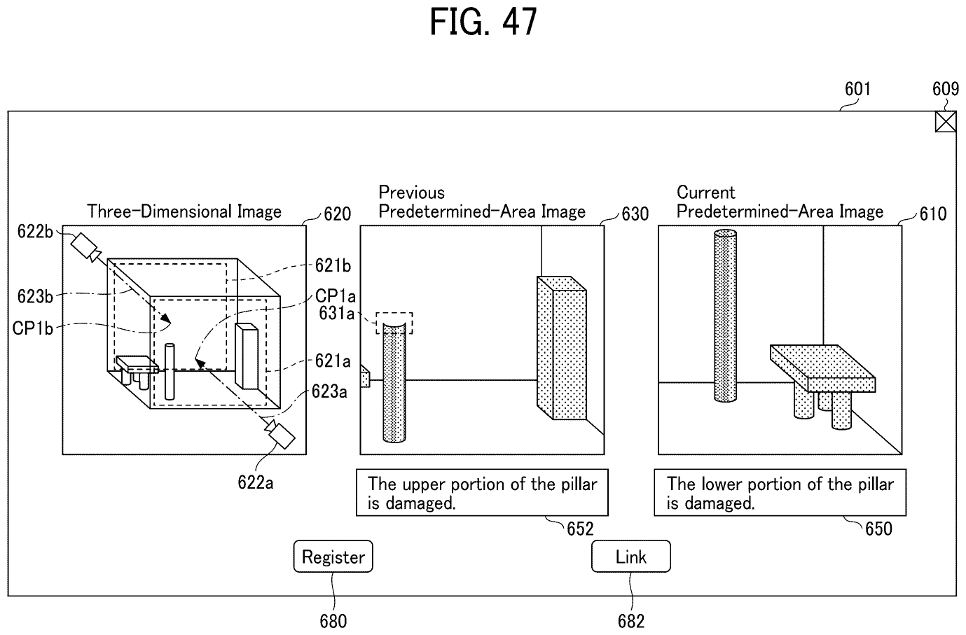

Variation (2) of the screen display process (after the registration process) will be described with reference to FIG. 47.

In step S153 of FIG. 43, the processing unit 54 determines whether there is any icon of the virtual camera IC1, which represents a previous image capturing position within the predetermined range from the current image capturing position, by way of example but not limitation. In another example, the processing unit 54 may determine whether there is any previous captured image similar to the current captured image.

If the processing unit 54 determines that there is a previous captured image similar to the current captured image, in step S155, the generation unit 53 specifies a particular icon representing a previous image capturing position associated with the previous captured image similar to the current captured image. The similarity of images may be measured using, for example, existing image similarity indices.

In step S133 of FIG. 39 and step S153 of FIG. 43, the processing unit 54 determines whether there is any icon of the virtual camera IC1, which represents a previous image capturing position within the predetermined range from the current image capturing position, by way of example but not limitation. In another example, the processing unit 54 may determine whether there is any previous text information similar to the current text information being displayed in the display area 650.

If the processing unit 54 determines that there is a previous text information similar to the current text information, in step S135 or S155, the generation unit 53 specifies a particular icon representing a previous image capturing position associated with the previous text information similar to the current text information. The similarity of text information may be measured using, for example, existing text similarity indices.

As illustrated in FIG. 47, the generation unit 53 superimposes the specific image indicating the position of the specific area 631a, which is specified from the previous captured image, on the display area 630 (an example of a second captured image display area). The display area 630 displays the previous predetermined-area image corresponding to the icon 622a of the virtual camera IC1. The generation unit 53 further displays the text information for the previous predetermined-area image in the display area 652 below the display area 630 on the screen 601. In response to the “link” button 682 being pressed, the processing unit 54 receives an instruction for a link request to associate the current captured image and a previous captured image having similar text information to that of the current captured image with each other.

As illustrated in FIG. 47, the current captured image and a previous captured image having similar text information to that of the current captured image can be displayed on the screen 601. Thus, the current captured image and the previous captured image, which have similar text information, can be visually identified by the user.

The previous captured image displayed in the display area 630 is not limited to an image captured from an image capturing position aligned with that of the current captured image. For example, an image captured from an image capturing position different from that of the current captured image, such as a captured image of another room, floor, or property of the same specifications, may be displayed in the display area 630.

### Variation (3-1) of Screen Display Process (after Registration Process)

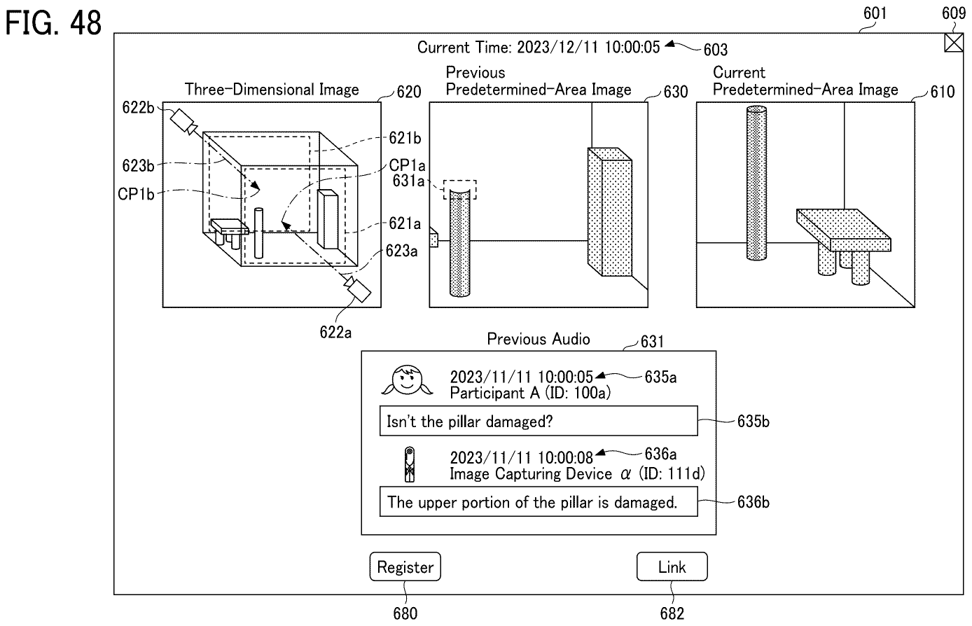

Variation (3-1) of the screen display process (after the registration process) will be described with reference to FIG. 48. FIG. 48 is a diagram illustrating a screen on the communication terminal 9a for additionally displaying a previous predetermined-area image after the date and time of image capturing is registered. A screen 601 illustrated in FIG. 48 includes current time information 603 as new information.

In variation (3-1), the generation unit 53 generates the screen 601 such that the screen 601 further includes a display area 631 for displaying previous audio. The display area 631 displays transcribed text corresponding to the previous predetermined-area image displayed in the display area 630. Instead of the transcribed text, the input text described above may be displayed.

In this case, in step S141 described above, the generation unit 53 displays transcribed text in the display area 631. The transcribed text is managed in the movement history management DB 5004 (see FIG. 18B) in association with the image capturing position and the field-of-view information that specify the previous predetermined-area image displayed in the display area 630. The generation unit 53 further displays a date and time of image and sound capturing stored in the movement history management DB 5004 (see FIG. 18B) in association with the transcribed text (a record marked with the checkmark in the “registered” item) in the movement history management DB 5004 (see FIG. 18B). The generation unit 53 also displays the corresponding name and device image (or user image) near the date and time of image and sound capturing. The corresponding name and device image (or user image) are read from the user device management DB 5001 based on the device ID (or user ID) managed in the movement history management DB 5004 (see FIG. 18B).

In FIG. 48, the display area 631 displays a display field 635a and a display field 635b. The display field 635a includes a user image of the participant A, the date and time of image and sound capturing, the name of the participant A, and the user ID of the participant A. The display field 635b displays transcribed text. The display area 631 further displays a display field 636a and a display field 636b. The display field 636a includes a device image of the image capturing device 10 (in the illustrated example, the image capturing device α), the date and time of image and sound capturing, the name of the image capturing device 10, and the device ID of the image capturing device 10. The display field 636b displays transcribed text. The display fields 635a and 635b and the display fields 636a and 636b are displayed in chronological order.

The user ID that can identify the communication terminal 7 is an example of identification information for identifying the sound input/output control unit 75 (sound collection unit) of the communication terminal 7. The user ID that can identify the communication terminal 9 is an example of identification information for identifying the sound input/output control unit 95 (sound collection unit) of the communication terminal 9. The device ID that can identify the image capturing device 10 is an example of identification information for identifying the sound collection unit 17 of the image capturing device 10.

### Variation (3-2) of Screen Display Process (after Registration Process)

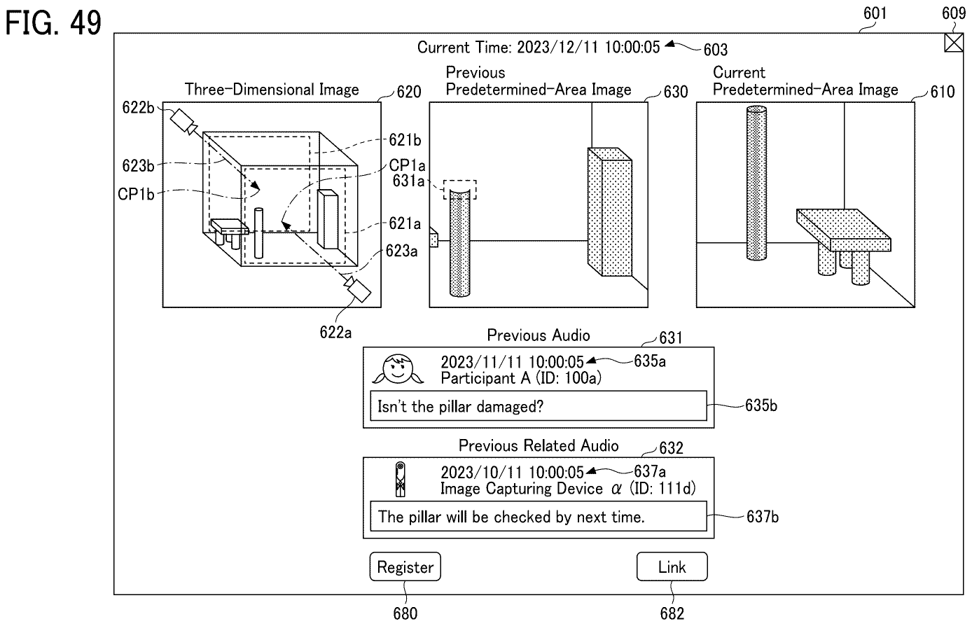

Variation (3-2) of the screen display process (after the registration process) will be described with reference to FIG. 49. FIG. 49 is a diagram illustrating a variation of a screen on the communication terminal 9a for additionally displaying a previous predetermined-area image after the date and time of image capturing is registered. In variation (3-1) illustrated in FIG. 48, the display area 631 is displayed to display previous transcribed text, whereas in variation (3-2) illustrated in FIG. 49, a display area 632 is further displayed in addition to the display area 631 in order to display transcribed text related to the previous transcribed text.

In this case, the processing unit 54 searches the virtual room management DB 5002 using each keyword (e.g., “pillar”) in the previous transcribed text (e.g., “Isn't the pillar damaged?”) as a search key for transcribed text generated from audio produced in the virtual room on a recording date (e.g., Oct. 11, 2023(2023.10.11 )) that is different from the recording date (e.g., Nov. 11, 2023(2023.11.11 )) of the audio corresponding to the previous transcribed text being displayed in the display area 631 illustrated in FIG. 49 but is associated with the same three-dimensional image ID. The processing unit 54 reads, for example, “The pillar will be checked by next time” as “further previous transcribed text”.

As illustrated in FIG. 49, the generation unit 53 generates the screen 601 such that the screen 601 includes the display area 632 for displaying related previous audio. The display area 632 includes a display field 637a and a display field 637b. The display field 637a includes a device image of the image capturing device 10 (in the illustrated example, the image capturing device α), the date and time of image and sound capturing, the name of the image capturing device 10, and the device ID of the image capturing device 10. The display field 637b displays transcribed text.

The related previous audio is not limited to further previous audio. The processing unit 54 may read transcribed text from the movement history management DB 5004 (see FIG. 18A) and display the read transcribed text in the display area 632. Specifically, the processing unit 54 may search the movement history management DB 5004 (see FIG. 18A) using the image capturing position (or the image capturing position and the field-of-view information) managed in the movement history management DB 5004 (see FIG. 18B) in association with the transcribed text being displayed in the display area 631 for displaying previous audio, as a search key for another date of recording a three-dimensional image with the same three-dimensional image ID, and read the corresponding transcribed text.

### Display of Minutes

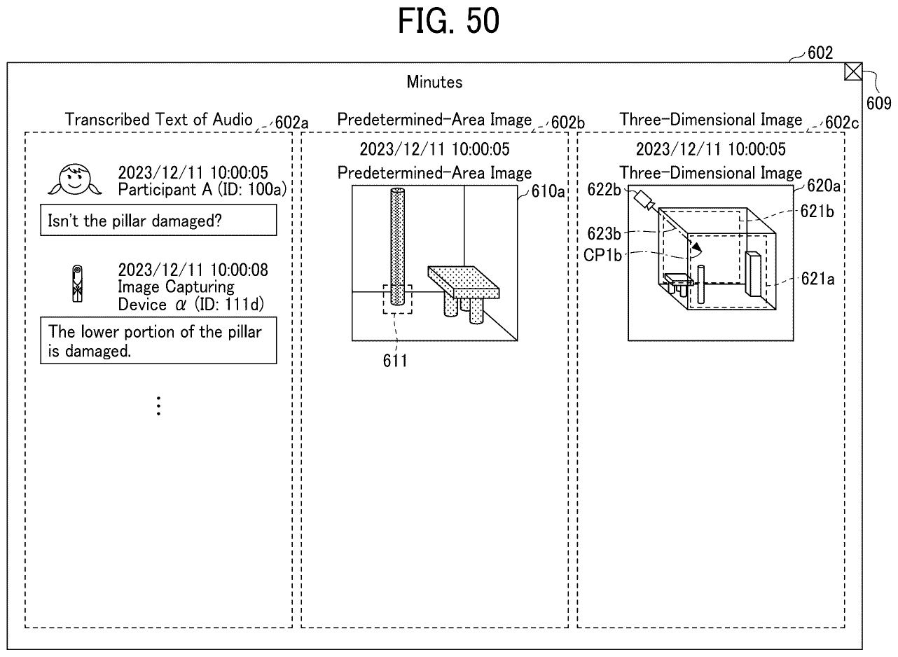

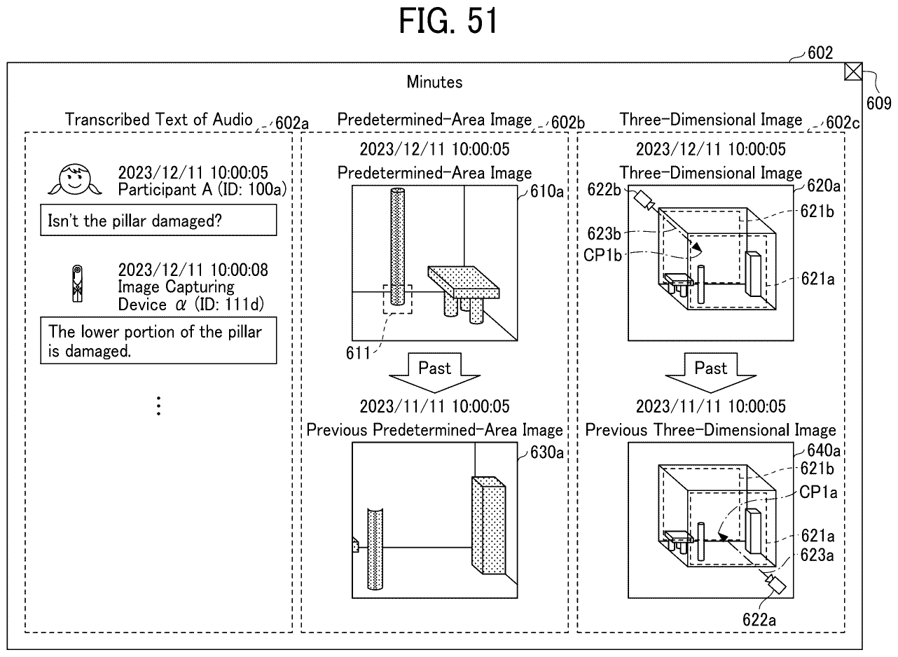

Using the managed data items illustrated in FIGS. 14, 15, 18A, 18B, and 18C, the generation unit 53 can generate a screen 602 as illustrated in FIGS. 50, 51, or 53 for displaying minutes (of a meeting or the like).

FIG. 50 is a diagram illustrating an example of a screen on the communication terminal 9a for displaying minutes including transcribed text and images. As described above, the minutes may include input text instead of the transcribed text.

The screen 602 illustrated in FIG. 50 includes, from left to right, a display area 602a, a display area 602b, and a display area 602c. The display area 602a displays transcribed text, which forms the basis of the minutes. The display area 602b displays a predetermined-area image corresponding to the transcribed text. The display area 602c displays a three-dimensional image corresponding to the predetermined-area image.

The generation unit 53 displays transcribed texts, which are managed in the movement history management DB 5004 (see FIG. 18C), in the display area 602a in chronological order. The display mode for displaying the transcribed texts is similar to that in the display area 631 illustrated in FIG. 48.

The generation unit 53 displays a display area 610a in the display area 602b. The display area 610a displays a previous predetermined-area image based on the field-of-view information managed in the movement history management DB 5004 (see FIG. 18C) in association with the transcribed texts. At the time of generation of the minutes, the conversations in the virtual room have been completed. Thus, the current predetermined-area image displayed in the display area 610 illustrated in FIG. 45 is displayed in the display area 610a as the previous predetermined-area image.

The generation unit 53 displays a display area 620a in the display area 602c. The display area 620a displays a previous three-dimensional image related to the display area 610a. Specifically, alignment processing has been performed by the processing unit 54 for the predetermined-area image in the display area 610a and the three-dimensional image in the display area 620a in the way as described above.

As a result, the viewer (e.g., the participant A) of the screen 602 of the minutes can view, all at once (or simultaneously), the automatically generated transcribed texts and the corresponding predetermined-area image and three-dimensional image. Thus, the detailed content of the minutes can be presented to the viewer in a comprehensible manner.

### Variation (1) of Minutes

Variation (1) of the screen illustrated in FIG. 50 will be described with reference to FIG. 51. FIG. 51 is a diagram illustrating an example of a screen on the communication terminal 9a for additionally displaying a previous predetermined-area image and a previous three-dimensional image together with the minutes.

In this case, the processing unit 54 searches the virtual room management DB 5002 (see FIG. 15) based on the virtual room ID (e.g., “101r”) of the virtual room on the recording date on which the transcribed texts displayed on the screen 602 illustrated in FIG. 50 were generated. The processing unit 54 reads a content ID (e.g., “c091”) associated with another virtual room ID (e.g., “091r”) with which the same three-dimensional image ID (e.g., “v001”) is associated. Subsequently, the processing unit 54 reads, from among the image capturing positions managed in the movement history management DB 5004 (see FIG. 18B) under the read content ID (i.e., “c091”), a particular image capturing position that is the same as or similar to (with parameter differences within a threshold) the image capturing position of the predetermined-area image being displayed in the display area 610a. The processing unit 54 also reads particular field-of-view information associated with the read particular image capturing position. As illustrated in FIG. 51, the generation unit 53 displays a display area 630a in the display area 602b. The display area 630a includes a previous predetermined-area image based on particular content data (image data), the particular image capturing position, and the particular field-of-view information.

The processing unit 54 may perform a similar image search based on the predetermined-area image displayed in the display area 610a to extract, from the particular content data (image data), a previous predetermined-area image having a degree of similarity greater than or equal to a predetermined value.

The generation unit 53 displays a display area 640a in the display area 602c. The display area 640a includes a previous three-dimensional image subjected to alignment processing with the previous predetermined-area image in the display area 630a. The previous predetermined-area image in the display area 630a is an example of a related image of the predetermined-area image in the display area 610a.

As a result, the viewer (e.g., the participant A) of the screen 602 of the minutes can view, all at once (or simultaneously), the automatically generated transcribed texts in the display area 602a, the corresponding predetermined-area image and three-dimensional image in the display areas 610a and 620a, respectively, the previous predetermined-area image in the display area 630a, and the previous three-dimensional image in the display area 640a. Thus, the more detailed content of the minutes can be presented to the viewer in a comprehensible manner.

### Variation (1) of Minutes

Variation (1) of the screen illustrated in FIG. 50 will be described with reference to FIG. 51. FIG. 51 is a diagram illustrating an example of a screen on the communication terminal 9a for additionally displaying a previous predetermined-area image and a previous three-dimensional image together with the minutes.

In this case, the processing unit 54 searches the virtual room management DB 5002 (see FIG. 15) based on the virtual room ID (e.g., “101r”) of the virtual room on the recording date on which the transcribed texts displayed on the screen 602 illustrated in FIG. 50 were generated. The processing unit 54 reads a content ID (e.g., “c091”) associated with another virtual room ID (e.g., “091r”) with which the same three-dimensional image ID (e.g., “v001”) is associated. Subsequently, the processing unit 54 reads, from among the image capturing positions managed in the movement history management DB 5004 (see FIG. 18B) under the read content ID (i.e., “c091”), a particular image capturing position that is the same as or similar to (with parameter differences within a threshold) the image capturing position of the predetermined-area image being displayed in the display area 610a. The processing unit 54 also reads particular field-of-view information associated with the read particular image capturing position. As illustrated in FIG. 51, the generation unit 53 displays a display area 630a in the display area 602b. The display area 630a includes a previous predetermined-area image based on particular content data (image data), the particular image capturing position, and the particular field-of-view information.

The processing unit 54 may perform a similar image search based on the predetermined-area image displayed in the display area 610a to extract, from the particular content data (image data), a previous predetermined-area image having a degree of similarity greater than or equal to a predetermined value.

The generation unit 53 displays a display area 640a in the display area 602c. The display area 640a includes a previous three-dimensional image subjected to alignment processing with the previous predetermined-area image in the display area 630a. The previous predetermined-area image in the display area 630a is an example of a related image of the predetermined-area image in the display area 610a.

As a result, the viewer (e.g., the participant A) of the screen 602 of the minutes can view, all at once (or simultaneously), the automatically generated transcribed texts in the display area 602a, the corresponding predetermined-area image and three-dimensional image in the display areas 610a and 620a, respectively, the previous predetermined-area image in the display area 630a, and the previous three-dimensional image in the display area 640a. Thus, the more detailed content of the minutes can be presented to the viewer in a comprehensible manner.

### Variation (2) of Minutes

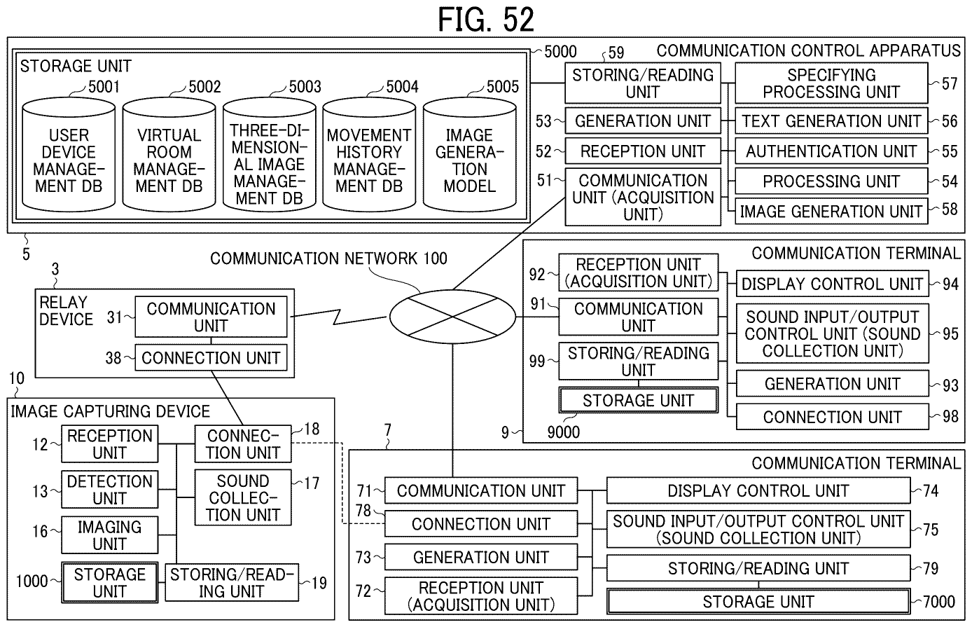

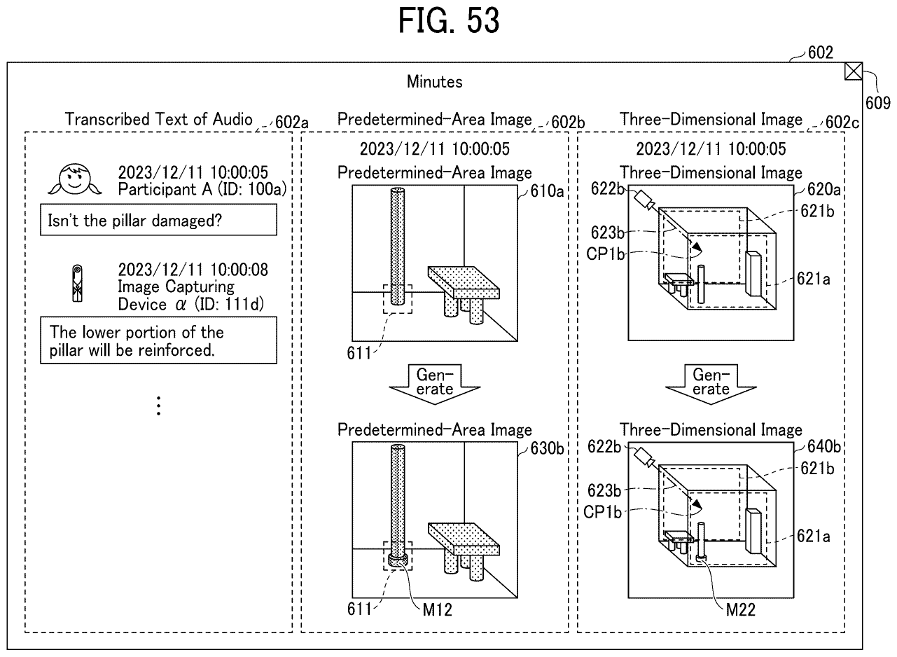

Variation (2) of the screen illustrated in FIG. 50 will be described with reference to FIGS. 52 and 53.

FIG. 52 is a block diagram illustrating an example functional configuration of a communication system according to a modification of the embodiment illustrated in FIG. 13. The communication control apparatus 5 further includes an image generation unit 58, and the storage unit 5000 of the communication control apparatus 5 further includes an image generation model 5005. The other configuration is the same as that illustrated in FIG. 13.

The image generation unit 58 is an example of an image generator and is implemented in accordance with instructions from the CPU 501 illustrated in FIG. 12. The image generation unit 58 generates image information based on the image generation model 5005.

The image generation model 5005 is a trained machine learning model (generative artificial intelligence (AI)) for generating images from text data or from text data and images. The image generation model 5005 is trained using training data including text data and image data. The training data includes, for example, learning data (text data, or text data and image data) as input, and image data as ground truth data for output. Machine learning is performed so that the image generated by the image generation model 5005 in response to input of the training data becomes closer to the ground truth image included in the training data.

FIG. 53 is a diagram illustrating an example of a screen on the communication terminal 9a for additionally displaying, together with the minutes, images generated based on a predetermined-area image, a three-dimensional image, and audio comments.

For example, the image generation unit 58 uses the image generation model 5005 to generate a predetermined-area image in accordance with a transcribed text (e.g., “The lower portion of the pillar will be reinforced.”), based on the transcribed text and a predetermined-area image corresponding to the transcribed text. A display area 630b illustrated in FIG. 53 includes an identification image (in the illustrated example, an image of an article M12) to identify a differing portion. The identification image is generated by the image generation unit 58. The generation unit 53 displays, in the display area 630b within the display area 602b, the predetermined-area image generated by the image generation unit 58.

The image generation unit 58 further generates a three-dimensional image corresponding to the display area 630b. The three-dimensional image is to be displayed in a display area 640b within the display area 602c. The display area 640b illustrated in FIG. 53 includes an identification image (in the illustrated example, an image of an article M22) to identify a differing portion. The identification image is generated by the image generation unit 58. The generation unit 53 displays, in the display area 640b within the display area 602c, the three-dimensional image generated by the image generation unit 58. The predetermined-area image in the display area 630b is an example of a related image of the predetermined-area image in the display area 610a.

As a result, the viewer (e.g., the participant A) of the screen 602 of the minutes can view, all at once (or simultaneously), the automatically generated transcribed texts, the corresponding predetermined-area image and three-dimensional image, and the generated predetermined-area image and three-dimensional image. Thus, the more detailed content of the minutes can be presented to the viewer in a comprehensible manner.

As described above, according to this embodiment, the processing unit 54 associates a first position in a captured image of an object with a second position in a three-dimensional image including a three-dimensional area corresponding to the object. The generation unit 53 (or the generation unit 73 or 93) generates a screen 601 including a display area 610, a display area 620, and a display area 630. The display area 610 displays a predetermined-area image, which represents a predetermined area in the captured image of the object. The display area 620 displays at least a portion of the three-dimensional image in which the second position is associated with the first position in the captured image by the processing unit 54. The display area 630 displays a predetermined-area image obtained at a different date and time, which represents a predetermined area in a wide-view image captured by the image capturing device 10.

Accordingly, by viewing the screen 601, the user can recognize the content of the predetermined-area image and the location where the predetermined-area image was captured. Even when the back of an object is not captured, the user can understand the state of the object, such as the back of the object, by viewing the screen 601. Generation of an image that complements a captured image obtained by image capturing can enhance user convenience.

Further, in the movement history management DBs 5004 illustrated in FIGS. 18B and 18C, the date and time of image capturing, the image capturing position, the field of view of an image being displayed, text information (current text information and previous text information), and a specific area are associated with one another. Accordingly, in response to the participant A pressing the “register” button 680 while a predetermined-area image is being displayed in the display area 610, the processing unit 54 can register, in the movement history management DB 5004, information on the captured image being displayed on the screen 601, namely, the date and time of image capturing, the image capturing position, the field of view, text information, and a specific area.

As illustrated in FIG. 41, the generation unit 53 can superimpose the icon 622b of the virtual camera IC1 on the display area 620 at a position corresponding to the current image capturing position. The imaging area of the virtual camera IC1 is defined by a field of view of the current predetermined-area image being displayed.

As illustrated in FIG. 41, the generation unit 53 can further display the icon 622a of the virtual camera IC1 in the display area 620 at a position corresponding to the previous image capturing position. When the user, such as the participant A, presses the icon 622a, as illustrated in FIG. 41, the generation unit 53 generates the screen 601 such that a predetermined-area image representing a portion of an image captured at the previous image capturing position represented by the icon 622a and indicating the field of view of the virtual camera IC1 indicated by the icon 622a is displayed in the display area 630 together with text information.

Accordingly, the user, such as the participant A, can recognize the previous captured image associated with the position of the icon 622a of the virtual camera IC1 and the specific area 631a and the text information, which are associated with the previous captured image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The programs described above may be stored in (non-transitory) recording media such as digital versatile disc-read only memories (DVD-ROMs), and such (non-transitory) recording media may be provided in the form of program products to domestic or foreign users.

Each of the CPUs 111, 301, and 501 may be implemented in hardware using a processor or a plurality of processors.

In the embodiment described above, the text generation unit 56 is optional. Specifically, text entered by a user may be received by the reception unit 92, and data of the text may be transmitted to the communication unit 51 of the communication control apparatus 5 via the communication unit 91, and the processing unit 54 may register the text in the movement history management DB 5004 illustrated in FIGS. 18A, 18B, and 18C. A record having the same date and time of image and sound capturing as the date and time of reception of the data of the text by the communication unit 51 is registered in the movement history management DB 5004.

The embodiment described above and the modifications thereof may be implemented by the following aspects. It should be noted that the reference numerals in parentheses are those used in the embodiment described above and the modifications thereof and are included merely for ease of understanding, and are not intended to limit the scope of the present disclosure.

In Aspect 1, an information processing apparatus communicable with an image capturing device includes a generation unit and a processing unit. The generation unit generates a screen including a captured image display area and a three-dimensional image display area. The captured image display area displays a predetermined-area image representing a predetermined area in a captured image of an object. The captured image is captured by the image capturing device. The three-dimensional image display area displays at least a portion of a three-dimensional image subjected to alignment processing with the captured image. The processing unit performs a process for associating each of a plurality of pieces of text information, each of a plurality of predetermined-area images, and a specific area specified in the predetermined-area image with an image capturing position of the captured image. The plurality of pieces of text information are generated based on pieces of audio data including pieces of audio captured by a sound collection unit in the image capturing device or a sound collection unit in a display terminal communicable with the image capturing device. The plurality of predetermined-area images represent a plurality of predetermined areas in the captured image.

According to Aspect 2, in the information processing apparatus of Aspect 1, the pieces of audio data include a piece of audio captured by the sound collection unit in the image capturing device.

According to Aspect 3, in the information processing apparatus of Aspect 1 or Aspect 2, the image capturing device or the display terminal includes a plurality of sound collection units including the sound collection unit, and the pieces of audio data include pieces of audio captured by the plurality of sound collection units. The processing unit performs a process for associating identification information for identifying each of the plurality of sound collection units with a corresponding one of the plurality of pieces of text information.

According to Aspect 4, in the information processing apparatus of Aspect 1, the generation unit generates the screen such that the screen displays an image corresponding to the image capturing position in the three-dimensional image at a position corresponding to the image capturing position and displays a particular piece of text information corresponding to the image capturing position among the plurality of pieces of text information and a particular predetermined-area image corresponding to the particular piece of text information among the plurality of predetermined-area images.

According to Aspect 5, in the information processing apparatus of Aspect 4, the generation unit generates the screen such that the screen displays the plurality of pieces of text information in chronological order.

In Aspect 6, a screen generation method executed by a computer communicable with an image capturing device includes a generation process and a registration process. The generation process generates a screen including a captured image display area and a three-dimensional image display area. The captured image display area displays a predetermined-area image representing a predetermined area in a captured image of an object. The captured image is captured by the image capturing device. The three-dimensional image display area displays at least a portion of a three-dimensional image subjected to alignment processing with the captured image. The registration process performs a process for associating each of a plurality of pieces of text information, each of a plurality of predetermined-area images, and a specific area specified in the predetermined-area image with an image capturing position of the captured image. The plurality of pieces of text information are generated based on pieces of audio data including pieces of audio captured by a sound collection unit in the image capturing device or a sound collection unit in a display terminal communicable with the image capturing device. The plurality of predetermined-area images represent a plurality of predetermined areas in the captured image.

In Aspect 7, a program causes a computer to execute the method of Aspect 6.

In Aspect 8, an information processing system includes an information processing apparatus communicable with an image capturing device. The information processing system includes a generation unit and a processing unit. The generation unit generates a screen including a captured image display area and a three-dimensional image display area. The captured image display area displays a predetermined-area image representing a predetermined area in a captured image of an object. The captured image is captured by the image capturing device. The three-dimensional image display area displays at least a portion of a three-dimensional image subjected to alignment processing with the captured image. The processing unit performs a process for associating each of a plurality of pieces of text information, each of a plurality of predetermined-area images, and a specific area specified in the predetermined-area image with an image capturing position of the captured image. The plurality of pieces of text information are generated based on pieces of audio data including pieces of audio captured by a sound collection unit in the image capturing device or a sound collection unit in a display terminal communicable with the image capturing device. The plurality of predetermined-area images represent a plurality of predetermined areas in the captured image.

In Aspect 9, an information processing apparatus communicable with an image capturing device includes a generation unit and a storage unit. The generation unit generates a screen including a first captured image display area and a three-dimensional image display area. The first captured image display area displays a first predetermined-area image representing a first predetermined area in a first captured image of an object. The first captured image is captured by the image capturing device at a first image capturing position. The three-dimensional image display area displays at least a portion of a three-dimensional image subjected to alignment processing with the first captured image and displays an image capturing position image indicating a position corresponding to a second image capturing position at a particular date and time of image capturing. The storage unit stores a second predetermined-area image, a specific area specified in the second predetermined-area image, and a piece of text information in association with the second image capturing position. The second predetermined-area image represents a second predetermined area in a second captured image at the particular date and time of image capturing. The second captured image is associated with the second image capturing position related to the image capturing position image. The piece of text information is generated based on a piece of audio data including a piece of audio captured by a sound collection unit in the image capturing device or a sound collection unit in a display terminal communicable with the image capturing device. The storage unit stores each of a plurality of second predetermined-area images including the second predetermined-area image, a specific area in the second predetermined-area image, and each of a plurality of pieces of text information including the piece of text information, in association with the second image capturing position. The generation unit generates the screen such that the screen includes a second captured image display area and a text display area. The second captured image display area is a display area for displaying a specific image indicating a position of the specific area in a superimposed manner on at least one predetermined-area image of the plurality of second predetermined-area images. The text display area displays a piece of text information corresponding to the at least one predetermined-area image displayed in the second captured image display area among the plurality of pieces of text information.

According to Aspect 10, in the information processing apparatus of Aspect 9, the piece of audio data includes a piece of audio captured by the sound collection unit in the image capturing device.

According to Aspect 11, in the information processing apparatus of Aspect 9 or Aspect 10, the image capturing device or the display terminal includes a plurality of sound collection units including the sound collection unit, and the piece of audio data includes pieces of audio captured by the plurality of sound collection units. The storage unit stores identification information for identifying each of the plurality of sound collection units in association with a corresponding one of the plurality of pieces of text information. The generation unit generates the screen such that the screen includes the identification information corresponding to the piece of text information.

According to Aspect 12, in the information processing apparatus of Aspect 9, the generation unit generates the screen such that the screen includes the plurality of pieces of text information, the plurality of pieces of text information being displayed in chronological order.

According to Aspect 13, in the information processing apparatus of Aspect 9, the generation unit generates the screen such that the screen includes a particular piece of text information associated with a date and time of image capturing and a date and time of sound capturing of the second predetermined-area image displayed on the screen.

According to Aspect 14, in the information processing apparatus of Aspect 13, the generation unit generates the screen such that the screen includes a piece of text information retrieved from among the plurality of pieces of text information stored in the storage unit, based on the piece of text information associated with the date and time of image capturing and the date and time of sound capturing of the second predetermined-area image displayed on the screen.

According to Aspect 15, in the information processing apparatus of Aspect 14, the generation unit generates the screen such that the screen includes another piece of text information corresponding to another second predetermined-area image retrieved from among the plurality of second predetermined-area images stored in the storage unit based on the second predetermined-area image displayed on the screen.

According to Aspect 16, in the information processing apparatus of any one of Aspects 13 to 15, the generation unit generates the screen such that the screen includes the date and time of sound capturing associated with the piece of text information.

In Aspect 17, a screen generation method executed by a computer communicable with an image capturing device includes a generation process and a storage process. The generation process generates a screen including a first captured image display area and a three-dimensional image display area. The first captured image display area displays a first predetermined-area image representing a first predetermined area in a first captured image of an object. The first captured image is captured by the image capturing device at a first image capturing position. The three-dimensional image display area displays at least a portion of a three-dimensional image subjected to alignment processing with the first captured image and displays an image capturing position image indicating a position corresponding to a second image capturing position at a particular date and time of image capturing. The storage process stores a second predetermined-area image, a specific area specified in the second predetermined-area image, and a piece of text information in association with the second image capturing position. The second predetermined-area image represents a second predetermined area in a second captured image at the particular date and time of image capturing. The second captured image is associated with the second image capturing position related to the image capturing position image. The piece of text information is generated based on a piece of audio data including a piece of audio captured by a sound collection unit in the image capturing device or a sound collection unit in a display terminal communicable with the image capturing device. The storage unit stores each of a plurality of second predetermined-area images including the second predetermined-area image, a specific area in the second predetermined-area image, and each of a plurality of pieces of text information including the piece of text information, in association with the second image capturing position. The generation process includes a process for generating the screen such that the screen includes a second captured image display area and a text display area. The second captured image display area is a display area for displaying a specific image indicating a position of the specific area in a superimposed manner on at least one predetermined-area image of the plurality of second predetermined-area images. The text display area displays a piece of text information corresponding to the at least one predetermined-area image displayed in the second captured image display area among the plurality of pieces of text information.

In Aspect 18, a program causes a computer to execute the method of Aspect 17.

In Aspect 19, an information processing system includes an information processing apparatus communicable with an image capturing device. The information processing system includes a generation unit and a storage unit. The generation unit generates a screen including a first captured image display area and a three-dimensional image display area. The first captured image display area displays a first predetermined-area image representing a first predetermined area in a first captured image of an object. The first captured image is captured by the image capturing device at a first image capturing position. The three-dimensional image display area displays at least a portion of a three-dimensional image subjected to alignment processing with the first captured image and displays an image capturing position image indicating a position corresponding to a second image capturing position at a particular date and time of image capturing. The storage unit stores a second predetermined-area image, a specific area specified in the second predetermined-area image, and a piece of text information in association with the second image capturing position. The second predetermined-area image represents a second predetermined area in a second captured image at the particular date and time of image capturing. The second captured image is associated with the second image capturing position related to the image capturing position image. The piece of text information is generated based on a piece of audio data including a piece of audio captured by a sound collection unit in the image capturing device or a sound collection unit in a display terminal communicable with the image capturing device. The storage unit stores each of a plurality of second predetermined-area images including the second predetermined-area image, a specific area in the second predetermined-area image, and each of a plurality of pieces of text information including the piece of text information, in association with the second image capturing position. The generation unit generates the screen such that the screen includes a second captured image display area and a text display area. The second captured image display area is a display area for displaying a specific image indicating a position of the specific area in a superimposed manner on at least one predetermined-area image of the plurality of second predetermined-area images. The text display area displays a piece of text information corresponding to the at least one predetermined-area image displayed in the second captured image display area among the plurality of pieces of text information.

In Aspect 20, an information processing apparatus (5, 7, 9) communicable with an image capturing device (10) includes a storage unit (5000, 7000, 9000) and a generation unit (53, 73, 93). The storage unit stores a predetermined-area image, a specific area, and text information, the predetermined-area image representing a predetermined area in a captured image of an object, the captured image being captured by the image capturing device at an image capturing position, the specific area being specified in the predetermined-area image, the text information being generated based on audio data including audio captured by a sound collection unit (17, 75, 95) in the image capturing device or a sound collection unit (17, 75, 95) in a display terminal (7, 9) communicable with the image capturing device. The storage unit stores each of a plurality of predetermined-area images and each of a plurality of pieces of text information in association with the image capturing position, the plurality of predetermined-area images being obtained at different times and representing a plurality of predetermined areas in the captured image, the plurality of pieces of text information being generated based on pieces of audio data including pieces of audio captured at the different times by the sound collection unit. The generation unit generates a screen such that the screen displays a particular piece of text information among the plurality of pieces of text information and displays a specific image indicating a position of the specific area in a superimposed manner on a particular predetermined-area image corresponding to the particular piece of text information among the plurality of predetermined-area images. The screen further displays a three-dimensional image subjected to alignment processing with the particular predetermined-area image, and displays an image corresponding to the image capturing position in the three-dimensional image at a position corresponding to the image capturing position.

1. An information processing apparatus communicably connected with an image capturing device, the information processing apparatus comprising:
a memory that stores, for a plurality of image capturing positions, a plurality of predetermined-area images having been obtained at different times and each representing a predetermined area in a captured image of an object having been captured by the image capturing device, a plurality of specific areas each specified in the corresponding predetermined-area image, and text information being generated based on audio data of audio collected by a sound collection unit at the different times, in association, and
circuitry configured to generate a screen,
the screen including:
a particular text information of the text information;
a particular predetermined-area image corresponding to the particular text information, the particular predetermined-area image being superimposed with a specific image indicating a position of the specific area;
a three-dimensional image to be aligned with the particular predetermined-area image; and
an image corresponding to the image capturing position, the image being displayed in the three-dimensional image at a position corresponding to the image capturing position.

2. The information processing apparatus according to claim 1, wherein the sound collection unit is included in the image capturing device.

3. The information processing apparatus according to claim 1, wherein
the sound collection unit is included in at least one of the image capturing device or a display terminal communicably connected with the image capturing device,
the at least one of the image capturing device or the display terminal includes a plurality of sound collection units including the sound collection unit,
the audio data includes audio captured by the plurality of sound collection units,
the memory stores identification information for identifying each of the plurality of sound collection units in association with a corresponding one of the text information, and
the circuitry is configured to generate the screen such that the screen includes the identification information corresponding to the particular text information.

4. The information processing apparatus according to claim 1, wherein the circuitry is configured to generate the screen such that the screen includes the text information displayed in chronological order.

5. The information processing apparatus according to claim 1, wherein
the plurality of predetermined-area images includes:
a first predetermined-area image representing the predetermined area in a first captured image and captured at a first image capturing position, the first predetermined-area image being the particular predetermined-area image; and
a second predetermined-area image representing a predetermined area in a second captured image and captured at a second image capturing position, and
the circuitry is configured to generate the screen such that the screen displays at least a portion of the three-dimensional image to be aligned with the first captured image and includes text information associated with a date and time of image and sound capturing for the second predetermined-area image.

6. The information processing apparatus according to claim 5, wherein
the circuitry is configured to generate the screen such that the screen includes text information retrieved from among the text information stored in the memory, based on the text information associated with the date and time of image and sound capturing of the second predetermined-area image displayed on the screen.

7. The information processing apparatus according to claim 6, wherein
the memory stores a plurality of second predetermined-area images including the second predetermined-area image, and
the circuitry is configured to generate the screen such that the screen includes another second predetermined-area image retrieved from among the plurality of second predetermined-area images stored in the memory based on the second predetermined-area image displayed on the screen.

8. The information processing apparatus according to claim 5, wherein
the circuitry is configured to generate the screen such that the screen includes the date and time of image and sound capturing associated with the text information.

9. A screen generation method performed by a computer communicably connected with an image capturing device, the screen generation method comprising:
storing, in a memory, for a plurality of image capturing positions, a plurality of predetermined-area images having been obtained at different times and each representing a predetermined area in a captured image of an object having been captured by the image capturing device, a plurality of specific areas each specified in the corresponding predetermined-area image, and text information being generated based on audio data of audio collected by a sound collection unit at the different times, in association; and
generating a screen, the screen including:
a particular text information of the text information;
a particular predetermined-area image corresponding to the particular text information, the particular predetermined-area image being superimposed with a specific image indicating a position of the specific area;
a three-dimensional image to be aligned with the particular predetermined-area image; and
an image corresponding to the image capturing position, the image being displayed in the three-dimensional image at a position corresponding to the image capturing position.

10. A non-transitory recording medium storing a plurality of instructions which, when executed by one or more processors, causes the one or more processors to perform a screen generation method comprising:
storing, in a memory, for a plurality of image capturing positions, a plurality of predetermined-area images having been obtained at different times and each representing a predetermined area in a captured image of an object having been captured by the image capturing device, a plurality of specific areas each specified in the corresponding predetermined-area image, and text information being generated based on audio data of audio collected by a sound collection unit at the different times, in association; and
generating a screen, the screen including:
a particular text information of the text information;
a particular predetermined-area image corresponding to the particular text information, the particular predetermined-area image being superimposed with a specific image indicating a position of the specific area;
a three-dimensional image to be aligned with the particular predetermined-area image; and
an image corresponding to the image capturing position, the image being displayed in the three-dimensional image at a position corresponding to the image capturing position.

11. An information processing system comprising:
a memory that stores, for a plurality of image capturing positions, a plurality of predetermined-area images having been obtained at different times and each representing a predetermined area in a captured image of an object having been captured by the image capturing device, a plurality of specific areas each specified in the corresponding predetermined-area image, and text information being generated based on audio data of audio collected by a sound collection unit at the different times, in association, and
circuitry configured to display a screen on a display, the screen including:
a particular text information of the text information;
a particular predetermined-area image corresponding to the particular text information, the particular predetermined-area image being superimposed with a specific image indicating a position of the specific area;
a three-dimensional image to be aligned with the particular predetermined-area image; and
an image corresponding to the image capturing position, the image being displayed in the three-dimensional image at a position corresponding to the image capturing position.
